(19) United States
(12) Patent Application Publication
(10) Pub. No.: US 2013/0156885 A1
(43) Pub. Date: Jun. 20, 2013

(54) CHEWING GUM CONTAINING COMBINATIONS OF PHYSIOLOGICAL COOLING AGENTS

(71) Applicants: Sonya S. Johnson, La Grange Highlands (IL); Gloria T. Sheldon, Valparaiso, IN (US); Armando J. Castro, Westchester, IL (US); Robert Yatka, Orland Park, IL (US)

(72) Inventors: Sonya S. Johnson, La Grange Highlands (IL); Gloria T. Sheldon, Valparaiso, IN (US); Armando J. Castro, Westchester, IL (US); Robert Yatka, Orland Park, IL (US)

(21) Appl. No.: 13/704,731

(22) PCT Filed: Jun. 16, 2011
(86) PCT No.: PCT/US11/40758

§ 371 Date: Mar. 4, 2013

(30) Foreign Application Priority Data
Jun. 18, 2010 (US) 61356083

(51) Int. Cl. A23G 4/06

(52) U.S. Cl. CPC A23G 4/06
USPC 426/3

(57) ABSTRACT

A method for producing a chewing gum and confections, as well as the chewing gum and confections so produced, incorporates combinations of physiological cooling agents. In another embodiment a combination of physiological cooling agents is made in a modified release structure. The modified release/cooling agents combination is preferably obtained by physically modifying the properties of the combination of cooling agents by coating and drying. When incorporated into gum and confections, these particles are adapted to enhance the shelf stability of the flavor and/or produce a modified release. In another embodiment, coated chewing gum has a coating that comprises combinations of physiological cooling agents. The preferred inventive chewing gum provides a high flavor impact in which the harsh notes normally associated with such a high flavor impact have been reduced or eliminated.

### PRIORITY DATA

The present patent application is a 371 of International Application Ser. No. PCT/US11/40758 filed 16 Jun. 2011, which claims benefit from Ser. No. 61/356,083 filed 18 Jun. 2010. The applications listed above are incorporated by reference from as if entirely restated herein.

### BACKGROUND OF THE INVENTION

The present invention relates to confectionery, particularly chewing gum compositions and methods of producing chewing gum and other confectionery products. More particularly, the invention relates to producing chewing gum and other confectionery containing a blend of physiological cooling agents. Preferably the physiological cooling agents are used in combination or have been treated to control their release and enhance shelf life stability. Also, the blend of physiological cooling agents may be added individually or as part of a cooling flavor composition, or used in confectionery and chewing gum coatings.

In recent years, efforts have been devoted to controlling release characteristics of various ingredients in chewing gum. Efforts have been directed at perfecting the use of high-intensity sweeteners within the chewing gum formulation, to thereby increase the shelf-life stability of the ingredients, i.e., the protection against degradation of the high-potency sweetener over time.

Patent Cooperation Treaty Publication No. 89-03170 discloses a method of controlling the release of acesulfame K. In this process, the sweetener is encapsulated fully or partially to modify the release rate in chewing gum.

Other patent publications disclose how a sweetener like aspartame can be physically modified to control its release rate in chewing gum.

For example, U.S. Pat. No. 4,597,970 to Sharma et al. teaches a process for producing an agglomerated sweetener wherein the sweetener is dispersed in a hydrophobic matrix consisting essentially of lecithin, a glyceride and a fatty acid or wax having a melting point between 25 and 100° C. The 30 disclosed method uses a spray congealing step to form the sweetener-containing matrix into droplets, followed by a fluid-bed second coating on the agglomerated particles.

U.S. Pat. Nos. 4,515,769 and 4,386,106, both to Merrit et al., teach a two step process for preparing a delayed release flavorant for chewing gum. In this process, the flavorant is prepared in an emulsion with a hydrophilic matrix. The emulsion is dried and ground and the particles are then coated with a water-impermeable substance.

U.S. Pat. No. 4,230,687 to Sair et al. teaches a process for encasing an active ingredient to achieve gradual release of the ingredient in a product such as chewing gum. The described method involves adding the ingredient to an encapsulating material in the form of a viscous paste. High shear mixing is used to achieve a homogeneous dispersion of the ingredient within the matrix, which is subsequently dried and ground.

U.S. Pat. No. 4,139,639 to Bahoshy et al. teaches a process of “fixing” aspartame by co-drying (by spray drying or fluid bed coating) a solution containing aspartame and an encapsulating agent, such as gum Arabic, to thereby surround and protect the aspartame in the gum during storage.

U.S. Pat. No. 4,384,004 to Cea et al. teaches a method of encapsulating aspartame with various solutions of encapsulating agents using various encapsulation techniques, such as spray drying, in order to increase the shelf stability of the aspartame.

U.S. Pat. No. 4,634,593 to Stroz et al. teaches a method for producing controlled release sweeteners for confections, such as chewing gum. The method taught therein involves the use of an insoluble fat material which is mix mulled with the sweetener.

Several known compounds have what can be characterized as a “cooling” activity, and are referred to in the art as “physiological cooling agents.” Physiological cooling agents are perceived as cold or cool when contacted with the human body and, in particular, with the mucous membranes of the mouth, nose and throat.

Efforts have been directed at perfecting the use of physiological cooling agents within chewing gum formulations to enhance flavor composition and control their release to enhance the flavor of chewing gum.

U.S. Pat. No. 5,326,574 discloses a process for codrying the physiological cooling agent 3-l-menthoxypropane-1,2-diol with a food acceptable, water-soluble carrier and mixing the resulting product into chewing gum.

U.S. Pat. No. 6,627,233 (hereby incorporated herein by reference) discloses a number of physiological cooling agents and combinations of physiological cooling agents, including N-2,3-trimethyl-2-isopropyl butanamide (called WS-23), as well as their use in chewing gum. The physiological cooling agents may be treated so as to modify their release from the chewing gum or confection, and may be used in a chewing gum or confectionery coating

Peppermint oil is currently used to create a “cooling” in oral products such as toothpaste, mouthwash, chewing gum, candy and other food products. Peppermint oil generally comprises about 45% menthol, about 20% menthone, about 5% menthyl acetate, about 5% eucalyptol and many other constituents. Peppermint oil is even used in non-peppermint products, such as spearmint or wintergreen flavored products, in order to create this desired cooling effect. However, peppermint notes are then found in the resulting non-peppermint flavored products.

Menthol is also known for its physiological cooling effect on the skin and mucous membranes of the mouth. Being a major constituent of peppermint oil, menthol has been used extensively in foods, beverages, dentifrices, mouthwashes, toiletries, lotions and the like. The disadvantages of using menthol, however, are its strong minty odor and the harsh notes it imparts to compositions in which it is found.

A need, therefore, exists for a cooling flavor composition that will contribute a long-lasting cooling sensation to products in which it is found without the unwanted harshness or flavor characteristics that come from adding menthol.

It would be desirable to provide a high flavor impact chewing gum that does not manifest the harsh notes normally associated with some chewing gum. It would also be desirable to provide a clean, high-quality flavor chewing gum with a good cooling effect.

The present invention also relates to coated confections such as chewing gum. Chewing gums and other confections are frequently covered with hard or soft coatings. The coatings provide an opportunity for the manufacturer to vary the taste, appearance, mouth-feel and nutritional value of the chewing gum.

For example, some consumers prefer a burst of intense flavor over the slow, gentle flavor release normally associated with confections such as chewing gum. In order to provide a favorable flavor impact, gum manufacturers have added flavors to the coating of a coated product. These flavors include spearmint flavor, peppermint flavor, wintergreen flavor and fruit flavors. In addition, very strong flavors such as menthol have often been used to provide a burst of flavor. However, at concentrations effective to provide a burst of flavor, menthol or mint flavors also manifest a bitter, harsh, burning taste (hereinafter “harsh notes”).

The harsh notes are particularly acute with sugarless gum and other confections. In the case of sugar coated confections including gum, the sugar masks many of the harsh notes of menthol and mint flavors (although high levels of menthol or mint flavors can still manifest the harsh notes). However, recent efforts to produce sugarless coated gums and other confections have highlighted the difficulties of providing an initial burst of flavor without the harsh notes associated with traditional flavoring.

One method to alleviate the problem of harsh notes in sugarless coated chewing gum is the use of xylitol as a coating material. Xylitol has a sweetness level equivalent to sugar, and produces a cooling effect due to its endothermic heat of solvation. It produces a clean, high-quality flavor with a good cooling effect, particularly when it is used with menthol and mint flavors.

Coating with xylitol is described in U.S. Pat. No. 4,105,801; U.S. Pat. No. 4,127,677; U.S. Pat. No. 4,681,766; U.S. Pat. No. 4,786,511; and U.S. Pat. No. 4,828,845.

The disadvantage of xylitol is that it is an expensive ingredient. Many efforts have been made to replace xylitol with a less expensive sugarless polyol. The most common and lowest cost polyol used in chewing gum is sorbitol. However, panning with sorbitol has been very difficult since it is hygroscopic and does not readily crystallize.

A number of patents have been published that use various procedures to coat with sorbitol, including G.B. Patent No. 2,115,672; U.S. Patent No. 4,317,838; and U.S. Pat. No. 4,753,790. A successful sorbitol hard coating was reported in U.S. Pat. No. 4,423,086, particularly when the sorbitol was at least 99% Sorbitol. However, the quality of coating never approached the quality of typical xylitol coatings.

Other coating patents that teach alternative polyols to xylitol include: U.S. Pat. No. 4,840,797, which discloses a maltitol coating which required over 95% maltitol to obtain a good quality coating on pellet gum; U.S. Pat. Nos. 5,248,508 and 4,792,453, which disclose a hydrogenated isomaltulose coating; and U.S. Pat. No. 5,603,970, which discloses an erythritol coating.

Still other patents teach partially replacing the xylitol with sorbitol, lactitol, or maltitol. However, these cannot be applied in the same solution, but must be applied by alternating solutions. In other words, a solution of one polyol is applied, and then another solution of another polyol is applied. These patents include: U.S. Pat. No. 5,270,061; U.S. Pat. No. 5,376,389; PCT Application Nos. PCT/US93/09354 (published as WO95/08925); PCT/US94/10406 (published as WO95/07625); and PCT/US93/08730 (published as WO95/07622).

A booklet entitled “The Evaluation of Chewing Gum—Xylitol and the Prevention of Dental Caries” published in 1985 by Xyrofin describes a coating formed by panning with a solution containing xylitol and up to 10% sorbitol. U.S. Pat. No. 5,536,511 discloses a coating that comprises co-crystallized xylitol and erythritol. In an approach different from panning from a solution, U.S. Pat. No. 4,146,653 discloses a molten blend of xylitol and sorbitol that are used to form a coating.

U.S. Pat. No. 5,409,715 discloses coating chewing gum with various materials, including waxes, lipids, fatty acids, fats, oils, cellulose derivatives, modified starch, dextrin, gelatin, zein, vegetable gums, proteins, edible polymers, edible plastic film, maltodextrins, polyols, low calorie carbohydrate bulking agents, shellac and combinations thereof.

It would be desirable to provide a high flavor impact chewing gum coating that does not manifest the harsh notes normally associated with such coatings. It would also be desirable to provide a clean, high-quality flavor coated confection including chewing gum with a good cooling effect, while reducing or eliminating the xylitol currently preferred in sugarless coatings.

### SUMMARY OF THE INVENTION

This invention incorporates a combination of physiological cooling agents into confections including chewing gum. One preferred embodiment of the invention provides a confections, particularly chewing gum, having a clean, cool sensation imparted by a cooling flavor composition that includes a blend of physiological cooling agents. Another preferred embodiment also contains a flavor, and a combination of physiological cooling agents which have been treated so as to modify their release from the chewing gum. The result is a synergy between the physiological cooling agents and the flavor, which provides a high flavor impact at a lower concentration of flavor. Thus, with either or both aspects of the present invention, confections can be made with a long lasting cooling sensation without unwanted harshness or flavor characteristics. The confections or gum may have a high flavor impact, as well as a clean, high quality flavor with good cooling effect.

In other embodiments of the invention, the cooling flavor compositions may also be used in other comestibles or even topical products such as creams and lotions.

In a first aspect, the present invention includes a method for producing confections including chewing gum with a physiological cooling agent or combinations of physiological cooling agents, treated to have a modified-release. The controlled release combination of physiological cooling agents is obtained by modifying the cooling agents by encapsulation, partial encapsulation or partial coating, entrapment or absorption with water-soluble materials or water-insoluble materials. The procedures for modifying the physiological cooling agents include spray drying, spray chilling, fluid-bed coating, coacervation, extrusion, and other agglomerating and standard encapsulating techniques. The cooling agents may also be absorbed onto an inert or water-insoluble material. The cooling agents may be modified in a multiple step process comprising any of the processes noted.

The combination of cooling agents, or the combination of cooling agents when modified according to the present invention, give a confection or chewing gum having a controlled-release cooling agent. A higher quantity of cooling agents can be used without resulting in a high initial cooling agent impact, but instead having a delayed cooling release, giving a highly consumer-acceptable confectionery product. Some cooling agents have a very slow release, but may be modified to give a fast release for more initial impact.

Another embodiment of this invention incorporates a physiological cooling agent into the coating of a coated confection including chewing gum. One preferred embodiment of the invention provides a coating having a clean, cool sensation in which xylitol is replaced, in part or in whole, by a less expensive coating material.

Another preferred embodiment also contains a flavor, where the synergy between the physiological cooling agent and the flavor provides a high flavor impact at a lower concentration of flavor. Adding the physiological cooling agent provides the coated confection or chewing gum with an unexpected, high-flavor impact where the harsh notes have been reduced or eliminated. This is particularly valuable for sugarless confection or chewing gum where the harsh notes of the flavor are not masked by sugar.

In addition, the physiological cooling agent provides a cooling sensation similar to that associated with coatings made from xylitol. Consequently, a lower cost polyol can be used as a confectionery or chewing gum coating material without sacrificing the clean, high-quality, cooling sensation ordinarily associated with xylitol coatings.

In yet another aspect of the invention, a chewing gum composition comprises one type of physiological cooling agent and either menthol or another physiological cooling agent, or both.

In still another embodiment, a confection or chewing gum composition comprises a hot flavor, such as cinnamon, and a physiological cooling agent. This embodiment produces a breath freshness perception.

The foregoing and other features and advantages of the present invention will become apparent from the following detailed description of the presently preferred embodiments, when read in conjunction with the accompanying examples.

### DETAILED DESCRIPTION OF THE PRESENTLY PREFERRED EMBODIMENTS OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In the context of this invention, chewing gum refers to chewing gum, bubble gum and the like. Moreover, all percentages are based on weight percentages unless otherwise specified. Further, although some terms are referred to in the singular, it is understood that such references may also encompass the plural. For example, although chewing gum coating is referred to in the singular, it is understood that coated chewing gum normally contains multiple layers of coating. Therefore a phrase that refers to “the coating,” refers to one or more layers of coating. Finally, all references cited herein are incorporated by reference.

The composition of a chewing gum tends to suppress the release of its flavors. Although a slow flavor release is desirable in many instances, some consumers prefer a burst of intense flavor. One method to provide a chewing gum with a greater flavor impact is the addition of encapsulated flavor to a chewing gum. For example, for a cool and refreshing taste, cooling flavors such as encapsulated menthol and/or mint flavors are added to chewing gum. A menthol/mint combination is disclosed in U.S. Pat. No. 4,724,151.

However, the improved flavor impact of adding cooling flavors to the chewing gum or other confections is somewhat offset by the disadvantage of the bitter, harsh, burning sensations associated with high concentrations of such flavors. This disadvantage is particularly acute for sugarless candies and gum, since sugar tends to mask the harsh notes.

The inventors have found that adding a combination of physiological cooling agents or a combination of cooling agents that have a modified release from the chewing gum provides a favorable flavor impact. As a result, the inventors are able to reduce or eliminate the harsh notes associated with the prior art high flavor-impact chewing gums and candies.

By adding a combination of physiological cooling agents to a menthol or mint type flavored confection, one can obtain a strong cooling and clean minty flavor, without the higher concentrations of menthol or mint flavors required in the prior art. Also, the fast release encapsulation of a combination of physiological cooling agents complements the mint flavors to give a high impact of flavor and cooling normally found in chewing gum and confections. This cooling effect is like menthol cooling, but without the bitterness associated with menthol.

For sugarless gums, chewing gums containing xylitol have become very popular because xylitol has about the same sweetness level as sugar and a cooling ability due to its endothermic heat of solvation. With this sweetness, xylitol masks the harsh notes of high impact flavors such as menthol and mint flavors. At the same time, its cooling effect complements the cooling effect of the cooling flavors. As a result, xylitol provides a clean, high-quality cooling effect. Xylitol in combination with physiological cooling agents give chewing gum a high quality flavor profile with good cooling. However, because of its expense, various efforts have been made to replace xylitol in coatings with a less expensive ingredient, such as another polyol.

Another method to provide a confection or chewing gum with a greater flavor impact is the addition of flavor to the coating of a coated confection. For example, for a cool and refreshing taste, cooling flavors such as menthol and/or mint flavors are added to the coating of confections.

However, the improved flavor impact of adding cooling flavors to the confectionery or chewing gum coating is somewhat offset by the disadvantage of the bitter, harsh, burning sensations associated with high concentrations of such flavors. This disadvantage is particularly acute for sugarless products, since sugar tends to mask the harsh notes.

Adding a blend of physiological cooling agents to the coating provides a favorable flavor impact. As a result, the inventors are able to reduce or eliminate the harsh notes associated with the prior art high flavor-impact coated confections, even in the case of sugarless, coated products.

By adding a blend of physiological cooling agents to a menthol or mint type flavored confection, one can obtain a strong cooling and clean minty flavor, without the higher concentrations of menthol or mint flavors required in prior art coatings. Also, the physiological cooling agents complement the mint flavors to give a high impact of flavor and cooling normally found in confections. This cooling effect is like menthol cooling, but without the bitterness associated with menthol.

Coated chewing gums of the present invention may be made with a variety of chewing gum compositions. The chewing gum is prepared as conventional chewing gum, but formed into pellets or balls. The pellets/balls can then be coated by a variety of methods known in the art, such as conventional panning methods to coat chewing gum. The coating is generally applied in multiple layers, where the composition of one layer is not necessarily the composition of the other layers.

The coating of the present invention contains at least a coating material and a physiological cooling agent or a blend of physiological cooling agents. It may also contain other ingredients such as flavors, artificial sweeteners and dispersing agents, coloring agents, film formers and binding agents.

Coating material constitutes the substantial portion of the chewing gum coating. Examples of coating material include sugars such as sucrose, maltose, dextrose and glucose syrup; polyols such as maltitol, lactitol, xylitol, mannitol, erythritol, sorbitol, hydrogenated isomaltulose and hydrogenated starch hydrolysates; and combinations thereof.

For sugarless gums, xylitol coatings have become very popular because xylitol has about the same sweetness level as sugar and a cooling ability due to its endothermic heat of solvation. With this sweetness, xylitol masks the harsh notes of high impact flavors such as menthol and mint flavors. At the same time, its cooling effect complements the cooling effect of the cooling flavors. As a result, xylitol provides a clean, high-quality cooling effect. When used with physiological cooling agents, a synergistic cooling effect may be noted with xylitol. However, because of its expense, various efforts have been made to replace xylitol in coatings with a less expensive ingredient, such as another polyol.

One problem with polyol substitutes for xylitol is that they are generally much less sweet than xylitol or sugar. In the presence of high levels of flavor, the polyol substitutes generally provide a coated product with a bitter, unpleasant taste. To some degree, high intensity sweeteners may be used to counteract bitterness, but these also may have some objectionable taste. Also, some of these polyols themselves may contribute to a bitter taste.

By using physiological cooling agents in a coating that comprises polyols other than xylitol, the coating manifests a cooling similar to xylitol cooling. Thus xylitol substitutes, which cost significantly less than xylitol, can be used to coat products and give a taste sensation similar to xylitol.

By using a combination of physiological cooling agents treated to have a modified release in a confectionery that comprises polyols other than xylitol, the effect is a cooling similar to xylitol cooling. Thus xylitol substitutes, which cost significantly less than xylitol, can be used in confections and give a taste sensation similar to xylitol.

Physiological cooling agents encompass any number of physiological cooling agents. However, in the context of this invention, the term “physiological cooling agent” does not include traditional flavor-derivatives such as menthol or menthone. Preferred physiological cooling agents do not have a perceptible flavor of their own, but simply provide a cooling effect.

Since the physiological cooling agents do not have their own perceptible flavor, they can be used with other types of flavors to offer new and unique advantages, such as breath freshening. Most confectionery products which are promoted for breath freshening are mint flavored products which contain moderate to high levels of menthol. Menthol is a component of peppermint oil which has a cooling property which provides to the consumer a perception of freshness in the oral cavity.

Paradoxically, some cinnamon flavored products have also been marketed for breath freshening based on the physiological heating provided by cinnamic aldehyde and other spice flavor components. In some cases, menthol or peppermint oil has been added to cinnamon flavored products to provide a cooling sensation and enhance breath freshening. While some consumers enjoy the presence of a mint note in cinnamon confections, others describe the flavor as “muddy”, “dirty” and “confused”, preferring a “pure” cinnamon flavor.

Another embodiment of the present invention is a confectionery product, preferably a chewing gum, which incorporates a spicy hot flavor, is substantially free of menthol and other mint oil components and which comprises a physiological cooling agent which imparts improved breath freshening and a desirable hot/cold sensory perception without a mint flavor.

Many consumers, who may not appreciate the addition of mint flavor to cinnamon flavored candies and chewing gums, do enjoy the addition of nonmenthol, physiological cooling agent in such products. Furthermore, it has been found that the inventive products have greatly enhanced breath freshening properties compared to cinnamon flavored confections without physiological cooling agents.

The confectionery products of this embodiment of the invention can be any new or existing type of product in that category. Hard candies, hard or soft pan coated items, chewy confections and powdered candies are specifically contemplated. Chewing gum is a preferred embodiment.

The confections of this embodiment of the invention will include a natural or non-menthol hot spice flavor such as cinnamon, clove, ginger, black pepper, cayenne pepper and mixtures of these. Cinnamon flavor is preferred. The flavor composition will be substantially free of menthol and mint oils. By substantially free, it is meant that the flavor composition will comprise less than about 15% and preferably less than 10% of mint components. Most preferably, the flavor composition will have 0% to 3% of mint components. The flavor composition will also contain a physiological cooling agent in an amount sufficient to impart noticeable cooling to the product.

While there are references that disclose the use of physiological cooling agents in chewing gum and other confections, unique combinations and controlled release are new areas of interest. Because a flavor imparts a distinct and unique sensation when it is used in a chewing gum, some combinations of the physiological cooling agents offer unique advantages and may be combined with various types of flavors or with various methods of encapsulation and entrapment for controlled release.

Several U.S. and foreign references disclose specific compounds and classes of compounds that are physiological cooling agents. Some of these disclose the use of physiological cooling agents in chewing gum. These include:
U.S. Pat. No. 5,451,404 (a ketal combined with another coolant (menthol or carboxamides));
U.S. Pat. No. 5,372,824 (physiological cooling agents and reduced menthol);
U.S. Pat. No. 5,348,750 (menthone ketals);
U.S. Pat. No. 5,326,574 (a spray dried 3-l-menthoxypropane-1,2-diol);
U.S. Pat. No. 5,266,592 (menthone glycerol ketals);
U.S. Pat. No. 5,165,943 (a cyclodextrin complex with physiological cooling agents);
U.S. Pat. No. 5,009,893 (p-menthane carboxamide physiological cooling agent with menthol for reduced bitterness);
U.S. Pat. No. 4,459,425 (3-l-menthoxypropane-1,2-diol);
U.S. Pat. No. 4,296,093 (substituted cyclohexanamides);
U.S. Pat. Nos. 4,248,859 and 4,318,900 (alkyl substituted alicyclic carboxylic acids, esters or amides);
U.S. Pat. Nos. 4,157,384 and 4,029,759 (various 3-substituted p-menthanes);
U.S. Pat. No. 4,081,480 (alpha-oxy(oxo)mercaptan alkanes);
U.S. Pat. No. 4,070,449 (sulphoxides and sulphones);
U.S. Pat. Nos. 4,060,091; 4,190,643 and 4,136,163 (substituted p-menthane-3-carboxamides);
U.S. Pat. Nos. 4,153,679; 4,296,255 and 4,230,688 (acyclic carboxamides);
U.S. Pat. No. 4,034,109 (acyclic sulphonamides and sulphinamides);
U.S. Pat. No. 4,033,994 (p-menthane-3-carboxylates);
U.S. Pat. Nos. 3,793,446 and 3,644,613 (ketoesters of menthol);
U.S. Pat. No. 3,720,762 (spilanthol with menthol or peppermint oil);
Canadian Patent No. 2,101,790 (carbonic acids having free polar groups);
German Patent No. 2,608,226 (menthyl lactate);
German Patent No. 2,433,165 (N-acetylglycine menthyl ester);
French Patent No. 2,577,922 (L-menthyl-3-hydroxybutyrate);
Japanese Patent No. 94/065023 (2-isopropenyl-5-methylcyclohexanol, also called isopulegol);
Great Britain Patent No. 1,502,680 (bicyclic acids, esters, amides and substituted menthanols);
Great Britain Patent No. 1,476,351 (cyclic and acyclic amides, ureas and sulphonamides);
Great Britain Patent No. 1,422,998 (trialkyl-substituted cyclohexane carboxamides);
Great Britain Patents Nos. 1,421,744 and 1,421,743 (novel amides);
Great Britain Patent No. 1,411,786 (cyclohexanamides);
Great Britain Patent No. 1,404,596 (acyclic secondary and tertiary alkanols);
PCT Publication No. WO 97/07771 (menthyl succinate and carboxamides);
PCT Publication No. WO 96/28133 (coolant composition for comestibles);
PCT Publication No. WO 96/17524 (a cooling composition comprising N-substituted p-menthane carboxamides and menthol);
PCT Publication No. WO 94/010117 (cyclohexanol derivatives); and
U.S. Pat. No. 3,639,569 (physiological cooling agents).

Other patents or patent applications that disclose physiological cooling agents include: WO 09/013,192; U.S. Ser. No. 09/001,1238; U.S. Ser. No. 09/194,883; CA 2508966; WO 08/124,667; WO 07/076,025; WO 05/099473; U.S. Ser. No. 08/175,800; EP 1946743; U.S. Ser. No. 06/249,167; U.S. Pat. No. 7,723,735; U.S. Ser. No. 09/099,258; U.S. Pat. No. 7,38,834; Ser. No. 06/0,217,456; U.S. Pat. No. 6,391,886; U.S. Pat. No. 4,157,384; U.S. Ser. No. 09/054,520; U.S. Ser. No. 09/163,733; U.S. Pat. No. 5,698,181; U.S. Pat. No. 4,136,163; JP 02/173420; JP 03/17755; U.S. Ser. No. 05/222,256; JP 04/059474; U.S. Ser. No. 08/096,969; EP 1913976; U.S. Pat. No. 7,414,152; WO 06/099762; WO 07/019,719; WO 06/092074; U.S. Ser. No. 09/105,237; U.S. Ser. No. 08/176,945; WO 08/075,942; U.S. Pat. No. 7,482,378; WO 09/021,357; WO 06/103401; U.S. Ser. No. 07/155,755; U.S. Pat. No. 4,296,255; U.S. Pat. No. 4,153,679; U.S. Pat. No. 4,230,688; U.S. Ser. No. 08/038,386; U.S. Pat. No. 7,030,273; WO 08/293,821; WO 08/039,522; WO 09/070,910; WO 09/021,558; U.S. Pat. No. 7,173,146; U.S. Pat. No. 5,783,725; U.S. Ser. No. 06/165,783; U.S. Pat. No. 5,725,865; U.S. Pat. No. 7,247,743; U.S. Pat. No. 6,451,844; U.S. Pat. No. 6,884,906; JP 61/194,049; FR 2,577,922; U.S. Pat. No. 6,956,139; WO 07/023,109; WO 05/042680; U.S. Pat. No. 7,189,760; U.S. Ser. No. 06/276,667; WO 06/125334; WO 02/015692; WO 06/103401; U.S. Ser. No. 05/054,651; U.S. Ser. No. 05/090,514; U.S. Pat. No. 7,169,377; U.S. Ser. No. 05/0,187,211; U.S. Ser. No. 05/0,159,394; U.S. Pat. No. 7,030,273; U.S. Pat. No. 7,001,594; U.S. Ser. No. 05/255,132; U.S. Pat. No. 7,078,050; U.S. Ser. No. 06/067,961; U.S. Ser. No. 06/104,931; U.S. Ser. No. 06/141,014; U.S. Ser. No. 06/222,620; U.S. Ser. No. 06/0,110,442; U.S. Pat. No. 7,087,255; U.S. Ser. No. 05/100,632; U.S. Ser. No. 06/251,590; U.S. Ser. No. 06/188,612; U.S. Ser. No. 06/188,613; U.S. Ser. No. 07/054,014; U.S. Ser. No. 06/193,909; U.S. Ser. No. 06/034,936; U.S. Ser. No. 07/036,838; U.S. Ser. No. 05/112,235; U.S. Pat. No. 6,887,493; U.S. Pat. No. 7,067,152; U.S. Ser. No. 05/074,420; U.S. Ser. No. 05/074,484; U.S. Ser. No. 05/002,879; U.S. Pat. No. 7,122,211; U.S. Ser. No. 05/201,953; U.S. Ser. No. 06/165,612; U.S. Ser. No. 07/092,623; U.S. Ser. No. 04/086,619; U.S. Ser. No. 05/203,473; U.S. Pat. No. 7,189,421; U.S. Ser. No. 06/280,852; U.S. Ser. No. 06/024,425; U.S. Ser. No. 05/084,551; U.S. Ser. No. 06/034,784; U.S. Ser. No. 05/137,166; U.S. Ser. No. 05/238,700; U.S. Ser. No. 06/15,973 U.S. Ser. No. 07/092,623; U.S. Ser. No. 04/086,619; U.S. Ser. No. 05/203,473; U.S. Pat. No. 7,189,421; U.S. Ser. No. 06/280,852; U.S. Ser. No. 06/024,425; U.S. Ser. No. 05/084,551; U.S. Ser. No. 06/034,784; U.S. Ser. No. 05/137,166; U.S. Ser. No. 05/238,700; U.S. Ser. No. 06/159,734; WO 06/127738; U.S. Ser. No. 06/280,837; WO 05/082154; U.S. Ser. No. 06/160,713; U.S. Pat. No. 7,090,832; U.S. Ser. No. 06/243,298; U.S. Ser. No. 06/269,500; WO 05/117811; U.S. Ser. No. 07/048,424; U.S. Ser. No. 07/059,417; WO 06/071749; WO 06/039945; U.S. Ser. No. 07/014,888; U.S. Ser. No. 05/163,727; U.S. Ser. No. 07/077,331; U.S. Ser. No. 06/051,301; WO 05/073284; JP 02/173420; U.S. Pat. No. 7,482,378; WO 07/115,593; U.S. Ser. No. 09/099,258; U.S. Ser. No. 09/163,733; WO 09/089,641; EP 1,518,466; U.S. Ser. No. 06/057,233; U.S. Pat. No. 7,025,997; U.S. Pat. No. 4,059,118; U.S. Pat. No. 4,032,661; U.S. Pat. No. 4,020,153, U.S. Pat. No. 4,070,496; GB 1,471,894; U.S. Pat. No. 4,248,859; U.S. Pat. No. 4,136,164; U.S. Pat. No. 4,044,120; U.S. Pat. No. 4,137,304; CA 2,021,222; GB 2,233,873; EP 0,507,190; U.S. Pat. No. 5,703,123; JP 94/065023; U.S. Pat. No. 5,725,865; U.S. Pat. No. 5,843,466; U.S. Pat. No. 5,752,529; U.S. Ser. No. 05/019,445; U.S. 99/013,734; U.S. Pat. No. 7,078,066; U.S. Pat. No. 6,627,233; U.S. Pat. No. 7,364,761; U.S. Ser. No. 04/247743; U.S. Ser. No. 07/098,842; EP 1,014,805; U.S. Ser. No. 08/199,565; U.S. Ser. No. 02/198412; U.S. Pat. No. 6,956,139; U.S. Pat. No. 7,090,832; U.S. Pat. No. 6,497,859; U.S. Ser. No. 04/018,954; JP 04/059474; U.S. Ser. No. 06/051,301; U.S. Pat. No. 6,884,906; U.S. Pat. No. 7,025,997; U.S. Ser. No. 06/057,233; WO 05/042680; U.S. Ser. No. 07/274,928; U.S. Pat. No. 6,897,195; U.S. Ser. No. 07/248,717; WO 05/082154; U.S. Ser. No. 05/222,256; U.S. Pat. No. 7,189,760; U.S. Ser. No. 07/014,888; WO 05/099473; WO 05/117811; U.S. Pat. No. 7,482,378; U.S. Ser. No. 05/265,930; WO 05/115325; U.S. Ser. No. 06/249,167; U.S. Ser. No. 08/170,999; U.S. Ser. No. 06/159,819; WO 06/092074; U.S. Ser. No. 08/176,945; U.S. Pat. No. 7,030,273; U.S. Ser. No. 08/319,055; WO 06/125334; U.S. Ser. No. 09/105,237; WO 06/131203; WO 07/019,719; U.S. Ser. No. 09/098,066; U.S. Ser. No. 07/048,424; U.S. Ser. No. 07/059,417; U.S. Ser. No. 07/077,331; WO 07/044,526; U.S. Ser. No. 07/221,236; U.S. Pat. No. 7,615,560; WO 07/138,031; WO 08/006,236; U.S. Ser. No. 08/038,386; JP 08/054,544; WO 08/039,522; U.S. Ser. No. 08/096,969; U.S. Ser. No. 08/175,800; WO 08/107,137; WO 08/124,667; U.S. Ser. No. 08/293,821; U.S. Ser. No. 08/311,232; U.S. Ser. No. 09/054,520; EP 1,913,976; U.S. Ser. No. 09/099,258; WO 09/062,332; WO 09/076,792; WO 09/089,641; WO 09/123,355; WO 09/140,783; U.S. Ser. No. 09/163,733.

Particular examples of physiological cooling agents include:
1) substituted p-menthanes, substituted p-menthane-carboxamides (e.g., N-ethyl-p-menthane-3-carboxamide (WS-3, FEMA 3455)), acyclic carboxamides (e.g., N,2,3-Trimethyl-2-Isopropyl butanamide (WS-23, FEMA 3804)), substituted cyclohexanamides, substituted cyclohexane carboxamides, substituted ureas and sulphonamides, and substituted menthanols (all from Wilkinson Sword);
2) hydroxymethyl and hydroxyethyl derivatives of p-menthane;
3) menthyl succinate (FEMA 3810);
4) 2-mercapto-cyclo-decanone;
5) 2-isopropanyl-5-methylcyclohexanol (hereinafter “isopulegol”, FEMA 2962);
6) hydroxycarboxylic acids with 2-6 carbon atoms;
7) menthone glycerol ketals (FEMA 3807);
8) menthol propylene glycol carbonate (FEMA 3806);
9) menthol ethylene glycol carbonate (FEMA 3805);
10) 3-l-menthoxypropane-1,2-diol (FEMA 3784);
11) menthyl lactate; (FEMA 3748);
12) monomenthyl glutarate (FEMA 4006).

While any of the above-disclosed physiological cooling agents may be used in chewing gum, the presently preferred physiological cooling agents are:
1) substituted p-menthane carboxamides (PMC), such as those disclosed in U.S. Pat. Nos. 4,060,091; 4,190,643 and 4,136,163, all assigned to Wilkinson Sword, especially N-ethyl-p-menthane-3-carboxamide (called WS-3);
2) acyclic carboxamides (AC), such as those disclosed in U.S. Pat. Nos. 4,296,255; 4,230,688; and 4,153,679; all assigned to Wilkinson Sword, especially N-2,3-trimethyl-2-isopropyl butanamide (called WS-23);
3) menthone glycerol ketal (MGK), (FEMA 3807);
4) menthyl lactate (ML), (FEMA 3748);
5) menthyl succinate (MS), (FEMA 3810);
6) 3-l-menthoxypropane-1,2-diol (TCA), (FEMA 3784);
7) monomenthyl glutarate, (FEMA 4006).

The concentration of physiological cooling agent will depend on the intensity of the physiological cooling agent and the desired cooling effect. In general the concentration of cooling agents used in chewing gum is between about 0.001% and about 2% by weight of the chewing gum. The preferred concentration of cooling agent is between about 0.01% and about 1.0%, more preferably between 0.02% and about 0.5%. In general, the concentration of the cooling agents in candy is between about 0.0005% and about 0.1% in candy. The candy will preferably comprise at least 5 ppm physiological cooling agents. Chewing gum products will preferably comprise at least 25 ppm physiological cooling agents.

The present invention contemplates that two or more physiological cooling agents may be added to the flavor used to make the chewing gum or confection. On the other hand, the flavor and cooling agents may be added separately anywhere within the manufacturing process for making a chewing gum or confectionery product.

These flavors include any flavor which is of food acceptable quality commonly known in the art such as essential oils, synthetic flavors or mixtures thereof. Such flavors include, but are not limited to, oils derived from plants and fruits such as citrus oils, fruit essences, peppermint oil, spearmint oil, eucalyptus, other mint oils, clove oil, oil of wintergreen, cinnamic aldehyde, anise and the like. Flavors that are very strong, such as menthol flavors, are also contemplated in this invention. Preferred flavors include cooling flavors such as peppermint, eucalyptus, menthol, wintergreen and fruity-mint; non-cooling flavors such as spearmint and cinnamon; and combinations thereof.

Artificial flavor components are also contemplated by the present invention. Those of ordinary skill in the art will recognize that natural and artificial flavors may be combined in any sensorially acceptable blend. All such flavors and blends are contemplated by the present invention.

The flavor may be added to the chewing gum formula in an amount such that it will contain from about 0.1% to about 10% flavor, preferably from about 0.2% to about 4.0% flavor, and most preferably about 0.5% to about 2% flavor. Somewhat lower flavor levels are used in candies.

For menthol flavored chewing gum and confections, a combination of physiological cooling agents allows for a reduced overall concentration of menthol. However, it does not completely eliminate menthol, because menthol has a very identifiable unique taste and cooling sensation. Hence, in the case of menthol flavor, the physiological cooling agents only enhance the cooling while reducing the menthol bitterness.

Physiological cooling agents generally release slowly from chewing gum during the early stages of mastication of the gum because of their low solubility in water. However, some cooling agents have a moderately fast release, others have a moderately slow release, and still others have a very slow release.

Combinations of cooling agents may not only be synergistic but may also provide both moderate release and slow release to give flavor impact and flavor extension. Physical modifications of the physiological cooling agents or physical modification of combinations of physiological cooling agents by encapsulation with another substrate will also modify their release in chewing gum by modifying the solubility or dissolution rate. Any standard technique which gives partial or full encapsulation of the combination of physiological cooling agents can be used. These techniques include, but are not limited to, spray drying, spray chilling, fluid-bed coating, and coacervation. These encapsulation techniques that give partial encapsulation or full encapsulation can be used individually or in any combination in a single step process or multiple step process. Generally, a modified release of physiological cooling agents is obtained in multistep processes like spray drying the combined physiological cooling agents and then fluid-bed coating the resultant powder.

The encapsulation techniques here described are standard coating techniques and generally give varying degrees of coating from partial to full coating, depending on the coating composition used in the process. Also, the coating compositions may be susceptible to water permeation to various degrees. Generally, compositions that have high organic solubility, good film forming properties and low water solubility give better delayed release of the physiological cooling agents. Such compositions include acrylic polymers and copolymers, carboxyvinyl polymer, polyamides, polystyrene, polyvinyl acetate, polyvinyl acetate phthalate, polyvinyl pyrrolidone and waxes. Although all of these materials are possible for encapsulation of physiological cooling agents, only food grade materials should be considered. Two standard food grade coating materials that are good film formers but not water soluble are shellac and Zein. Others which are more water soluble, but good film formers are materials like agar, alginates, a wide range of cellulose derivatives like ethyl cellulose and hydroxypropylmethyl cellulose, dextrin, gelatin and modified starches. These ingredients, which are generally approved for food use, may give a faster release when used as an encapsulant for the physiological cooling agents. Other encapsulants like acacia or maltodextrin can also encapsulate the physiological cooling agents, but give a faster release rate of the physiological cooling agents.

The amount of coating or encapsulating material on the physiological cooling agents also controls the length of time for their release from chewing gum. Generally, a higher level of coating and a lower amount of active physiological cooling agent gives a slower release of the cooling agents during mastication. To obtain the desired cooling agent release to blend with a gum's flavor release, the encapsulant should be a minimum of about 20% of the coated cooling agents. Preferably, the encapsulant should be a minimum of about 30% of the coated cooling agents, and most preferably should be a minimum of about 40% of the coated cooling agents. Depending on the coating material, a higher or lower amount of coating material may be needed to give the desired release of cooling agents.

Another method of giving a delayed release of the physiological cooling agents is agglomeration with an agglomerating agent which partially coats the cooling agents. This method includes the step of mixing the cooling agents and agglomerating agent with a small amount of water or solvent. The mixture is prepared in such a way as to have individual wet particles in contact with each other so a partial coating can be applied. After the water or solvent is removed, the mixture is ground and used as a powdered coated cooling agent.

Materials that can be used as the agglomerating agent are the same as those used in the encapsulation mentioned previously. However, since the coating is only a partial encapsulation, some agglomeration agents are more effective in delaying release than others. Some of the better agglomerating agents are the organic polymers like acrylic polymer and copolymers, polyvinyl acetate, polyvinyl-pyrrolidone, waxes, shellac and Zein. Other agglomerating agents are not as effective in giving a delayed release as are the polymers, waxes, shellac and Zein, but can be used to give some delayed release. These others agglomerating agents include, but are not limited to, agar, alginates, a wide range of cellulose derivatives, dextrin, gelatin, modified starches, and vegetable gums like guar gums, locust bean gum, and carrageenan. Even though the agglomerated cooling agents are only partially coated, when the quantity of coating is increased compared to the quantity of the cooling agents, the release can be delayed for a longer time during mastication. The level of coating used in the agglomerated product is a minimum of about 5%. Preferably the coating level is a minimum of about 15%, and more preferably about 20%. Depending on the agglomerating agent, a higher or lower amount of agent may be needed to give the desired release of cooling agents.

The physiological cooling agents may be coated in a two-step process or multiple step process. The physiological cooling agents may be encapsulated with any of the materials as described previously and then the encapsulated material can be agglomerated as described previously to obtain an encapsulated/agglomerated product that could be used in chewing gum to give a delayed release.

In another embodiment of this invention, the physiological cooling agents may be absorbed onto another component, often referred to as a carrier, which is porous and become entrapped in the matrix of the porous component. Common materials used for absorbing the physiological cooling agents include, but are not limited to, silicas, silicates, pharmasorb clay, sponge-like beads or microbeads, amorphous carbonates and hydroxides, including aluminum and calcium lakes, vegetable gums and other spray dried materials.

Depending on the type of absorbent material and how it is prepared, the amount of the physiological cooling agents that can be loaded onto the absorbent will vary. Generally materials like polymers or spongelike beads or microbeads, amorphous sugars, and alditols and amorphous carbonates and hydroxides absorb about 10% to about 40% of the weight of the absorbent. Other materials like silicas and pharmasorb clays may be able to absorb about 20% to about 80% of the weight of the absorbent.

The general procedure for absorbing the physiological cooling agents onto the absorbent is as follows. An absorbent like fumed silica powder can be mixed in a powder blender and a solution of the physiological cooling agents can be sprayed onto the powder as mixing continues. The solution can be about 5% to 30% cooling agent, and higher levels may be used if higher temperatures are used. Generally water is the solvent, but other solvents like alcohol should also be used if approved for use in food. As the powder mixes, the liquid is sprayed onto the powder. Spraying is stopped before the mix becomes damp. The still flowing powder is removed from the mixer and dried to remove the water or other solvent, and ground to a specific particle size.

After the physiological cooling agents are absorbed onto an absorbent or fixed onto an absorbent, the fixative/cooling agents can be coated by encapsulation. Either full or partial encapsulation may be used, depending on the coating composition used in the process. Full encapsulation may be obtained by coating with a polymer as in spray drying, spray chilling, fluid-bed coating, extrusion, coacervation, or any other standard technique. A partial encapsulation or coating can be obtained by agglomeration of the fixative/cooling agents mixture using any of the materials discussed above.

The physiological cooling agents can be treated to modify their release by being entrapped in an extrusion process. Examples of such extrusion processes are disclosed in U.S. Pat. No. 5,128,155 and PCT Publication No. WO 94/06308.

The four methods to use to obtain a modified release of physiological cooling agents or combinations of physiological cooling agents are (1) encapsulation by spray drying, fluid-bed coating, spray chilling and coacervation to give full or partial encapsulation; (2) agglomeration to give partial encapsulation; (3) fixation or absorption which also gives partial encapsulation; and (4) entrapment by extrusion. These four methods, combined in any usable manner which physically isolates the physiological cooling agents, modifies their dissolvability or modifies the release of physiological cooling agents are included in this invention.

Methods other than encapsulation may be used to physically isolate the physiological cooling agent from other chewing gum ingredients. This may also have some effect on its release rate and stability. The physiological cooling agent or combinations of physiological cooling agents may be added to the liquid inside a liquid center or center-filled gum product. The center-fill of a gum product may comprise one or more carbohydrate syrups, glycerin, thickeners, flavors, acidulants, colors, sugars and sugar alcohols in conventional amounts. The ingredients are combined in a conventional manner. The physiological cooling agent or combinations of physiological cooling agents may be dissolved in the flavor used as the center-fill ingredient, or may be dispersed or emulsified in the center-fill liquid in a conventional manner. The amount of the physiological cooling agent or combinations of physiological cooling agents added to the center-fill liquid is about 2 ppm to about 500 ppm by weight of the entire chewing gum formula. This method of using physiological cooling agents in chewing gum can allow for a lower usage level of physiological cooling agents, can give the physiological cooling agents a smooth release rate, and can reduce or eliminate any possible reaction of the physiological cooling agents with gum base, or other components, yielding improved shelf stability.

Another method of isolating the physiological cooling agent or combinations of physiological cooling agents from other chewing gum ingredients is to add the physiological cooling agent to the dusting compound of a chewing gum. A rolling or dusting compound is applied to the surface of chewing gum as it is formed during processing. This rolling or dusting compound serves to reduce sticking of gum to machinery as it is formed. It also reduces sticking of the product to machinery as it is wrapped, and sticking to its wrapper after it is wrapped and being stored. The rolling compound comprises the physiological cooling agent or combinations of physiological cooling agents in combination with mannitol, sorbitol, sucrose, starch, calcium carbonate, talc, other orally acceptable substances or a combination thereof. The rolling compound constitutes from about 0.25% to about 10.0%, but preferably about 1% to about 3% of weight of the chewing gum composition. The amount of the physiological cooling agent or combinations of physiological cooling agents added to the rolling compound is about 0.001% to about 1% of the rolling compound or about 0.1 ppm to about 100 ppm of the chewing gum composition. This method of using physiological cooling agents in the chewing gum can allow a lower usage level of the physiological cooling agents, can give the physiological cooling agents a more controlled release rate, and can reduce or eliminate any possible reaction of the physiological cooling agents with gum base or other components, yielding improved shelf stability. The physiological cooling agent or combination of physiological cooling agents may be blended directly into a dusting or rolling compound, or the physiological cooling agent may be encapsulated before being used in a dusting or rolling compound for gum or other confections.

The previously described cooling flavor compositions and encapsulated, agglomerated or absorbed physiological cooling agents may readily be incorporated into a chewing gum composition. Generally the physiological cooling agents will be added to the gum in either the form of a cooling flavor composition or as part of a modified release combination of physiological cooling agents. However, both of these aspects of the invention may be used in the same gum formula, and the cooling flavor composition itself or its individual components may be treated to have a modified release. The remainder of the chewing gum ingredients is noncritical to the present invention. That is, the cooling flavor composition and/or coated particles of physiological cooling agents can be incorporated into conventional chewing gum formulations in a conventional manner.

Physiological cooling agents in a liquid form may be added directly to a chewing gum formulation or confectionery formulation in its liquid form or may be combined with flavors or with other solvents such as alcohol, glycerin, propylene glycol, flavor solvents, emulsifiers, or vegetable oils. Physiological cooling agents in crystalline or powder form may also be added directly to a chewing gum formulation or confectionery formulation in its powder form or may be combined with other powdered bulking agents such as sugars, polyols, and other types of powdered ingredients. In some cases physiological cooling agents may be emulsified in flavor/water compositions or oil/water compositions. Most importantly, because of the low level of usage, the physiological cooling agents need to be evenly dispersed throughout the chewing gum or confectionery formulation.

In most instances, liquid physiological cooling agents may be combined and readily added directly to a gum or confectionery formulation. In other instances, crystalline or powder physiological cooling agents as well as menthol may be dissolved in other liquid physiological cooling agents and the combinations readily added directly to a gum or confectionery formulation. It is also known that some crystalline physiological cooling agents as well as menthol may be combined to form eutectic mixtures which have a lower melting point than the individual crystalline cooling agents themselves. As a result, mixtures of some crystalline physiological cooling agents can be melted, blended together, and remain liquid at or near room temperature and can then be added directly to a chewing gum or confectionery formulation. Combinations of menthol with physiological cooling agents such as menthyl lactate, menthyl succinate, p-menthane carboxamides like WS-3, acyclic carboxamides like WS-23, can be melted together and used readily in liquid form in product formulations.

Most recently, the preferred chewing gum formulation is a sugarless formulation. However, the physiological cooling agents may also be used in a sugar chewing gum. The cooling flavor composition and coated physiological cooling agents may be used in either regular chewing gum or bubble gum.

In other embodiments of this invention, particularly coatings of chewing gum, the concentration of physiological cooling agent or combination of physiological cooling agents will depend on the intensity of the physiological cooling agents and the desired cooling effect. In general the concentration of cooling agents used is between about 0.001% and about 1% by weight of coating. The preferred concentration of cooling agent is between about 0.01% and about 0.5%, more preferably between about 0.02% and about 0.2%.

The present invention contemplates that one or more flavors may be added to the syrup used to make the coating, or applied to the gum center while the syrup coating is drying, or after the coating has dried. Furthermore, the flavor may be applied anywhere within the sequence of coats, for example, after the third, twelfth, eighteenth, etc., coats.

These flavors include any flavor which is of food acceptable quality, including the flavors described earlier for use in chewing gum. The flavor may be added to the coating syrup in an amount such that the coating will contain from about 0.2% to about 1.2% flavor and preferably from about 0.7% to about 1.0% flavor.

For menthol flavored coatings, this concentration of physiological cooling agent allows a reduced overall concentration of menthol. However, it does not completely eliminate menthol, because menthol has a very identifiable unique taste and cooling sensation. Hence, in the case of menthol flavor, the physiological cooling agents only enhance the cooling while reducing the menthol bitterness.

Artificial sweeteners contemplated for use in the coating include but are not limited to synthetic substances, saccharin, Thaumatin, alitame, saccharin salts, aspartame, sucralose, Stevia, and acesulfame. The artificial sweetener may be added to the coating syrup in an amount such that the coating will contain from about 0.02% to about 0.3%, and preferably from about 0.05% to about 0.15% artificial sweetener.

Dispersing agents are often added to syrup coatings for the purpose of whitening and tack reduction. Dispersing agents contemplated by the present invention to be employed in the coating syrup include titanium dioxide, talc, or any other anti-stick compound. Titanium dioxide is a presently preferred dispersing agent of the present invention. The dispersing agent may be added to the coating syrup in amounts such that the coating will contain from about 0.1% to about 1.0%, and preferably from about 0.3% to about 0.6% of the agent.

Coloring agents are preferably added directly to the syrup in the dye or lake form. Coloring agents contemplated by the present invention include food quality dyes. Film formers preferably added to the syrup include methyl cellulose, gelatins, hydroxypropyl cellulose, ethyl cellulose, hydroxyethyl cellulose, carboxymethyl cellulose and the like and combinations thereof. Binding agents may be added either as an initial coating on the chewing gum center or may be added directly into the syrup. Binding agents contemplated by the present invention include gum Arabic, alginate, cellulosics, vegetable gums and the like.

Conventional panning procedures generally use sucrose as the coating material, but recent advances in panning have allowed the use of other carbohydrate materials to be used in the place of sucrose. Some of these components include, but are not limited to, dextrose, maltose, erythritol, xylitol, hydrogenated isomaltulose, maltitol and other new polyols or a combination thereof.

The coating material may be blended with panning modifiers including, but not limited to, gum Arabic, maltodextrins, corn syrup, gelatin, cellulose type materials like carboxymethyl cellulose or hydroxymethyl cellulose, starch and modified starches, vegetable gums like alginates, locust bean gum, guar gum and gum tragacanth, insoluble carbonates like calcium carbonate or magnesium carbonate, and talc. Antitack agents may also be added as panning modifiers, which allow the use of a variety of carbohydrates and sugar alcohols to be used in the development of new panned or coated gum products.

Another type of pan coating would also isolate the physiological cooling agents from the chewing gum ingredients. This technique is referred to as film coating and is more common in pharmaceuticals than in chewing gum, but procedures are similar. A film like shellac, Zein, or cellulose-type material is applied onto a pellet-type product forming a thin film on the surface of the product. The film is applied by mixing the polymer, a plasticizer and a solvent (pigments are optional) and spraying the mixture onto the pellet surface. This is done in conventional type panning equipment, or in more advanced side-vented coating pans. When a solvent like alcohol is used, extra precautions are needed to prevent fires and explosions, and specialized equipment must be used.

Some film polymers can use water as the solvent in film coating. Recent advances in polymer research and in film coating technology eliminates the problem associated with the use of solvents in coating. These advances make it possible to apply aqueous films to a pellet or chewing gum product. As physiological cooling agents are alcohol soluble, they can most likely be added to an alcohol film solution and applied with the film to the pellet or chewing gum product. The alcohol solvent film, in which physiological cooling agent may be dissolved, may also contain a flavor along with the polymer and plasticizer. By adding the physiological cooling agent to the polymer/plasticizer/solvent system, either as an emulsion or solution, the cooling agent can add cooling to the flavor and a balanced flavor/coolness can be obtained. The physiological cooling agent can also be dispersed in the aqueous solvent and coated on the surface with the aqueous film. This will give a unique coolness release to a film coated product.

The chewing gum center of the present invention follows the general pattern outlined below. These centers may contain physiological cooling agents or combinations of physiological cooling agents as an ingredient.

In general, a chewing gum center composition or other chewing gum compositions typically contain a chewable gum base portion which is essentially free of water and is water-insoluble, a water-soluble bulk portion and flavors which are typically water insoluble. The water-soluble portion dissipates with a portion of the flavor over a period of time during chewing. The gum base portion is retained in the mouth throughout the chew.

The insoluble gum base generally comprises elastomers, elastomer solvents, plasticizers, waxes, emulsifiers and inorganic fillers. Plastic polymers, such as polyvinyl acetate, which behave somewhat as plasticizers, are also often included. Other plastic polymers that may be used include polyvinyl laureate, polyvinyl alcohol and polyvinyl pyrrolidone.

Elastomers may include polyisobutylene, butyl rubber, (isobutylene-isoprene copolymer) and styrene butadiene rubber, as well as natural latexes such as chicle. Elastomer solvents are often resins such as terpene resins. Plasticizers, sometimes called softeners, are typically fats and oils, including tallow, hydrogenated and partially hydrogenated vegetable oils, and cocoa butter. Commonly employed waxes include paraffin, microcrystalline and natural waxes such as beeswax and carnauba. Microcrystalline waxes, especially those with a high degree of crystallinity, may be considered bodying agents or textural modifiers.

According to the preferred embodiment of the present invention, the insoluble gum base constitutes between about 5% to about 95% by weight of the gum. More preferably the insoluble gum base comprises between 10% and 50% by weight of the gum and most preferably about 20% to 35% by weight of the gum.

The gum base typically also includes a filler component. The filler component may be calcium carbonate, magnesium carbonate, talc, dicalcium phosphate or the like. The filler may constitute between about 5% and about 60% by weight of the gum base. Preferably the filler comprises about 5% to 50% by weight of the gum base.

Gum bases typically also contain softeners including glycerol monostearate and glycerol triacetate. Gum bases may also contain optional ingredients such as antioxidants, colors, and emulsifiers. The present invention contemplates employing any commercially acceptable gum base.

The water-soluble portion of the chewing gum may further comprise softeners, sweeteners, flavors, physiological cooling agents and combinations thereof. The sweeteners often fulfill the role of bulking agents in the gum. The bulking agents typically comprise about 5% to about 95% of the gum composition.

Softeners are added to the chewing gum in order to optimize the chewability and mouth feel of the gum. Softeners, also known in the art as plasticizers or plasticizing agents, generally constitute between about 0.5% to about 15% of the chewing gum. Softeners contemplated by the present invention include glycerin, lecithin and combinations thereof. Further, aqueous sweetener solutions such as those containing sorbitol, hydrogenated starch hydrolysate, corn syrup and combinations thereof may be used as softeners and binding agents in gum.

As mentioned above, the cooling flavor compositions or coated physiological cooling agents of the present invention will most likely be used in sugarless gum formulations. However, formulations containing sugar are also within the scope of the invention. Sugar sweeteners generally include saccharide-containing components commonly known in the chewing gum art which comprise, but are not limited to, sucrose, dextrose, maltose, dextrin, dried invert sugar, fructose, galactose, corn syrup solids and the like, alone or in any combination.

The cooling flavor compositions and coated physiological cooling agents of the present invention can also be used in combination with sugarless sweeteners. Generally sugarless sweeteners include components with sweetening characteristics but which are devoid of the commonly known sugars and comprise, but are not limited to, sugar alcohols such as sorbitol, hydrogenated isomaltulose, mannitol, xylitol, lactitol, erythritol, hydrogenated starch hydrolysate, maltitol and the like alone or in any combination.

Depending on the particular sweetness release profile and shelf-stability needed, coated or uncoated high-intensity sweeteners may be used in the chewing gum center or in the coating. High-intensity sweeteners, preferably aspartame, may be used at levels from about 0.01% to about 3.0%. Encapsulated aspartame is a high intensity sweetener with improved stability and release characteristics, as compared to free aspartame. Free aspartame can also be added, and a combination of some free and encapsulated aspartame is preferred when aspartame is used. Other high intensity sweeteners that may be used in the gum center are: saccharin, Thaumatin, alitame, saccharin salts, sucralose, Stevia, and acesulfame K.

Optional ingredients such as colors, emulsifiers and pharmaceutical agents may also be added as separate components of the chewing gum composition, or added as part of the gum base.

Aqueous syrups, such as corn syrup and hydrogenated corn syrup may be used, particularly if their moisture content is reduced. This can preferably be done by coevaporating the aqueous syrup with a plasticizer, such as glycerin or propylene glycol, to a moisture content of less than 10%. Preferred compositions include hydrogenated starch hydrolysate solids and glycerin. Such syrups and their methods of preparation are discussed in detail in U.S. Pat. No. 4,671,967.

A preferred method of manufacturing chewing gum according to the present invention is by sequentially adding the various chewing gum ingredients to any commercially available mixer known in the art. After the ingredients have been thoroughly mixed, the gum is discharged from the mixer and shaped into the desired form such as by rolling into sheets and cutting into sticks, extruding into chunks, or casting into pellets.

Generally, the ingredients are mixed by first melting the gum base and adding it to the running mixer. The base may also be melted in the mixer itself. Color or emulsifiers may also be added at this time, along with syrup and a portion of the bulking agent. Further portions of the bulking agent may then be added to the mixer. A flavoring agent is typically added with the final portion of the bulking agent. The physiological cooling agents may be mixed with the flavor composition of the present invention and preferably added as part of the flavor addition. The coated physiological cooling agents of the present invention are preferably added after the final portion of bulking agent and flavor has been added. The entire mixing procedure typically takes from five to fifteen minutes, but longer mixing times may sometime be required. Those skilled in the art will recognize that many variations of the above described procedures may be followed.

Once formed, the chewing gum center can be coated. The coating is initially present as a liquid syrup which contains from about 30% to about 80% or 85% of the coating ingredients previously described herein, and from about 15% or 20% to about 70% of a solvent such as water. In general, the coating process is carried out in conventional panning equipment. Sugarless gum center tablets to be coated are placed into the panning equipment to form a moving mass.

The material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the panning procedure, syrup is added to the gum center tablets at a temperature range of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In another embodiment, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center Tablet. Preferably, no more than about 75 coats are applied to the gum center. More preferably, less than about 60 coats are applied and most preferably, about 30 to about 60 coats are applied. In any event, the present invention contemplates applying an amount of syrup sufficient to yield a coated chewing gum product containing about 10% to about 65% coating. Preferably, the final product will contain from about 20% to about 50% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

Once a coating of syrup is applied to the gum center, the present invention contemplates drying the wet syrup in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possesses a relative humidity of less than about 15 percent. Preferably, the relative humidity of the drying air is less than about 8 percent.

The drying air may be passed over and admixed with the syrup coated gum centers in any way commonly known in the art. Preferably, the drying air is blown over and around the syrup coated gum center at a flow rate, for large scale operations, of about 2800 cubic feet per minute. If lower quantities of material are being processed, or if smaller equipment is used, lower flow rates would be used. If a flavor is applied after a syrup coating has been dried, the present invention contemplates drying the flavor with or without the use of a drying medium.

The table below compares cooling intensity and bitterness intensity of various physiological cooling agents to I-menthol. A taste test method was developed for testing cooling agents compared to I-menthol. A 0.1 gram sample of cooling agent was diluted in 10 ml of food grade ethanol, and 1 ml of this solution was diluted to 100 ml with a 5% sucrose solution, giving a 100 ppm solution. A 10 ml quantity of each solution of cooling agent was kept in the mouth for 10 seconds then expectorated, and cooling and bitterness were rated as the average of “N” test subjects (initial cooling measurements). To calibrate the test subjects on the 1-10 scale, 100 ppm I-menthol solutions were prepared and the test subjects evaluated those first. The remaining cooling agents were evaluated in relation to I-menthol on the 1-10 scale. One cooling agent was evaluated per day, with fresh I-menthol solutions used to calibrate daily.

After reviewing the data, the following observations were made:

1. When initial cooling intensity was measured or extrapolated to equal the mean intensity of 100 ppm I-menthol, the cooling agents and mixtures were ranked. The cooling agents needing the lowest ppm concentration to achieve the 100 ppm I-menthol cooling intensity (measured or extrapolated) were given the highest cooling ranking. Lower ppm levels equate to higher cooling intensity per level of material tested—a positive attribute. Data is presented in Table I below.

2. When initial cooling intensity was measured or extrapolated to equal the mean intensity of 100 ppm I-menthol, the cooling agents that were available as single chemicals were ranked on a molar basis. The cooling agents needing the lowest molar concentration to achieve the 100 ppm I-menthol cooling intensity (measure or extrapolated) were given the highest cooling ranking. Lower molar levels equate to higher cooling intensity per molecule of chemical tested—a positive attributed. Data is presented in Table I below.

3. When bitterness was measured or extrapolated to equal the mean intensity of 100 ppm I-menthol, the cooling agents and mixtures that demonstrated that level of bitterness were ranked. The cooling agents needing the lowest ppm concentration to achieve the 100 ppm I-menthol bitterness intensity (measured or extrapolated) were given the highest bitterness ranking. Lower ppm levels equate to higher bitterness intensity per level of material tested—a negative attribute. Please note the correlation between higher levels of bitterness being associated with cooling agents having the highest cooling activity, the exceptions being WS-3 and WS-23 (high cooling, lower bitterness). Data is presented in the Table below.

TABLE I

| COOLANT OR | COOLING | COOLING | BITTERNESS |
|---|---|---|---|
| MIXTURE | INTENSITY PPM | INTENSITY MOLAR | PPM |
| WS-30 | 63 PPM | 2.44 × 10 | 30 PPM |
| WS-3 | 65 PPM | 3.08 × 10 | 330 PPM |
| /-ISOPULEGOL | 87 PPM | 5.65 × 10 | 81 PPM |
| MENTHYL LACTATE | 95 PPM | 4.17 × 10 | 78 PPM |
| /-MENTHOL | 100 PPM | 6.41 × 10 | 100 PPM |
| MENTHONE | 175 PPM | 7.87 × 10 | 140 PPM |
| GLYCEROL KETAL | | | |
| TCA | 185 PPM | 8.04 × 10 | 160 PPM |
| WS-23 | 200 PPM | 1.17 × 10 | 320 PPM |
| MENTHOL EG | 250 PPM | 1.02 × 10 | 155 PPM |
| CARBONATE | | | |
| WS-14 | 300 PPM | 1.26 × 10 | 400 PPM |
| MENTHYL | 325 PPM | 1.27 × 10 | 275 PPM |
| SUCCINATE | | | |
| MENTHOL PG | 410 PPM | 1.59 × 10 | 90 PPM |
| CARBONATE | | | |
| MENTHANEDIOL | 640 PPM | 3.72 × 10 | 200 PPM |
| HOMOMENTHOL | 825 PPM | 5.81 × 10 | 250 PPM |
| MENTHYL | 950 PPM | 3.52 × 10 | >500 PPM |
| GLUTARATE | | | |

In various multi-component tests, some synergy was noted, with greater levels of cooling detected in some cooling agent combinations and with lower levels of bitterness associated with other cooling agent combinations. However, the best combinations for synergy in cooling with the lowest level of bitterness were the blends of 1) menthyl glutarate and I-isopulegol and 2) menthyl glutarate, I-isopulegol and menthanediol.

Based on the data in the Table above, it would take about two times more menthyl succinate and about half as much I-isopulegol to equal the cooling effect of WS-23. However, as shown in the examples below, about the same level of menthyl succinate as WS-23, along with a very low level of isopulegol and/or menthanediol, can give a similar level of coolness compared to WS-23 in hard candy and chewing gum.

### EXAMPLES

The following sugarless candy formulations can be made in the following examples (all data below are in weight percent):

The example formulations can be prepared by first mixing hydrogenated isomaltulose, xylitol, acesulfame sweetener, and color in water at a level of 75-80% solids. These materials can be mixed at about 220°-230° F. to dissolve the hydrogenated isomaltulose, xylitol, sweetener, and color in a preblend tank. The mixture can then be pumped into a continuous vacuum cooker and heated to 290-310° F. to obtain a cooked hard candy mass having about 1% moisture. The final formulations noted in Table II are on a dry basis. Comparative examples A, C, and E are control samples made with WS-23.

TABLE II

| Examples | A | B | C | D | E | F |
|---|---|---|---|---|---|---|
| Hydrogenated | 98.91 | 98.91 | 98.80 | 98.80 | 98.921 | 98.921 |
| Isomaltulose | | | | | | |
| Xylitol | 1.03 | 1.03 | 1.02 | 1.02 | 1.025 | 1.025 |
| Acesulfame | 0.05 | 0.05 | 0.05 | 0.05 | 0.050 | 0.050 |
| Color | 0.01 | 0.01 | 0.13 | 0.13 | 0.004 | 0.004 |
| Total | 100.0 | 100.0 | 100.0 | 100.0 | 100.0 | 100.0 |

The preblended cooked mass can then be pumped into an in-line mixer where the flavor, flavor extracts, aspartame sweetener, acids, and calcium lactate can be added to the preblend at the levels in Table III:

TABLE III

| Examples | A | B | C | D | E | F |
|---|---|---|---|---|---|---|
| Preblend | 97.72 | 98.70 | 98.03 | 98.02 | 98.90 | 98.88 |
| Flavor | 0.41 | 0.43 | 0.29 | 0.30 | 0.59 | 0.615 |
| Aspartame | 0.06 | 0.06 | 0.06 | 0.06 | 0.06 | −.06 |
| Citric Acid | 1.26 | 1.26 | 1.07 | 1.07 | 0.20 | 0.20 |
| Malic Acid | 0.30 | 0.30 | 0.29 | 0.29 | — | — |
| Calcium Lactate | 0.10 | 0.10 | 0.10 | 0.10 | 0.10 | 0.10 |
| Flavor extracts | 0.10 | 0.10 | 0.10 | 0.16 | 0.15 | 0.15 |
| Total | 100.0 | 100.0 | 100.0 | 100.0 | 100.0 | 100.0 |

The acids and aspartame are dissolved in water at a solids level of between about 40% and about 44% before addition. The preblended cooked mass can be then pumped into an in-line mixer where the flavors, acids, and sweetener can be added to make the final hard candy mass.

The flavor used in Examples A and B can be a lemon/lime flavor, in Examples C and D can be a fruit/lime flavor, and in Examples E and F can be a mint/lemon flavor. The cooling agents to be used and the amounts of flavor and cooling agents in the above examples are shown below in Table IV:

TABLE IV

| Examples | A | B | C | D | E | F |
|---|---|---|---|---|---|---|
| Flavor | 79.25 | 81.90 | 75.60 | 82.51 | 60.00 | 63.58 |
| I-menthol | 12.25 | 11.52 | 12.60 | 12.27 | 35.00 | 32.40 |
| WS-23 | 8.50 | — | 11.80 | — | 5.00 | — |
| Menthyl | — | 5.53 | — | 5.30 | — | 3.50 |
| succinate | | | | | | |
| I-isopulegol | — | 0.35 | — | 0.32 | — | 0.21 |
| Menthanediol | — | 0.70 | — | 0.60 | — | 0.31 |
| Coolant level | | | | | | |
| in candy | | | | | | |
| WS-23 | 354 ppm | — | 347 ppm | — | 297 ppm | |
| Menthyl | — | 230 ppm | — | 160 ppm | — | 212 ppm |
| succinate | | | | | | |
| I-Isopulegol | — | 15 ppm | — | 10 ppm | — | 13 ppm |
| Menthanediol | — | 30 ppm | — | 18 ppm | — | 20 ppm |

After cooling to about 176° F. on a cooling belt, the hard candy mass can be mixed in a batch roller, then sized and cut, and cooled further for wrapping.

Sensory tests of the products, A vs. B, C vs. D, and E vs. F, will show that the samples will have similar cooling and flavor attributes.

Additional hard candy samples can be made as shown in Tables V-VII by a similar process as above with slight variations in the cooling agents, sweeteners and flavor. Table V shows the formulas for the preblend.

TABLE V

| | Example G | Example H | Example J |
|---|---|---|---|
| Hydrogenated Isomaltulose | 98.915 | 98.803 | 98.922 |
| Xylitol | 1.025 | 1.024 | 1.025 |
| Acesulfame | 0.046 | 0.046 | 0.046 |
| Color | 0.014 | 0.127 | 0.007 |
| Total | 100.0 | 100.0 | 100.0 |

Table VI shows the formulas for hard candy.

TABLE VI

| | Example G | Example H | Example J |
|---|---|---|---|
| Preblend | 97.50 | 97.84 | 98.68 |
| Flavor | 0.44 | 0.30 | 0.61 |
| Aspartame | 0.06 | 0.06 | 0.06 |
| Citric Acid | 1.26 | 1.07 | 0.20 |
| Malic Acid | 0.30 | 0.29 | — |
| Calcium Lactate | 0.10 | 0.10 | 0.10 |
| Flavor Extracts | 0.34 | 0.33 | 0.35 |
| Total | 100.0 | 100.0 | 100.0 |

Table VII shows the flavor and cooling agent compositions and amounts. Example G is a lemon/lime flavor, Example H is a fruit/lime flavor, and Example J is a mint/lemon flavor.

TABLE VII

| | Example G | Example H | Example J |
|---|---|---|---|
| Flavor | 84.07 | 80.65 | 62.90 |
| Menthol | 10.79 | 12.06 | 32.48 |
| Menthyl Succinate | 3.48 | 4.93 | 3.34 |
| Isopulegol | 0.83 | 1.18 | 0.64 |
| Menthanediol | 0.83 | 1.18 | 0.64 |

Coolant level in candy:

| | | | |
|---|---|---|---|
| Menthyl Succinate | 153 ppm | 150 ppm | 206 ppm |
| Isopulegol | 36 ppm | 36 ppm | 39 ppm |
| Menthanediol | 36 ppm | 36 ppm | 39 ppm |

Sensory tests of the products, A vs. G, C vs. H, and E vs. J, will show these examples to be similar in cooling and flavor attributes compared to Examples B, D, and F.

The examples of chewing gum below can be made on a lab scale. The same formula can be used for both the comparative examples and the inventive examples. In each example, WS-23 can be replaced by approximately the same level of the blend of cooling agents. The formulas used are in Table VIII. Comparative Examples K and M are peppermint flavored gums and comparative Example L is a blackcurrant flavored gum.

TABLE VIII

| | Example K | Example L | Example M |
|---|---|---|---|
| Gum Base | 25.85 | 32.00 | 30.00 |
| Calcium Carbonate | — | 14.90 | 11.00 |
| Sorbitol | 49.89 | 45.48 | 59.72 |
| Glycerin | 8.24 | 1.50 | 5.50 |
| Mannitol | 5.00 | — | — |
| Coevaporated Hydrogenated | 7.95 | — | — |
| Starch Hydrolysate/Glycerin | | | |
| Flavor | 1.24 | 1.35 | 1.70 |
| Encapsulated Sweeteners | 1.05 | 0.87 | 0.90 |
| Encapsulated Flavor | — | 1.50 | — |
| Free APM/ACK | 0.13 | — | 0.05 |
| Sodium Bicarbonate | 0.25 | — | 0.38 |
| Sodium Ascorbate | — | 1.40 | — |
| Lecithin | 0.20 | — | 0.40 |
| Menthol | 0.05 | 1.00 | 0.20 |
| WS-23 | 0.15 | — | 0.15 |
| Total | 100.0 | 100.0 | 100.0 |

Examples L and M can be coated to make coated products with the following coating formulas:

TABLE IX

| | Example K | Example L | Example M |
|---|---|---|---|
| Gum Center | — | 67.50 | 67.50 |
| Hydrogenated Isomaltulose | — | 30.41 | — |
| Xylitol | — | — | 26.08 |
| Gum Talha | — | 0.80 | 2.70 |
| Calcium Carbonate | — | — | 3.20 |
| Titanium Dioxide | — | 0.33 | 0.30 |
| Flavor | — | 0.28 | 0.13 |
| Sweetener | — | 0.17 | — |
| Wax and talc | — | 0.11 | 0.09 |
| Menthol | — | 0.36 | — |
| WS-23 | — | 0.018 | — |
| Color | — | 0.022 | — |
| Total | — | 100.0 | 100.0 |

In inventive Example N, the 1500 ppm WS-23 in comparative Example K was replaced with 270 ppm of menthyl succinate and 763 ppm of isopulegol. In inventive Example P, the 180 ppm WS-23 in the coating of comparative Example L was replaced with 28 ppm of menthyl succinate and 106 ppm of isopulegol. In inventive Example Q, the 1500 ppm WS-23 in comparative Example M was replaced with 235 ppm of menthyl succinate and 881 ppm of isopulegol.

Evaluation of these inventive examples will indicate the cooling level, cooling quality, and cooling duration will be similar to WS-23 for the blend of menthyl succinate and isopulegol compared to WS-23.

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

### Examples

Although many of the physiological cooling agents are similar to menthol in that they are a type of menthol derivative, the cooling agents are separated here into the following specific groups:

### Group A

The following Group A is a list of some p-menthane carboxamides, p-menthane carboxylic acids, and other p-menthane derivatives:
1) N-Ethyl-p-menthane-carboxamide, WS-3 (FEMA 3455);
2) N-[[5-methyl-2-(1-methylethyl)-cyclohexyl]carbonyl]glycine ethyl ester, also called [(Ethoxycarbonyl)methyl]-p-menthane-3-carboxamide, WS-5 (FEMA 4309);
3) N-(4-methoxyphenyl)-p-menthane-3-carboxamide, WS-12;
4) N-(t-butyl)-p-menthane-3-carboxamide, WS-14;
5) N-(2-ethoxyethyl)-p-menthane-3-carboxamide,
6) L-N-(menthanecarboxyl)-glycine-N-isobutyl amide;
7) N-(p-benzene acetonitrile)-p-menthane-carboxamide, BAMC (FEMA 4496);
8) N-(2-(Pyridin-2-yl)ethyl)-3-p-menthane-carboxamide, PEMC (FEMA 4549);
9) N-(1-phenyl-(3,4-methylenendioxy))-p-methane-3-carboxamide;
10) N-methyl, N-(1-hydroxylbenzyl-(3-hydroxyl))-amide of p-methane-3-carboxylic acid, HHPMC;
11) N-(g-lactone of 4-hydroxybutyric acid-2-yl)p-methane-3-carboxamide, LHPMC;
12) N-(1,1-diisopropylethane)-phenyl-(3,4-methylenendioxyl)-1-carboxamide;
13) N-(2-methyl-1-isopropylpropane)-phenyl-(3-cyano)-1-carboxamide;
14) Glycerol ester of p-methane-3-carboxylic acid, WS-30;
15) Ethylene glycol ester of p-menthane-3-carboxylic acid, WS-4
16) N-ethyl-2-isopropyl-bicyclo [2.2.1]heptane-2-carboxamide, WS-211.
17) p-menthane-3-carboxylic acid, also called WS-1;

### Group B

The following Group B is a list of acyclic carboxamides (AC) consisting mostly of butanamides:
18) N,2,3-trimethyl-2-isopropyl butanamide, WS-23 (FEMA 3804);
19) N,2-diethyl-3-methyl-2-isopropyl butanamide, DMIB (FEMA 4557);
20) N-(1,1-dimethyl-2-hydroxyethyl)-2,2-diethyl butanamide, DHDB (FEMA 4603);
21) N-(2-hydroxyethyl)-2,3-dimethyl-2-isopropyl butanamide, HDIB (FEMA 4602);
22) N-(2-ethoxyethyl)-2,3-dimethyl-2-isopropyl butanamide, EDIB;
23) N-(3-ethoxypropyl)-2-isopropyl-2,3-dimethyl butanamide;
24) N-(3-propoxypropyl-2-isopropyl-2,3-dimethyl butanamide;
25) N-(3-butoxypropyl-2-isopropyl-2,3-dimethyl butanamide;

### Group C

Other coolants listed in Group C are referred to in a general category as mostly menthol or menthone type derivatives:
26) I-Menthoxy ethanol, MENETH (FEMA 4154);
27) Menthone lactic acid ketal, MLAK (FEMA 4285);
28) Menthol methyl ether, MME (FEMA 4054);
29) p-Mentha-3,8-diol, also called menthanediol, (FEMA 4053);
30) Isopulegol or p-menth-8-ene-3-ol, (FEMA 2962);
31) 3-(1-menthoxy)-2-methylpropane-1,2-diol, (FEMA 3849);
32) Menthone glycerol ketal (MGK), (FEMA 3807);
33) 3-l-Menthoxypropane-1,2-diol (also called Menthol glycerin ether), (TCA), (FEMA 3784);

### Group D

Other coolants are menthol esters, acids, and menthol salts, which are listed here in Group D:
34) Menthyl aceto acetate, MAA (FEMA 4327);
35) Menthyl 3,6-dioxaheptanoate;
36) Menthyl-3-hydroxybutyrate, MHB (FEMA 4308);
37) Menthyl menthoxy acetate, MMA;
38) Menthyl lactoyl lactate, MLL;
39) Menthol ethylene glycol carbonate, MEGC, (FEMA 3805);
40) Menthol propylene glycol carbonate, MPGC, (FEMA 3806);
41) Menthyl pyrrolidone carboxylate, MPC, (FEMA 4155);
42) Menthyl lactate, ML, (FEMA 3748);
43) Menthyl succinate, MS, (FEMA 3810);
44) Menthyl glutarate, MG, (FEMA 4006);
45) Menthyl N,N-dimethyl succinamide, (FEMA 4230);

### Group E

Other coolants that are not part of other categories are listed here as Group E:
46) Cubebol, (FEMA 4497);
47) 2-sec butyl cyclohexanone, BCH, (FEMA 3261);
48) 2,5-dimethyl-4-(1-pyrrolidinyl)-3-(2H)-furanone;
49) 4,5-dimethyl-3-(1-pyrrolidinyl)-2-(5H)-furanone;
50) 3-Methyl-2-(1-pyrrolidinyl)-2-cyclopenten-1-one;
51) 5-Methyl-2-(1-pyrrolidinyl)-2-cyclopenten-1-one;
52) 4-Methyl-3-(1-pyrrolidinyl)-2-(5H)-furanone;
53) 5-Methyl-4-(1-pyrrolidinyl)-3-(2H)-furanone.
54) Homomenthol or 3,3,5-trimethyl cyclohexanol, (FEMA 3962);

Any of the coolants listed in Group A can be mixed together to form a blend, any of the coolants listed in Group B can be mixed together to form a blend, any of the coolants listed in Group C can be mixed together to form a blend, any of the coolants listed in Group D can be mixed together to form a blend, and any of the coolants listed in Group E can be mixed together to form a blend. Blends can also be mixtures of multiple combinations of coolants with any 2 or more coolants in a specific Group. In addition the coolants from any of the Groups may be blended with any of the coolants from any of the other Groups. Coolants from any of the 3, 4 or even all 5 groups can also be mixed to form blends. The following table discloses various combinations of coolants in the 5 groups that can be combined in a variety of chewing gum products:

| Coolant Blend | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| p-Menthane | A | | | A | A | | | | A | | A | A | | | A | | A |
| carboxamides | | | | | | | | | | | | | | | | | |
| Butanamides | B | B | | | | B | | | B | B | | B | B | | B | B | B |
| Menthol | | C | C | C | | | C | | C | | C | | C | C | C | C | C |
| derivatives | | | | | | | | | | | | | | | | | |
| Menthol esters | | | D | | | | | D | | D | D | D | D | D | D | D | D |
| Other | | | | | E | E | E | E | | E | | | | E | | E | E |

### Examples 1 and 2

Cooling blends 1-17 may be mixed with a cherry flavor and used to make two cherry flavored sugarless gum formulas. Products would have a slightly minty flavor with cherry. When a peppermint flavor is used in place of the cooling blend in comparable formulas, the minty character is too strong. The cooling blend can give a high quality cool cherry mint flavored product as formulated below:

TABLE 1

| | Example 1 | Example 2 |
|---|---|---|
| Sorbitol | 49.51 | 51.44 |
| Base | 28.50 | 25.00 |
| Glycerin | 12.00 | 12.00 |
| Cherry Flavor | 3.0848 | 2.8848 |
| Cooling Blends 1-17 | 0.1152 | 0.1152 |
| Spray Dried Cherry Flavor | 0.30 | — |
| Xylitol | 1.50 | 4.50 |
| Fumaric, Citric, and Adipic Acids | 2.10 | 2.10 |
| Encapsulated Sweeteners | 1.36 | 1.36 |
| Salt Solution | 0.75 | — |
| Color | 0.28 | 0.30 |
| Lecithin | 0.50 | 0.30 |
| TOTAL | 100.00 | 100.00 |

### Examples 3, 4 and 5

Cooling blends 1-17 may be used in sugarless wintergreen flavored chewing gum and can give improved cooling without mint flavor according to the following formulas:

TABLE 2

| | Example 3 | Example 4 | Example 5 |
|---|---|---|---|
| Sorbitol | 49.60 | 50.01 | 48.76 |
| Base | 25.10 | 25.10 | 25.10 |
| Glycerin | 14.00 | 6.00 | 14.00 |
| Maltitol | 5.00 | 7.00 | 10.00 |
| Coevaporated Glycerin/Lycasin* | 3.50 | 9.50 | — |
| Wintergreen Flavor | 1.1296 | 1.1296 | 1.1296 |
| Cooling Blends 1-17 | 0.4704 | 0.4704 | 0.4704 |
| Encapsulated Wintergreen Flavor | 0.1625 | 0.1625 | — |
| Encapsulated Menthol | 0.0875 | 0.0875 | — |
| Encapsulated Sweeteners | 0.54 | 0.54 | 0.54 |
| Salt Solution** | 0.28 | — | — |
| Color | 0.13 | — | — |
| TOTAL | 100.00 | 100.00 | 100.00 |

*Contains 25% glycerin, 67.5% Lycasin brand hydrogenated starch hydrolysate solids and 7.5% water.
**Contains 10% NaCl and 90% water.

### Examples 6 through 10

Cooling blends 1-17 may be used in spearmint and peppermint flavored chewing gums of Examples 6 through 10 to give improved cooling with mint flavor. The increased cooling can yield products with less bitterness and harshness, and can give good minty tasting products. The following formulas can be made:

TABLE 3

| | Example 6 | Example 7 | Example 8 | Example 9 | Example 10 |
|---|---|---|---|---|---|
| Sorbitol | 47.21 | 48.60 | 32.76 | 48.41 | 40.60 |
| Base | 25.00 | 25.00 | 37.35 | 25.00 | 30.00 |
| Glycerin | 6.00 | 11.40 | 12.00 | 8.00 | 10.00 |
| Coevaporated | 9.50 | 7.67 | — | 9.50 | 3.50 |
| Glycerin/Lycasin* | | | | | |
| Maltitol^{A}/Mannitol^{B} | 10.00^{A} | 5.00^{A} | 3.07^{B} | 5.00^{B} | 7.00^{B} |
| Spearmint Flavor | 1.0908 | 1.0908 | — | — | — |
| Cooling Blends 1-17 | 0.2592 | 0.2592 | 0.7425 | 0.7425 | 0.40 |
| Peppermint Flavor | — | — | 1.5075 | 1.5075 | 1.60 |
| Lecithin | 0.30 | 0.30 | 0.40 | 0.30 | 0.30 |
| Calcium | — | — | 9.66 | — | 5.00 |
| Carbonate | | | | | |
| Encapsulated | — | 0.20 | 1.50 | 1.00 | 1.00 |
| Menthol | | | | | |
| Encapsulated | 0.54 | 0.34 | 0.34 | 0.54 | 0.60 |
| Sweetener | | | | | |
| Salt Solution** | 0.10 | 0.10 | 0.67 | — | — |
| Color | — | 0.04 | — | — | — |
| TOTAL | 100.00 | 100.00 | 100.00 | 100.00 | 100.00 |

*Contains 25% glycerin, 67.5% Lycasin brand hydrogenated starch hydrolysate solids and 7.5% water.
**Contains 10% NaCl and 90% water.

### Examples 11 through 105

The following formulations contain combinations of specific cooling agents that may give fast and slow release and may be synergistic to increase cooling when used in the same formulation:

TABLE 4
SUGARLESS CHEWING GUM

| | Example 11 | Example 12 | Example 13 | Example 14 |
|---|---|---|---|---|
| Base | 33.10 | 28.00 | 30.00 | 28.00 |
| Calcium Carbonate | — | — | 11.00 | — |
| Sorbitol | 55.90 | 54.36 | 46.08 | 49.52 |
| Glycerin | 8.00 | 5.40 | 0.40 | 8.30 |
| Liquid Sorbitol | — | 6.00 | 6.20 | 2.00 |
| Encapsulated Sweetener | 0.70 | 0.24 | 0.24 | 0.82 |
| Menthol | 1.10 | — | 0.26 | 0.30 |
| Active MS/TCA* | 0.10 | 0.20 | 0.12 | 0.16 |
| Mannitol | — | 3.00 | 3.00 | 8.00 |
| Peppermint Flavor | 1.10 | 2.00 | — | — |
| Methyl Salicylate Flavor | — | — | 1.90 | 1.90 |
| Lecithin | — | 0.80 | 0.80 | 1.00 |
| Encapsulated Menthol/Flavor | — | — | — | — |
| TOTAL | 100.00 | 100.00 | 100.00 | 100.00 |

*50/50 combination of Menthyl succinate and TCA

TABLE 5
SUGARLESS CHEWING GUM

| | Example 15 | Example 16 | Example 17 |
|---|---|---|---|
| Base | 29.00 | 31.60 | 33.60 |
| Calcium Carbonate | 15.00 | 11.00 | 13.00 |
| Sorbitol | 41.26 | 44.48 | 47.73 |
| Glycerin | 10.00 | 0.80 | 0.75 |
| Liquid Sorbitol | — | 7.20 | — |
| Encapsulated Sweetener | 0.40 | 0.66 | 0.66 |
| Menthol | 0.90 | 0.30 | 0.30 |
| Active MS/MGK * | 0.14 | 0.06 | 0.06 |
| Mannitol | — | — | — |
| Peppermint Flavor | 1.30 | 1.40 | 1.40 |
| Methyl Salicylate Flavor | — | — | — |
| Lecithin | — | 0.50 | 0.50 |
| Encapsulated Menthol/Flavor | 2.00 | 2.00 | 2.00 |
| TOTAL | 100.00 | 100.00 | 100.00 |

* 50/50 combination of MS and MGK

Any N-substituted p-menthane carboxamides, carboxylic acid or carboxamide from Group A, for example Glycerol ester of p-menthane-3-carboxylic acid (WS-30), when combined with menthone ketals such as menthone glycerol ketal, may produce synergistic cooling effects in chewing gum. It is also possible to take advantage of differing release rates of the two cooling agents to provide a fast cooling release and a long lasting cooling in the same product. For example, chewing gums may be prepared from the following formulas:

TABLE 6

| | Example 18 | Example 19 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| WS-30 | 0.08 | 0.06 |
| Menthone Glycerol Ketal | 0.11 | 0.08 |
| TOTAL | 100.00 | 100.00 |

Other N-substituted p-menthane carboxamides, carboxylic acids or carboxamide from Group A can also be used to produce synergistic effects in chewing gum. Some of these are:
1) N-[[5-methyl-2-(1-methylethyl)-cyclohexyl]carbonyl]glycine, WS-5 (FEMA 4309);
2) N-(4-methoxyphenyl)-p-menthane-3-carboxamide, WS-12;
3) N-(t-butyl)-p-menthane-3-carboxamide, WS-14;
4) Ethylene glycol ester of p-menthane-3-carboxylic acid, WS-4
5) N-(p-benzene acetonitrile)-p-menthane-carboxamide, BAMC (FEMA 4496);
6) N-(2-(Pyridin-2-yl)ethyl)-3-p-menthane-carboxamide, PEMC (FEMA 4549);

TABLE 7

| | Example 20 | Example 21 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| WS-5 | 0.08 | 0.06 |
| Menthone Glycerol Ketal | 0.11 | 0.08 |
| TOTAL | 100.00 | 100.00 |

TABLE 8

| | Example 22 | Example 23 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| BAMC | 0.08 | 0.06 |
| Menthone Glycerol Ketal | 0.11 | 0.08 |
| TOTAL | 100.00 | 100.00 |

TABLE 9

| | Example 24 | Example 25 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| PEMC | 0.08 | 0.06 |
| Menthone Glycerol Ketal | 0.11 | 0.08 |
| TOTAL | 100.00 | 100.00 |

TABLE 10

| | Example 26 | Example 27 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| WS-4 | 0.08 | 0.06 |
| Menthone Glycerol Ketal | 0.11 | 0.08 |
| TOTAL | 100.00 | 100.00 |

TABLE 11

| | Example 28 | Example 29 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| WS-14 | 0.08 | 0.06 |
| Menthone Glycerol Ketal | 0.11 | 0.08 |
| TOTAL | 100.00 | 100.00 |

TABLE 12

| | Example 30 | Example 31 |
|---|---|---|
| Gum Base | 25.00 | 30.00 |
| Sugar | 57.11 | 58.46 |
| Corn Syrup | 15.00 | 9.00 |
| Glycerin | 2.00 | 1.50 |
| Spearmint Oil | 0.70 | — |
| Peppermint Oil | — | 0.90 |
| WS-12 | 0.08 | 0.06 |
| Menthone Glycerol Ketal | 0.11 | 0.08 |
| TOTAL | 100.00 | 100.00 |

Additional cooling agents from the other Groups B, C, D or E may also be added as in some of the following examples:

TABLE 13

| | Example | Example | Example | Example | Example | Example |
|---|---|---|---|---|---|---|
| | 32 | 33 | 34 | 35 | 36 | 37 |
| Gum Base | 48.00 | 35.00 | 30.00 | 25.00 | 22.00 | 30.00 |
| Sorbitol | 34.05 | 49.05 | 53.07 | 60.69 | 59.54 | 51.12 |
| Hydrogenated | — | — | — | 7.5 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-5 | 0.30 | 0.10 | 0.08 | 0.11 | 0.13 | 0.04 |
| Menthane | 0.05 | 0.10 | 0.20 | 0.35 | 0.05 | 0.04 |
| Glycerol Ketal | | | | | | |
| Butanamides | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Succinate | | | | | | |
| | 100.00 | 100.00 | 100.00 | 100.00 | 100.00 | 100.00 |

TABLE 14

| | Example | Example | Example | Example | Example | Example |
|---|---|---|---|---|---|---|
| | 38 | 39 | 40 | 41 | 42 | 43 |
| Gum Base | 48.00 | 35.00 | 30.00 | 25.00 | 22.00 | 30.00 |
| Sorbitol | 34.05 | 49.05 | 53.07 | 60.69 | 59.54 | 51.12 |
| Hydrogenated | — | — | — | 7.5 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| BAMC | 0.30 | 0.10 | 0.08 | 0.11 | 0.13 | 0.04 |
| Menthane | 0.05 | 0.10 | 0.20 | 0.35 | 0.05 | 0.04 |
| Glycerol Ketal | | | | | | |
| Butanamides | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Succinate | | | | | | |
| | 100.00 | 100.00 | 100.00 | 100.00 | 100.00 | 100.00 |

TABLE 15

| | Example | Example | Example | Example | Example | Example |
|---|---|---|---|---|---|---|
| | 44 | 45 | 46 | 47 | 48 | 49 |
| Gum Base | 48.00 | 35.00 | 30.00 | 25.00 | 22.00 | 30.00 |
| Sorbitol | 34.05 | 49.05 | 53.07 | 60.69 | 59.54 | 51.12 |
| Hydrogenated | — | — | — | 7.5 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| PEMC | 0.30 | 0.10 | 0.08 | 0.11 | 0.13 | 0.04 |
| Menthane | 0.05 | 0.10 | 0.20 | 0.35 | 0.05 | 0.04 |
| Glycerol Ketal | | | | | | |
| Butanamides | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Succinate | | | | | | |
| | 100.00 | 100.00 | 100.00 | 100.00 | 100.00 | 100.00 |

TABLE 16

| | Example | Example | Example | Example | Example | Example |
|---|---|---|---|---|---|---|
| | 50 | 51 | 52 | 53 | 54 | 55 |
| Gum Base | 48.00 | 35.00 | 30.00 | 25.00 | 22.00 | 30.00 |
| Sorbitol | 34.05 | 49.05 | 53.07 | 60.69 | 59.54 | 51.12 |
| Hydrogenated | — | — | — | 7.5 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-4 | 0.30 | 0.10 | 0.08 | 0.11 | 0.13 | 0.04 |
| Menthane | 0.05 | 0.10 | 0.20 | 0.35 | 0.05 | 0.04 |
| Glycerol Ketal | | | | | | |
| Butanamides | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Succinate | | | | | | |
| | 100.00 | 100.00 | 100.00 | 100.00 | 100.00 | 100.00 |

TABLE 17

| | Example | Example | Example | Example | Example | Example |
|---|---|---|---|---|---|---|
| | 56 | 57 | 58 | 59 | 60 | 61 |
| Gum Base | 48.00 | 35.00 | 30.00 | 25.00 | 22.00 | 30.00 |
| Sorbitol | 34.05 | 49.05 | 53.07 | 60.69 | 59.54 | 51.12 |
| Hydrogenated | — | — | — | 7.5 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-14 | 0.30 | 0.10 | 0.08 | 0.11 | 0.13 | 0.04 |
| Menthane | 0.05 | 0.10 | 0.20 | 0.35 | 0.05 | 0.04 |
| Glycerol Ketal | | | | | | |
| Butanamides | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Succinate | | | | | | |
| | 100.00 | 100.00 | 100.00 | 100.00 | 100.00 | 100.00 |

TABLE 18

| | Example | Example | Example | Example | Example | Example |
|---|---|---|---|---|---|---|
| | 62 | 63 | 64 | 65 | 66 | 67 |
| Gum Base | 48.00 | 35.00 | 30.00 | 25.00 | 22.00 | 30.00 |
| Sorbitol | 34.05 | 49.05 | 53.07 | 60.69 | 59.54 | 51.12 |
| Hydrogenated | — | — | — | 7.5 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-12 | 0.30 | 0.10 | 0.08 | 0.11 | 0.13 | 0.04 |
| Menthane | 0.05 | 0.10 | 0.20 | 0.35 | 0.05 | 0.04 |
| Glycerol Ketal | | | | | | |
| Butanamides | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Succinate | | | | | | |
| | 100.00 | 100.00 | 100.00 | 100.00 | 100.00 | 100.00 |

Acyclic carboxamides or butanamides from Group B may produce synergistic cooling effects when combined with menthone ketals, such as menthone glycerol ketal, in chewing gum. The butanamides used in the following tables are:
1) N,2,3-Trimethyl-2-isopropyl butanamide (WS-23), FEMA 3804;
2) N,2-Diethyl-3-methyl-2-isopropyl butanamide (DMIB), FEMA 4557;
3) N-(1,1-dimethyl-2-hydroxyethyl)-2,2-diethyl butanamide (DHDB), FEMA 4603;
4) N-(2-hydroxyethyl)-2,3-dimethyl-2-isopropyl butanamide (HDIB), FEMA 4602;
5) N-(2-ethoxyethyl)-2,3-dimethyl-2-isopropyl butanamide (EDIB)

It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 19

| | Example 68 | Example 69 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| DMIB | 0.08% | 0.06% |
| Menthone Glycerol Ketal | 0.11% | 0.08% |
| TOTAL | 100.00 | 100.00 |

TABLE 20

| | Example 70 | Example 71 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| DHDB | 0.08% | 0.06% |
| Menthone Glycerol Ketal | 0.11% | 0.08% |
| TOTAL | 100.00 | 100.00 |

TABLE 21

| | Example 72 | Example 73 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| HDIB | 0.08% | 0.06% |
| Menthone Glycerol Ketal | 0.11% | 0.08% |
| TOTAL | 100.00 | 100.00 |

TABLE 22

| | Example 74 | Example 75 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| EDIB | 0.08% | 0.06% |
| Menthone Glycerol Ketal | 0.11% | 0.08% |
| TOTAL | 100.00 | 100.00 |

Additional cooling agents from the other Groups A, C, D or E may also be added as in some of the following examples:

TABLE 23

| | Example | Example | Example | Example | Example | Example |
|---|---|---|---|---|---|---|
| | 76 | 77 | 78 | 79 | 80 | 81 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-23 | 0.30 | 0.10 | 0.08 | 0.11 | 0.13 | 0.04 |
| Menthone | 0.05 | 0.10 | 0.20 | 0.35 | 0.05 | 0.04 |
| Glycerol Ketal | | | | | | |
| PEMC | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthol | — | 0.15 | — | — | — | 0.25 |
| | 100.00 | 100.00 | 100.00 | 100.00 | 100.00 | 100.00 |

TABLE 24

| | Example | Example | Example | Example | Example | Example |
|---|---|---|---|---|---|---|
| | 82 | 83 | 84 | 85 | 86 | 87 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| DMIB | 0.30 | 0.10 | 0.08 | 0.11 | 0.13 | 0.04 |
| Menthone | 0.05 | 0.10 | 0.20 | 0.35 | 0.05 | 0.04 |
| Glycerol Ketal | | | | | | |
| PEMC | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthol | — | 0.15 | — | — | — | 0.25 |
| | 100.00 | 100.00 | 100.00 | 100.00 | 100.00 | 100.00 |

TABLE 25

| | Example | Example | Example | Example | Example | Example |
|---|---|---|---|---|---|---|
| | 88 | 89 | 90 | 91 | 92 | 93 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| DHDB | 0.30 | 0.10 | 0.08 | 0.11 | 0.13 | 0.04 |
| Menthone | 0.05 | 0.10 | 0.20 | 0.35 | 0.05 | 0.04 |
| Glycerol Ketal | | | | | | |
| PEMC | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthol | — | 0.15 | — | — | — | 0.25 |
| | 100.00 | 100.00 | 100.00 | 100.00 | 100.00 | 100.00 |

TABLE 26

| | Example | Example | Example | Example | Example | Example |
|---|---|---|---|---|---|---|
| | 94 | 95 | 96 | 97 | 98 | 99 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| HDIB | 0.30 | 0.10 | 0.08 | 0.11 | 0.13 | 0.04 |
| Menthone | 0.05 | 0.10 | 0.20 | 0.35 | 0.05 | 0.04 |
| Glycerol Ketal | | | | | | |
| PEMC | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthol | — | 0.15 | — | — | — | 0.25 |
| | 100.00 | 100.00 | 100.00 | 100.00 | 100.00 | 100.00 |

TABLE 27

| | Example | Example | Example | Example | Example | Example |
|---|---|---|---|---|---|---|
| | 100 | 101 | 102 | 103 | 104 | 105 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| EDIB | 0.30 | 0.10 | 0.08 | 0.11 | 0.13 | 0.04 |
| Menthone | 0.05 | 0.10 | 0.20 | 0.35 | 0.05 | 0.04 |
| Glycerol Ketal | | | | | | |
| PEMC | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthol | — | 0.15 | — | — | — | 0.25 |
| | 100.00 | 100.00 | 100.00 | 100.00 | 100.00 | 100.00 |

Acyclic carboxamides or butanamides, for example N,2-diethyl-3-methyl-2-isopropyl butanamide (DMIB) or any of the other butanamides from Group B noted above, may produce synergistic cooling effects when combined with menthol in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 28

| | Example 106 | Example 107 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| DMIB | 0.04% | 0.06% |
| Menthol | 0.50% | 0.25% |
| TOTAL | 100.00 | 100.00 |

TABLE 29

| | Example 108 | Example 109 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| DHDB | 0.04% | 0.06% |
| Menthol | 0.50% | 0.25% |
| TOTAL | 100.00 | 100.00 |

TABLE 30

| | Example 110 | Example 111 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| HDIB | 0.04% | 0.06% |
| Menthol | 0.50% | 0.25% |
| TOTAL | 100.00 | 100.00 |

TABLE 31

| | Example 112 | Example 113 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| EDIB | 0.04% | 0.06% |
| Menthol | 0.50% | 0.25% |
| TOTAL | 100.00 | 100.00 |

Additional cooling agents from the other Groups A, C, D or E may also be added as in some of the following examples:

TABLE 32

| | Example | Example | Example | Example | Example | Example |
|---|---|---|---|---|---|---|
| | 114 | 115 | 116 | 117 | 118 | 119 |
| Gum Base | 48.00 | 35.00 | 30.00 | 25.00 | 22.00 | 30.00 |
| Sorbitol | 33.85 | 48.60 | 53.12 | 60.39 | 59.11 | 50.52 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.10 | — |
| Salicylate | | | | | | |
| Peppermint Oil | 1.30 | 0.40 | — | 0.95 | 0.80 | 1.20 |
| Spearmint Oil | 0.20 | 0.80 | 0.80 | — | — | — |
| DMIB | 0.30 | 0.10 | 0.08 | 0.11 | 0.24 | 0.18 |
| Menthol | 0.25 | 0.40 | 0.15 | 0.35 | 0.05 | 0.45 |
| WS-30 | — | 0.05 | 0.05 | — | 0.08 | — |
| Menthyl | 0.30 | — | 0.20 | 0.20 | 0.16 | 0.10 |
| Glutarate | | | | | | |
| Menthyl | — | — | — | 0.10 | — | 0.05 |
| Succinate | | | | | | |
| Isopulegol | — | 0.15 | — | 0.20 | 0.16 | 0.10 |
| | 100.00 | 100.00 | 100.00 | 100.00 | 100.00 | 100.00 |

TABLE 33

| | Example | Example | Example | Example | Example | Example |
|---|---|---|---|---|---|---|
| | 120 | 121 | 122 | 123 | 124 | 125 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| DHDB | 0.30 | 0.10 | 0.08 | 0.11 | 0.13 | 0.04 |
| Menthol | 0.25 | 0.40 | 0.15 | 0.35 | 0.05 | 0.45 |
| WS-30 | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 34

| | Example | Example | Example | Example | Example | Example |
|---|---|---|---|---|---|---|
| | 126 | 127 | 128 | 129 | 130 | 131 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| HDIB | 0.30 | 0.10 | 0.08 | 0.11 | 0.13 | 0.04 |
| Menthol | 0.25 | 0.40 | 0.15 | 0.35 | 0.05 | 0.45 |
| WS-30 | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 35

| | Example | Example | Example | Example | Example | Example |
|---|---|---|---|---|---|---|
| | 132 | 133 | 134 | 135 | 136 | 137 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| EDIB | 0.30 | 0.10 | 0.08 | 0.11 | 0.13 | 0.04 |
| Menthol | 0.25 | 0.40 | 0.15 | 0.35 | 0.05 | 0.45 |
| WS-30 | — | 0.05 | 0.05 | — | — | — |
| Menthyl | 0.30 | — | 0.20 | — | — | 0.10 |
| Glutarate | | | | | | |
| Menthyl | — | — | — | 0.20 | 0.08 | 0.10 |
| Lactate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

Menthyl succinate may produce synergistic cooling effects when combined with acyclic carboxamides, for example N,2-diethyl-3-methyl-2-isopropyl butanamide (DMIB), or any of the other acyclic carboxamides or butanamides noted above in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 36

| | Example 138 | Example 139 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| DMIB | 0.08% | 0.06% |
| Menthyl Succinate | 0.11% | 0.08% |
| TOTAL | 100.00 | 100.00 |

TABLE 37

| | Example 140 | Example 141 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| DHDB | 0.08% | 0.06% |
| Menthyl Succinate | 0.11% | 0.08% |
| TOTAL | 100.00 | 100.00 |

TABLE 38

| | Example 142 | Example 143 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| HDIB | 0.08% | 0.06% |
| Menthyl Succinate | 0.11% | 0.08% |
| TOTAL | 100.00 | 100.00 |

TABLE 39

| | Example 144 | Example 145 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| EDIB | 0.08% | 0.06% |
| Menthyl Succinate | 0.11% | 0.08% |
| TOTAL | 100.00 | 100.00 |

Additional cooling agents from the other Groups A, C, D and E may also be added as in some of the following examples:

TABLE 40

| | Example | Example | Example | Example | Example | Example |
|---|---|---|---|---|---|---|
| | 146 | 147 | 148 | 149 | 150 | 151 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-3 | — | — | 0.08 | 0.16 | — | — |
| Menthone Glycerol Ketal | — | — | — | — | 0.05 | 0.04 |
| DMIB | 0.30 | 0.05 | 0.05 | 0.20 | 0.13 | 0.04 |
| Menthyl Lactate | 0.30 | 0.10 | 0.20 | 0.10 | — | 0.10 |
| Menthyl Succinate | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 41

| | Example | Example | Example | Example | Example | Example |
|---|---|---|---|---|---|---|
| | 152 | 153 | 154 | 155 | 156 | 157 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-5 | — | — | 0.08 | 0.16 | — | — |
| Menthone Glycerol Ketal | — | — | — | — | 0.05 | 0.04 |
| DHDB | 0.30 | 0.05 | 0.05 | 0.20 | 0.13 | 0.04 |
| Menthyl Lactate | 0.30 | 0.10 | 0.20 | 0.10 | — | 0.10 |
| Menthyl Succinate | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 42

| | Example | Example | Example | Example | Example | Example |
|---|---|---|---|---|---|---|
| | 158 | 159 | 160 | 161 | 162 | 163 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-3 | — | — | 0.08 | 0.16 | — | — |
| Menthone Glycerol Ketal | — | — | — | — | 0.05 | 0.04 |
| HDIB | 0.30 | 0.05 | 0.05 | 0.20 | 0.13 | 0.04 |
| Menthyl Lactate | 0.30 | 0.10 | 0.20 | 0.10 | — | 0.10 |
| Menthyl Succinate | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 43

| | Example | Example | Example | Example | Example | Example |
|---|---|---|---|---|---|---|
| | 164 | 165 | 166 | 167 | 168 | 169 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-5 | — | — | 0.08 | 0.16 | — | — |
| Menthone Glycerol Ketal | — | — | — | — | 0.05 | 0.04 |
| EDIB | 0.30 | 0.05 | 0.05 | 0.20 | 0.13 | 0.04 |
| Menthyl Lactate | 0.30 | 0.10 | 0.20 | 0.10 | — | 0.10 |
| Menthyl Succinate | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

Menthyl glutarate may produce synergistic cooling effects when combined with menthone ketals, such as menthone glycerol ketal, in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 44

| | Example 170 | Example 171 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthyl Glutarate | 0.08% | 0.06% |
| Menthone Glycerol Ketal | 0.11% | 0.08% |
| TOTAL | 100.00 | 100.00 |

Additional cooling agents from the other Groups A, B, C and E may also be added as in some of the following examples:

TABLE 45

| | Example | Example | Example | Example | Example | Example |
|---|---|---|---|---|---|---|
| | 172 | 173 | 174 | 175 | 176 | 177 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-5 | — | — | — | 0.05 | 0.08 | — |
| Menthone Glycerol Ketal | 0.05 | 0.10 | 0.20 | 0.35 | 0.10 | 0.07 |
| WS-23 | — | 0.05 | 0.05 | — | — | — |
| Menthyl Lactate | 0.30 | — | 0.20 | — | — | 0.10 |
| Menthyl Glutarate | 0.30 | 0.10 | 0.08 | 0.26 | 0.08 | 0.11 |
| Menthol | — | 0.20 | 0.50 | — | 0.30 | — |
| | 100.00 | 100.00 | 100.00 | 100.00 | 100.00 | 100.00 |

Menthyl glutarate may produce synergistic cooling effects when combined with menthyl lactate in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 46

| | Example 178 | Example 179 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthyl Lactate | 0.08% | 0.06% |
| Menthyl Glutarate | 0.11% | 0.08% |
| TOTAL | 100.00 | 100.00 |

Additional cooling agents from the other Groups A, B and C may also be added as in some of the following examples:

TABLE 47

| | Example | Example | Example | Example | Example | Example |
|---|---|---|---|---|---|---|
| | 180 | 181 | 182 | 183 | 184 | 185 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-3 | 0.10 | — | 0.08 | — | — | 0.04 |
| Menthone Glycerol Ketal | 0.05 | — | — | 0.11 | 0.05 | 0.04 |
| WS-23 | — | 0.05 | 0.05 | — | — | — |
| Menthyl Lactate | 0.30 | 0.10 | 0.25 | 0.35 | 0.13 | 0.10 |
| Menthyl Glutarate | 0.20 | 0.10 | 0.15 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

Menthyl glutarate along with other menthol esters and menthol salts may produce synergistic cooling effects when combined with N-substituted p-menthane carboxamides, for example N-ethyl-p-menthane-3-carboxamide (WS-3), in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 48

| | Example 186 | Example 187 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| Menthyl Glutarate | 0.11% | 0.08% |
| TOTAL | 100.00 | 100.00 |

Some other menthol esters and salts from Group D can also be used in chewing gum formulations. These include:
1) Menthyl aceto acetate, MAA (FEMA 4327);
2) Menthyl-3-hydroxybutyrate, MHB (FEMA 4308);
3) Menthol ethylene glycol carbonate, MEGC, (FEMA 3805);
4) Menthol propylene glycol carbonate, MPGC, (FEMA 3806);
5) Menthyl pyrrolidone carboxylate, MPC, (FEMA 4155);
6) Menthyl lactate, ML, (FEMA 3748);
7) Menthyl glutarate, MG, (FEMA 4006);
8) Menthyl succinate, MS, (FEMA 3810)

TABLE 49

| | Example 188 | Example 189 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| Menthyl Aceto Acetate | 0.11% | 0.08% |
| TOTAL | 100.00 | 100.00 |

TABLE 50

| | Example 190 | Example 191 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| MHB | 0.11% | 0.08% |
| TOTAL | 100.00 | 100.00 |

TABLE 51

| | Example 192 | Example 193 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| MEGC | 0.11% | 0.08% |
| TOTAL | 100.00 | 100.00 |

TABLE 52

| | Example 194 | Example 195 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| MPGC | 0.11% | 0.08% |
| TOTAL | 100.00 | 100.00 |

TABLE 53

| | Example 196 | Example 197 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| MPC | 0.11% | 0.08% |
| TOTAL | 100.00 | 100.00 |

TABLE 54

| | Example 198 | Example 199 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-3 | 0.08% | 0.06% |
| Menthyl Lactate | 0.11% | 0.08% |
| TOTAL | 100.00 | 100.00 |

Additional cooling agents from the other Groups A, B, C and E may also be added as in some of the following examples:

TABLE 55

| | Example | Example | Example | Example | Example | Example |
|---|---|---|---|---|---|---|
| | 200 | 201 | 202 | 203 | 204 | 205 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-5 | 0.30 | 0.10 | 0.08 | 0.25 | 0.13 | 0.04 |
| Menthone Glycerol Ketal | — | — | — | 0.05 | 0.05 | 0.04 |
| WS-23 | — | 0.05 | 0.05 | 0.06 | — | — |
| Isopulegol | 0.30 | — | 0.20 | 0.10 | — | 0.10 |
| Menthyl Aceto Acetate | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 56

| | Example | Example | Example | Example | Example | Example |
|---|---|---|---|---|---|---|
| | 206 | 207 | 208 | 209 | 210 | 211 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-5 | 0.30 | 0.10 | 0.08 | 0.25 | 0.13 | 0.04 |
| Menthone Glycerol Ketal | — | — | — | 0.05 | 0.05 | 0.04 |
| WS-23 | — | 0.05 | 0.05 | 0.06 | — | — |
| Isopulegol | 0.30 | — | 0.20 | 0.10 | — | 0.10 |
| MHB | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 57

| | Example | Example | Example | Example | Example | Example |
|---|---|---|---|---|---|---|
| | 212 | 213 | 214 | 215 | 216 | 217 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-3 | 0.30 | 0.10 | 0.08 | 0.25 | 0.13 | 0.04 |
| Menthone Glycerol Ketal | — | — | — | 0.05 | 0.05 | 0.04 |
| WS-23 | — | 0.05 | 0.05 | 0.06 | — | — |
| Isopulegol | 0.30 | — | 0.20 | 0.10 | — | 0.10 |
| MAA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 58

| | Example | Example | Example | Example | Example | Example |
|---|---|---|---|---|---|---|
| | 218 | 219 | 220 | 221 | 222 | 223 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-5 | 0.30 | 0.10 | 0.08 | 0.25 | 0.13 | 0.04 |
| Menthone Glycerol Ketal | — | — | — | 0.05 | 0.05 | 0.04 |
| WS-23 | — | 0.05 | 0.05 | 0.06 | — | — |
| Isopulegol | 0.30 | — | 0.20 | 0.10 | — | 0.10 |
| MPGC | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 59

| | Example | Example | Example | Example | Example | Example |
|---|---|---|---|---|---|---|
| | 224 | 225 | 226 | 227 | 228 | 229 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| WS-3 | 0.30 | 0.10 | 0.08 | 0.25 | 0.13 | 0.04 |
| Menthone Glycerol Ketal | — | — | — | 0.05 | 0.05 | 0.04 |
| WS-23 | — | 0.05 | 0.05 | 0.06 | — | — |
| Isopulegol | 0.30 | — | 0.20 | 0.10 | — | 0.10 |
| MPC | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 60

| | Example | Example | Example | Example | Example | Example |
|---|---|---|---|---|---|---|
| | 230 | 231 | 232 | 233 | 234 | 235 |
| Gum Base | 48.00 | 35.00 | 30.00 | 25.00 | 22.00 | 30.00 |
| Sorbitol | 34.05 | 48.85 | 52.57 | 60.40 | 58.87 | 50.56 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.20 | — |
| Peppermint Oil | 1.30 | 0.40 | — | 0.95 | 0.70 | 1.20 |
| Spearmint Oil | 0.20 | 0.80 | 0.80 | — | — | — |
| WS-23 | 0.30 | 0.10 | 0.08 | 0.25 | 0.13 | 0.24 |
| Menthyl Glutarate | — | — | — | 0.20 | 0.16 | 0.12 |
| WS-3 | 0.05 | 0.05 | 0.05 | — | 0.08 | — |
| Isopulegol | 0.25 | — | 0.20 | 0.20 | 0.16 | 0.12 |
| Menthyl Succinate | 0.05 | 0.10 | 0.20 | 0.10 | — | 0.06 |
| Menthol | — | 0.20 | 0.50 | 0.20 | 0.40 | 0.30 |
| | 100.00 | 100.00 | 100.00 | 100.00 | 100.00 | 100.00 |

N-substituted p-menthane carboxamides, for example N-(t-butyl)-p-menthane-3-carboxamide (WS-14), may produce synergistic cooling effects when combined with acyclic carboxamides, for example N,2-diethyl-3-methyl-2-isopropyl-butanamide (DMIB), in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 61

| | Example 236 | Example 237 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| PEMC | 0.08% | 0.06% |
| DMIB | 0.11% | 0.08% |
| TOTAL | 100.00 | 100.00 |

Additional cooling agents may also be added as in some of the following examples:

TABLE 62

| | Example | Example | Example | Example | Example | Example |
|---|---|---|---|---|---|---|
| | 238 | 239 | 240 | 241 | 242 | 243 |
| Gum Base | 48.00 | 35.00 | 30.00 | 25.00 | 22.00 | 30.00 |
| Sorbitol | 34.05 | 48.85 | 52.57 | 60.69 | 59.24 | 51.08 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| PEMC | 0.30 | 0.10 | 0.08 | 0.21 | 0.13 | 0.04 |
| Menthone Glycerol Ketal | — | — | — | 0.10 | 0.05 | 0.04 |
| DMIB | 0.05 | 0.15 | 0.25 | 0.10 | 0.04 | 0.10 |
| Menthyl Lactate | 0.30 | — | 0.20 | 0.05 | — | 0.07 |
| Menthyl Succinate | — | — | — | 0.20 | 0.04 | 0.07 |
| Menthol | — | 0.20 | 0.50 | — | 0.30 | — |
| | 100.00 | 100.00 | 100.00 | 100.00 | 100.00 | 100.00 |

Menthyl salicylate (wintergreen) may produce synergistic cooling effects when combined with acyclic carboxamides, for example N-2,3-trimethyl-2-isopropyl butanamide (WS-23), and other acyclic carboxamides or butanamides in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 63

| | Example 244 | Example 245 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-23 | 0.08% | 0.06% |
| Methyl salicylate | 0.11% | 0.08% |
| TOTAL | 100.00 | 100.00 |

TABLE 64

| | Example 246 | Example 247 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| DMIB | 0.08% | 0.06% |
| Methyl salicylate | 0.11% | 0.08% |
| TOTAL | 100.00 | 100.00 |

TABLE 65

| | Example 248 | Example 249 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| DHDB | 0.08% | 0.06% |
| Methyl salicylate | 0.11% | 0.08% |
| TOTAL | 100.00 | 100.00 |

TABLE 66

| | Example 250 | Example 251 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| HDIB | 0.08% | 0.06% |
| Methyl salicylate | 0.11% | 0.08% |
| TOTAL | 100.00 | 100.00 |

TABLE 67

| | Example 252 | Example 253 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| EDIB | 0.08% | 0.06% |
| Methyl salicylate | 0.11% | 0.08% |
| TOTAL | 100.00 | 100.00 |

Additional cooling agents from other Groups A, C, and D may also be added as in some of the following examples:

TABLE 68

| | Example | Example | Example | Example | Example | Example |
|---|---|---|---|---|---|---|
| | 254 | 255 | 256 | 257 | 258 | 259 |
| Gum Base | 48.00 | 35.00 | 30.00 | 25.00 | 22.00 | 30.00 |
| Sorbitol | 34.05 | 48.30 | 51.77 | 60.49 | 58.95 | 50.36 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.70 | 0.80 | 1.20 | 0.20 | — | — |
| Peppermint Oil | 1.00 | 0.40 | — | 0.70 | 0.90 | 1.20 |
| Spearmint Oil | 0.10 | — | 0.40 | — | — | 0.20 |
| WS-3 | 0.20 | 0.50 | 0.08 | — | 0.06 | — |
| Isopulegol | 0.05 | 0.10 | 0.20 | 0.20 | 0.12 | 0.16 |
| WS-5 | 0.30 | 0.10 | 0.05 | 0.11 | 0.15 | 0.24 |
| Menthyl Succinate | 0.30 | — | 0.20 | 0.10 | — | 0.08 |
| Menthyl Glutarate | — | 0.10 | — | 0.20 | 0.12 | 0.16 |
| Menthol | — | 0.20 | 0.50 | 0.30 | 0.40 | 0.20 |
| | 100.00 | 100.00 | 100.00 | 100.00 | 100.00 | 100.00 |

TABLE 69

| | Example | Example | Example | Example | Example | Example |
|---|---|---|---|---|---|---|
| | 260 | 261 | 262 | 263 | 264 | 265 |
| Gum Base | 48.00 | 35.00 | 30.00 | 25.00 | 22.00 | 30.00 |
| Sorbitol | 34.05 | 48.30 | 51.77 | 60.74 | 59.24 | 51.02 |
| Hydrogenated Starch | — | — | — | 7.50 | 14.00 | 10.00 |
| Hydrolysate Syrup | | | | | | |
| 70% Sorbitol Solution | 10.00 | 8.00 | — | — | — | — |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.70 | 0.80 | 1.20 | 0.70 | 0.90 | 1.00 |
| Peppermint Oil | 1.00 | 0.40 | — | 0.20 | — | — |
| Spearmint Oil | 0.10 | — | 0.40 | — | — | 0.30 |
| WS-3 | 0.20 | 0.50 | 0.08 | — | — | 0.04 |
| Menthone Glycerol Ketal | 0.05 | 0.10 | 0.20 | 0.35 | 0.05 | 0.04 |
| DMIB | 0.30 | 0.10 | 0.05 | 0.11 | 0.13 | 0.08 |
| Menthyl Lactate | 0.30 | — | 0.20 | — | — | 0.06 |
| Menthyl Glutarate | — | — | — | 0.20 | 0.08 | 0.06 |
| Menthol | — | 0.20 | 0.50 | — | 0.30 | — |
| | 100.00 | 100.00 | 100.00 | 100.00 | 100.00 | 100.00 |

TABLE 70

| | Example 266 | Example 267 | Example 268 | Example 269 | Example 270 | Example 271 |
|---|---|---|---|---|---|---|
| Gum Base | 48.00 | 35.00 | 30.00 | 25.00 | 22.00 | 30.00 |
| Sorbitol | 34.05 | 48.40 | 51.77 | 60.74 | 59.24 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.70 | 0.80 | 1.20 | 0.70 | 0.90 | 1.00 |
| Peppermint Oil | 1.00 | 0.40 | — | 0.20 | — | — |
| Spearmint Oil | 0.10 | — | 0.40 | — | — | 0.30 |
| WS-3 | 0.20 | 0.50 | 0.08 | — | — | 0.04 |
| Menthone Glycerol Ketal | 0.05 | 0.10 | 0.20 | 0.35 | 0.05 | 0.04 |
| DHDB | 0.30 | 0.10 | 0.05 | 0.11 | 0.13 | 0.08 |
| Menthyl Lactate | 0.30 | — | 0.20 | — | — | 0.06 |
| Menthyl Glutarate | — | — | — | 0.20 | 0.08 | 0.06 |
| Menthol | — | 0.20 | 0.50 | — | 0.30 | — |
| | 100.00 | 100.00 | 100.00 | 100.00 | 100.00 | 100.00 |

TABLE 71

| | Example 272 | Example 273 | Example 274 | Example 275 | Example 276 | Example 277 |
|---|---|---|---|---|---|---|
| Gum Base | 48.00 | 35.00 | 30.00 | 25.00 | 22.00 | 30.00 |
| Sorbitol | 34.05 | 48.40 | 51.77 | 60.74 | 59.24 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.70 | 0.80 | 1.20 | 0.70 | 0.90 | 1.00 |
| Peppermint Oil | 1.00 | 0.40 | — | 0.20 | — | — |
| Spearmint Oil | 0.10 | — | 0.40 | — | — | 0.30 |
| WS-3 | 0.20 | 0.50 | 0.08 | — | — | 0.04 |
| Menthone Glycerol Ketal | 0.05 | 0.10 | 0.20 | 0.35 | 0.05 | 0.04 |
| HDIB | 0.30 | 0.10 | 0.05 | 0.11 | 0.13 | 0.08 |
| Menthyl Lactate | 0.30 | — | 0.20 | — | — | 0.06 |
| Menthyl Glutarate | — | — | — | 0.20 | 0.08 | 0.06 |
| Menthol | — | 0.20 | 0.50 | — | 0.30 | — |
| | 100.00 | 100.00 | 100.00 | 100.00 | 100.00 | 100.00 |

TABLE 72

| | Example 278 | Example 279 | Example 280 | Example 281 | Example 282 | Example 283 |
|---|---|---|---|---|---|---|
| Gum Base | 48.00 | 35.00 | 30.00 | 25.00 | 22.00 | 30.00 |
| Sorbitol | 34.05 | 48.40 | 51.77 | 60.74 | 59.24 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.70 | 0.80 | 1.20 | 0.70 | 0.90 | 1.00 |
| Peppermint Oil | 1.00 | 0.40 | — | 0.20 | — | — |
| Spearmint Oil | 0.10 | — | 0.40 | — | — | 0.30 |
| WS-5 | 0.20 | 0.50 | 0.08 | — | — | 0.04 |
| Menthone Glycerol Ketal | 0.05 | 0.10 | 0.20 | 0.35 | 0.05 | 0.04 |
| EDIB | 0.30 | 0.10 | 0.05 | 0.11 | 0.13 | 0.08 |
| Menthyl Lactate | 0.30 | — | 0.20 | — | — | 0.06 |
| Menthyl Glutarate | — | — | — | 0.20 | 0.08 | 0.06 |
| Menthol | — | 0.20 | 0.50 | — | 0.30 | — |
| | 100.00 | 100.00 | 100.00 | 100.00 | 100.00 | 100.00 |

Menthyl salicylate (wintergreen) may produce synergistic cooling effects when combined with any of the p-menthane carboxamides from Group A, for example N-(t-butyl)-p-menthane-3-carboxamide (WS-14), in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 73

| | Example 284 | Example 285 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| PEMC | 0.08% | 0.06% |
| Methyl Salicylate | 0.11% | 0.08% |
| TOTAL | 100.00 | 100.00 |

Additional cooling agents from Groups B, C, and D may also be added as in some of the following examples:

TABLE 74

| | Example 286 | Example 287 | Example 288 | Example 289 | Example 290 | Example 291 |
|---|---|---|---|---|---|---|
| Gum Base | 48.00 | 35.00 | 30.00 | 25.00 | 22.00 | 30.00 |
| Sorbitol | 34.05 | 48.85 | 51.77 | 59.75 | 58.94 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.85 | 0.80 | 1.20 | 0.70 | 0.90 | 1.00 |
| Peppermint Oil | 1.00 | 0.40 | — | 1.20 | 0.20 | — |
| Spearmint Oil | 0.15 | — | 0.40 | — | — | 0.30 |
| PEMC | 0.25 | 0.20 | 0.08 | 0.20 | 0.13 | 0.04 |
| Menthone Glycerol Ketal | — | — | 0.10 | 0.25 | 0.05 | 0.04 |
| WS-23 | 0.10 | 0.05 | 0.05 | — | 0.10 | — |
| Menthyl Lactate | 0.30 | — | 0.20 | — | — | 0.10 |
| Menthyl Glutarate | — | — | 0.10 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 75

| | Example 292 | Example 293 | Example 294 | Example 295 | Example 296 | Example 297 |
|---|---|---|---|---|---|---|
| Gum Base | 48.00 | 35.00 | 30.00 | 25.00 | 22.00 | 30.00 |
| Sorbitol | 34.05 | 48.85 | 51.77 | 59.75 | 58.94 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.85 | 0.80 | 1.20 | 0.70 | 0.90 | 1.00 |
| Peppermint Oil | 1.00 | 0.40 | — | 1.20 | 0.20 | — |
| Spearmint Oil | 0.15 | — | 0.40 | — | — | 0.30 |
| WS-5 | 0.25 | 0.20 | 0.08 | 0.20 | 0.13 | 0.04 |
| Menthone Glycerol Ketal | — | — | 0.10 | 0.25 | 0.05 | 0.04 |
| WS-23 | 0.10 | 0.05 | 0.05 | — | 0.10 | — |
| Menthyl Lactate | 0.30 | — | 0.20 | — | — | 0.10 |
| Menthyl Glutarate | — | — | 0.10 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 76

| | Example 298 | Example 299 | Example 300 | Example 301 | Example 302 | Example 303 |
|---|---|---|---|---|---|---|
| Gum Base | 48.00 | 35.00 | 30.00 | 25.00 | 22.00 | 30.00 |
| Sorbitol | 34.05 | 48.85 | 51.77 | 59.75 | 58.94 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.85 | 0.80 | 1.20 | 0.70 | 0.90 | 1.00 |
| Peppermint Oil | 1.00 | 0.40 | — | 1.20 | 0.20 | — |
| Spearmint Oil | 0.15 | — | 0.40 | — | — | 0.30 |
| BAMC | 0.25 | 0.20 | 0.08 | 0.20 | 0.13 | 0.04 |
| Menthone Glycerol Ketal | — | — | 0.10 | 0.25 | 0.05 | 0.04 |
| WS-23 | 0.10 | 0.05 | 0.05 | — | 0.10 | — |
| Menthyl Lactate | 0.30 | — | 0.20 | — | — | 0.10 |
| Menthyl Glutarate | — | — | 0.10 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 77

| | Example 304 | Example 305 | Example 306 | Example 307 | Example 308 | Example 309 |
|---|---|---|---|---|---|---|
| Gum Base | 48.00 | 35.00 | 30.00 | 25.00 | 22.00 | 30.00 |
| Sorbitol | 34.05 | 48.85 | 51.77 | 59.75 | 58.94 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.85 | 0.80 | 1.20 | 0.70 | 0.90 | 1.00 |
| Peppermint Oil | 1.00 | 0.40 | — | 1.20 | 0.20 | — |
| Spearmint Oil | 0.15 | — | 0.40 | — | — | 0.30 |
| WS-4 | 0.25 | 0.20 | 0.08 | 0.20 | 0.13 | 0.04 |
| Menthone Glycerol Ketal | — | — | 0.10 | 0.25 | 0.05 | 0.04 |
| WS-23 | 0.10 | 0.05 | 0.05 | — | 0.10 | — |
| Menthyl Lactate | 0.30 | — | 0.20 | — | — | 0.10 |
| Menthyl Glutarate | — | — | 0.10 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 78

| | Example 310 | Example 311 | Example 312 | Example 313 | Example 314 | Example 315 |
|---|---|---|---|---|---|---|
| Gum Base | 48.00 | 35.00 | 30.00 | 25.00 | 22.00 | 30.00 |
| Sorbitol | 34.05 | 48.85 | 51.77 | 59.75 | 58.94 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.85 | 0.80 | 1.20 | 0.70 | 0.90 | 1.00 |
| Peppermint Oil | 1.00 | 0.40 | — | 1.20 | 0.20 | — |
| Spearmint Oil | 0.15 | — | 0.40 | — | — | 0.30 |
| WS-14 | 0.25 | 0.20 | 0.08 | 0.20 | 0.13 | 0.04 |
| Menthone Glycerol Ketal | — | — | 0.10 | 0.25 | 0.05 | 0.04 |
| WS-23 | 0.10 | 0.05 | 0.05 | — | 0.10 | — |
| Menthyl Lactate | 0.30 | — | 0.20 | — | — | 0.10 |
| Menthyl Glutarate | — | — | 0.10 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 79

| | Example 316 | Example 317 | Example 318 | Example 319 | Example 320 | Example 321 |
|---|---|---|---|---|---|---|
| Gum Base | 48.00 | 35.00 | 30.00 | 25.00 | 22.00 | 30.00 |
| Sorbitol | 34.05 | 48.85 | 51.77 | 59.75 | 58.94 | 51.02 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.85 | 0.80 | 1.20 | 0.70 | 0.90 | 1.00 |
| Peppermint Oil | 1.00 | 0.40 | — | 1.20 | 0.20 | — |
| Spearmint Oil | 0.15 | — | 0.40 | — | — | 0.30 |
| WS-12 | 0.25 | 0.20 | 0.08 | 0.20 | 0.13 | 0.04 |
| Menthone Glycerol Ketal | — | — | 0.10 | 0.25 | 0.05 | 0.04 |
| WS-23 | 0.10 | 0.05 | 0.05 | — | 0.10 | — |
| Menthyl Lactate | 0.30 | — | 0.20 | — | — | 0.10 |
| Menthyl Glutarate | — | — | 0.10 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

The cooling agent 3-l-menthoxypropane-1,2-diol (TCA) from Takasago may produce synergistic cooling effects when combined with N,2,3-trimethyl-2-isopropyl butanamide (WS-23), in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 80

| | Example 322 | Example 323 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| TCA | 0.08% | 0.06% |
| WS-23 | 0.11% | 0.08% |
| TOTAL | 100.00 | 100.00 |

Some other menthol and menthone derivatives from Group C can also be used in chewing gum formulations. These include:
1) Menthoxy ethanol, also called MENETH (FEMA 4154);
2) Menthone lactic acid ketal, also called MLAK (FEMA 4285);
3) p-Mentha-3,8-diol, also called Menthanediol, (FEMA 4053);
4) Isopulegol or p-menth-8-ene-3-ol, (FEMA 2962);
5) 3-l-Menthoxypropane-1,2-diol, TCA, (FEMA 3784);
6) Menthyl methyl ether, MME (FEMA 4054)

TABLE 81

| | Example 324 | Example 325 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| MENETH | 0.08% | 0.06% |
| WS-23 | 0.11% | 0.08% |
| TOTAL | 100.00 | 100.00 |

TABLE 82

| | Example 326 | Example 327 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| MLAK | 0.08% | 0.06% |
| WS-23 | 0.11% | 0.08% |
| TOTAL | 100.00 | 100.00 |

TABLE 83

| | Example 328 | Example 329 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthanediol | 0.08% | 0.06% |
| WS-23 | 0.11% | 0.08% |
| TOTAL | 100.00 | 100.00 |

TABLE 84

| | Example 330 | Example 331 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Isopulegol | 0.08% | 0.06% |
| WS-23 | 0.11% | 0.08% |
| TOTAL | 100.00 | 100.00 |

TABLE 85

| | Example 332 | Example 333 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| MME | 0.08% | 0.06% |
| WS-23 | 0.11% | 0.08% |
| TOTAL | 100.00 | 100.00 |

TABLE 86

| | Example 334 | Example 335 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Cubebol | 0.08% | 0.06% |
| WS-23 | 0.11% | 0.08% |
| TOTAL | 100.00 | 100.00 |

TABLE 87

| | Example 336 | Example 337 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| MME | 0.08% | 0.06% |
| WS-23 | 0.11% | 0.08% |
| TOTAL | 100.00 | 100.00 |

Additional cooling agents from Groups A, B, and D may also be added as in some of the following examples:

TABLE 88

| | Example 338 | Example 339 | Example 340 | Example 341 | Example 342 | Example 343 |
|---|---|---|---|---|---|---|
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| TCA | 0.30 | 0.10 | 0.08 | 0.11 | 0.13 | 0.04 |
| WS-23 | 0.05 | 0.10 | 0.20 | 0.35 | 0.05 | 0.04 |
| WS-3 | — | 0.05 | 0.05 | — | — | — |
| Menthyl Lactate | 0.30 | — | 0.20 | — | — | 0.10 |
| Menthyl Succinate | — | — | — | 0.20 | 0.08 | 0.10 |
| Menthol | — | 0.15 | — | — | — | 0.25 |
| | 100.00 | 100.00 | 100.00 | 100.00 | 100.00 | 100.00 |

TABLE 89

| | Example 344 | Example 345 | Example 346 | Example 347 | Example 348 | Example 349 |
|---|---|---|---|---|---|---|
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |

TABLE 90

| | Example 350 | Example 351 | Example 352 | Example 353 | Example 354 | Example 355 |
|---|---|---|---|---|---|---|
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| MLAK | 0.30 | 0.10 | 0.08 | 0.11 | 0.13 | 0.04 |
| WS-23 | 0.05 | 0.10 | 0.20 | 0.35 | 0.05 | 0.04 |
| WS-3 | — | 0.05 | 0.05 | — | — | — |
| Menthyl Lactate | 0.30 | — | 0.20 | — | — | 0.10 |
| Menthyl Succinate | — | — | — | 0.20 | 0.08 | 0.10 |

TABLE 91

| | Example 356 | Example 357 | Example 358 | Example 359 | Example 360 | Example 361 |
|---|---|---|---|---|---|---|
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| Menthanediol | 0.30 | 0.10 | 0.08 | 0.11 | 0.13 | 0.04 |
| WS-23 | 0.05 | 0.10 | 0.20 | 0.35 | 0.05 | 0.04 |
| WS-5 | — | 0.05 | 0.05 | — | — | — |
| Menthyl Lactate | 0.30 | — | 0.20 | — | — | 0.10 |
| Menthyl Succinate | — | — | — | 0.20 | 0.08 | 0.10 |

TABLE 92

| | Example 362 | Example 363 | Example 364 | Example 365 | Example 366 | Example 367 |
|---|---|---|---|---|---|---|
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| Isopulegol | 0.30 | 0.10 | 0.08 | 0.11 | 0.13 | 0.04 |
| WS-23 | 0.05 | 0.10 | 0.20 | 0.35 | 0.05 | 0.04 |
| WS-5 | — | 0.05 | 0.05 | — | — | — |
| Menthyl Lactate | 0.30 | — | 0.20 | — | — | 0.10 |
| Menthyl Succinate | — | — | — | 0.20 | 0.08 | 0.10 |

TABLE 93

| | Example 368 | Example 369 | Example 370 | Example 371 | Example 372 | Example 373 |
|---|---|---|---|---|---|---|
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated Starch | — | — | — | 7.50 | 14.00 | 10.00 |
| Hydrolysate Syrup | 10.00 | 8.00 | — | — | — | — |
| 70% Sorbitol Solution | | | | | | |
| Glycerin | 5.00 | 6.00 | 15.00 | 5.00 | 3.00 | 7.00 |
| Encapsulated Aspartame | 0.30 | 0.50 | 0.60 | 0.20 | 0.30 | 0.40 |
| Methyl Salicylate | 0.50 | — | — | — | 0.70 | — |
| Peppermint Oil | 1.30 | 0.40 | — | 0.95 | 0.20 | 1.20 |
| Spearmint Oil | 0.20 | 0.80 | 0.80 | — | — | — |
| MME | 0.30 | 0.10 | 0.08 | 0.11 | 0.13 | 0.04 |
| WS-23 | 0.05 | 0.10 | 0.20 | 0.35 | 0.05 | 0.04 |
| WS-3 | — | 0.05 | 0.05 | — | — | — |
| Menthyl Lactate | 0.30 | — | 0.20 | — | — | 0.10 |
| Menthyl Succinate | — | — | — | 0.20 | 0.08 | 0.10 |

TABLE 94

| | Example | Example | Example | Example | Example | Example |
|---|---|---|---|---|---|---|
| | 374 | 375 | 376 | 377 | 378 | 379 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| Cubebol | 0.30 | 0.10 | 0.08 | 0.11 | 0.13 | 0.04 |
| WS-23 | 0.05 | 0.10 | 0.20 | 0.35 | 0.05 | 0.04 |
| WS-5 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |

TABLE 95

| | Example | Example | Example | Example | Example | Example |
|---|---|---|---|---|---|---|
| | 380 | 381 | 382 | 383 | 384 | 385 |
| Gum Base | 48.00 | 35.00 | 30.00 | 25.00 | 22.00 | 30.00 |
| Sorbitol | 34.05 | 48.90 | 53.07 | 60.69 | 59.54 | 50.87 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| MME | 0.30 | 0.10 | 0.08 | 0.11 | 0.13 | 0.04 |
| WS-23 | 0.05 | 0.10 | 0.20 | 0.35 | 0.05 | 0.04 |
| WS-3 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |

The Isopulegol coolant may produce synergistic cooling effects when combined with menthol in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 96

| | Example 386 | Example 387 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| Isopulegol | 0.04% | 0.06% |
| Menthol | 0.50% | 0.25% |
| TOTAL | 100.00 | 100.00 |

TABLE 97

| | Example 388 | Example 389 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| MENETH | 0.04% | 0.06% |
| Menthol | 0.50% | 0.25% |
| TOTAL | 100.00 | 100.00 |

TABLE 98

| | Example 390 | Example 391 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| MLAK | 0.04% | 0.06% |
| Menthol | 0.50% | 0.25% |
| TOTAL | 100.00 | 100.00 |

TABLE 99

| | Example 392 | Example 393 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| Menthanediol | 0.04% | 0.06% |
| Menthol | 0.50% | 0.25% |
| TOTAL | 100.00 | 100.00 |

TABLE 100

| | Example 394 | Example 395 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| MME | 0.04% | 0.06% |
| Menthol | 0.50% | 0.25% |
| TOTAL | 100.00 | 100.00 |

TABLE 101

| | Example 396 | Example 397 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| Cubebol | 0.04% | 0.06% |
| Menthol | 0.50% | 0.25% |
| TOTAL | 100.00 | 100.00 |

TABLE 102

| | Example 398 | Example 399 |
|---|---|---|
| Gum Base | 25.00% | 30.00% |
| Sugar | 56.76% | 58.29% |
| Corn Syrup | 15.00% | 9.00% |
| Glycerin | 2.00% | 1.50% |
| Spearmint Oil | 0.70% | — |
| Peppermint Oil | — | 0.90% |
| MME | 0.04% | 0.06% |
| Menthol | 0.50% | 0.25% |
| TOTAL | 100.00 | 100.00 |

Additional cooling agents from Groups A, B, and D may also be added as in some of the following examples:

TABLE 103

| | Example | Example | Example | Example | Example | Example |
|---|---|---|---|---|---|---|
| | 400 | 401 | 402 | 403 | 404 | 405 |
| Gum Base | 48.00 | 35.00 | 30.00 | 25.00 | 22.00 | 30.00 |
| Sorbitol | 33.85 | 48.60 | 53.12 | 60.60 | 58.95 | 50.55 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.10 | — |
| Salicylate | | | | | | |
| Peppermint | 1.30 | 0.40 | — | 0.95 | 0.80 | 1.20 |
| Oil | | | | | | |
| Spearmint | 0.20 | 0.80 | 0.80 | — | — | — |
| Oil | | | | | | |
| Isopulegol | 0.30 | 0.10 | 0.08 | 0.12 | 0.24 | 0.14 |
| Menthol | 0.25 | 0.40 | 0.15 | 0.35 | 0.17 | 0.45 |
| WS-3 | — | 0.05 | 0.05 | 0.10 | 0.20 | 0.05 |
| Menthyl | 0.30 | — | 0.20 | 0.12 | 0.24 | 0.14 |
| Glutarate | | | | | | |
| Menthyl | — | 0.15 | — | 0.06 | — | 0.07 |
| Succinate | | | | | | |
| | 100.00 | 100.00 | 100.00 | 100.00 | 100.00 | 100.00 |

TABLE 104

| | Example | Example | Example | Example | Example | Example |
|---|---|---|---|---|---|---|
| | 406 | 407 | 408 | 409 | 410 | 411 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| MENETH | 0.30 | 0.10 | 0.08 | 0.11 | 0.13 | 0.04 |
| Menthol | 0.25 | 0.40 | 0.15 | 0.35 | 0.05 | 0.45 |
| WS-5 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 105

| | Example | Example | Example | Example | Example | Example |
|---|---|---|---|---|---|---|
| | 412 | 413 | 414 | 415 | 416 | 417 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| MLAK | 0.30 | 0.10 | 0.08 | 0.11 | 0.13 | 0.04 |
| Menthol | 0.25 | 0.40 | 0.15 | 0.35 | 0.05 | 0.45 |
| WS-5 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 106

| | Example | Example | Example | Example | Example | Example |
|---|---|---|---|---|---|---|
| | 418 | 419 | 420 | 421 | 422 | 423 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| Menthanediol | 0.30 | 0.10 | 0.08 | 0.11 | 0.13 | 0.04 |
| Menthol | 0.25 | 0.40 | 0.15 | 0.35 | 0.05 | 0.45 |
| WS-3 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 107

| | Example | Example | Example | Example | Example | Example |
|---|---|---|---|---|---|---|
| | 424 | 425 | 426 | 427 | 428 | 429 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| MME | 0.30 | 0.10 | 0.08 | 0.11 | 0.13 | 0.04 |
| Menthol | 0.25 | 0.40 | 0.15 | 0.35 | 0.05 | 0.45 |
| WS-5 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 108

| | Example | Example | Example | Example | Example | Example |
|---|---|---|---|---|---|---|
| | 430 | 431 | 432 | 433 | 434 | 435 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| Cubebol | 0.30 | 0.10 | 0.08 | 0.11 | 0.13 | 0.04 |
| Menthol | 0.25 | 0.40 | 0.15 | 0.35 | 0.05 | 0.45 |
| WS-3 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

TABLE 109

| | Example | Example | Example | Example | Example | Example |
|---|---|---|---|---|---|---|
| | 436 | 437 | 438 | 439 | 440 | 441 |
| Gum Base | 48.00 | 35.00 | 30.00 | 25.00 | 22.00 | 30.00 |
| Sorbitol | 33.85 | 48.60 | 53.12 | 60.69 | 59.54 | 50.46 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| MME | 0.30 | 0.10 | 0.08 | 0.11 | 0.13 | 0.04 |
| Menthol | 0.25 | 0.40 | 0.15 | 0.35 | 0.05 | 0.45 |
| WS-5 | — | 0.05 | 0.05 | — | — | — |
| Menthyl | 0.30 | — | 0.20 | — | — | 0.10 |
| Lactate | | | | | | |
| Menthyl | — | — | — | 0.20 | 0.08 | 0.10 |
| Succinate | | | | | | |
| Menthone | — | 0.15 | — | — | — | 0.25 |
| Glycerol Ketal | | | | | | |
| | 100.00 | 100.00 | 100.00 | 100.00 | 100.00 | 100.00 |

The cooling agent 3-l-menthoxypropane-1,2-diol (TCA) may produce synergistic cooling effects when combined with menthol esters of Group D, for example menthol glutarate in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 110

| | Example 442 | Example 443 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| TCA | 0.11% | 0.08% |
| TOTAL | 100.00 | 100.00 |

Other cooling agents from Group C can also be used to combine with menthol glutarate in some of the following examples:

TABLE 111

| | Example 444 | Example 445 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| Isopulegol | 0.11% | 0.08% |
| TOTAL | 100.00 | 100.00 |

TABLE 112

| | Example 446 | Example 447 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| MENETH | 0.11% | 0.08% |
| TOTAL | 100.00 | 100.00 |

TABLE 113

| | Example 448 | Example 449 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| MLAK | 0.11% | 0.08% |
| TOTAL | 100.00 | 100.00 |

TABLE 114

| | Example 450 | Example 451 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| Menthanediol | 0.11% | 0.08% |
| TOTAL | 100.00 | 100.00 |

TABLE 115

| | Example 452 | Example 453 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| MME | 0.11% | 0.08% |
| TOTAL | 100.00 | 100.00 |

TABLE 116

| | Example 454 | Example 455 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| Cubebol | 0.11% | 0.08% |
| TOTAL | 100.00 | 100.00 |

TABLE 117

| | Example 456 | Example 457 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| Menthol Glutarate | 0.08% | 0.06% |
| MME | 0.11% | 0.08% |
| TOTAL | 100.00 | 100.00 |

Additional cooling agents from Groups A, B, and D may also be added as in some of the following examples:

TABLE 118

| | Example | Example | Example | Example | Example | Example |
|---|---|---|---|---|---|---|
| | 458 | 459 | 460 | 461 | 462 | 463 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-5 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 119

| | Example | Example | Example | Example | Example | Example |
|---|---|---|---|---|---|---|
| | 464 | 465 | 466 | 467 | 468 | 469 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-3 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| Isopulegol | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 120

| | Example | Example | Example | Example | Example | Example |
|---|---|---|---|---|---|---|
| | 470 | 471 | 472 | 473 | 474 | 475 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-5 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| MENETH | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 121

| | Example | Example | Example | Example | Example | Example |
|---|---|---|---|---|---|---|
| | 476 | 477 | 478 | 479 | 480 | 481 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-5 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| MLAK | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 122

| | Example | Example | Example | Example | Example | Example |
|---|---|---|---|---|---|---|
| | 482 | 483 | 484 | 485 | 486 | 487 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-5 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| Menthanediol | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 123

| | Example | Example | Example | Example | Example | Example |
|---|---|---|---|---|---|---|
| | 488 | 489 | 490 | 491 | 492 | 493 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-3 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| MME | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 124

| | Exam- | Exam- | Exam- | Exam- | Exam- | Exam- |
|---|---|---|---|---|---|---|
| | ple | ple | ple | ple | ple | ple |
| | 494 | 495 | 496 | 497 | 498 | 499 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint | 1.30 | 0.40 | — | 0.95 | 0.20 | 1.20 |
| Oil | | | | | | |
| Spearmint | 0.20 | 0.80 | 0.80 | — | — | — |
| Oil | | | | | | |
| WS-5 | — | — | 0.08 | 0.16 | — | — |
| Menthone | — | — | — | — | 0.05 | 0.04 |
| Glycerol | | | | | | |
| Ketal | | | | | | |
| Menthol | 0.30 | 0.05 | 0.05 | 0.20 | 0.13 | 0.04 |
| Glutarate | | | | | | |
| Menthyl | 0.30 | 0.10 | 0.20 | 0.10 | — | 0.10 |
| Lactate | | | | | | |
| Cubebol | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 125

| | Exam- | Exam- | Exam- | Exam- | Exam- | Exam- |
|---|---|---|---|---|---|---|
| | ple | ple | ple | ple | ple | ple |
| | 500 | 501 | 502 | 503 | 504 | 505 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-5 | — | — | 0.08 | 0.16 | — | — |
| Menthone | — | — | — | — | 0.05 | 0.04 |
| Glycerol Ketal | | | | | | |
| Menthol | 0.30 | 0.05 | 0.05 | 0.20 | 0.13 | 0.04 |
| Glutarate | | | | | | |
| Menthyl Lactate | 0.30 | 0.10 | 0.20 | 0.10 | — | 0.10 |
| MME | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

The cooling agent 3-l-menthoxypropane-1,2-diol may produce synergistic cooling effects when combined with N-substituted p-menthane carboxamides of Group A, for example Glycerol ester of p-menthane-3-carboxylic acid (WS-30) in chewing gum. It is also possible to take advantage of differing release rates of the two cooling agents to provide a fast cooling release and a long lasting cooling in the same product. Also, reductions in bitterness may be achieved through optimization of the levels of these cooling agents. For example, chewing gums may be prepared from the following formulas:

TABLE 126

| | Example 506 | Example 507 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-30 | 0.08% | 0.06% |
| TCA | 0.11% | 0.08% |
| TOTAL | 100.00 | 100.00 |

Other N-substituted p-menthane carboxamides, carboxylic acids or carboxamide from Group A can also be used to produce synergistic effects in chewing gum. Some of these are:
1) N-[[5-methyl-2-(1-methylethyl)-cyclohexyl]carbonyl]glycine, WS-5;
2) N-(4-methoxyphenyl)-p-menthane-3-carboxamide, WS-12;
3) N-(t-butyl)-p-menthane-3-carboxamide, WS-14;
4) Ethylene glycol ester of p-menthane-3-carboxylic acid, WS-4
5) N-(p-benzene acetonitrile)-p-menthane-carboxamide, BAMC (FEMA 4496);
6) N-(2-(Pyridin-2-yl)ethyl)-3-p-menthane-carboxamide, PEMC (FEMA 4549);

TABLE 127

| | Example 508 | Example 509 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-5 | 0.08% | 0.06% |
| TCA | 0.11% | 0.08% |
| TOTAL | 100.00 | 100.00 |

TABLE 128

| | Example 510 | Example 511 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| BAMC | 0.08% | 0.06% |
| TCA | 0.11% | 0.08% |
| TOTAL | 100.00 | 100.00 |

TABLE 129

| | Example 512 | Example 513 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| PEMC | 0.08% | 0.06% |
| TCA | 0.11% | 0.08% |
| TOTAL | 100.00 | 100.00 |

TABLE 130

| | Example 514 | Example 515 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-4 | 0.08% | 0.06% |
| TCA | 0.11% | 0.08% |
| TOTAL | 100.00 | 100.00 |

TABLE 131

| | Example 516 | Example 517 |
|---|---|---|
| Gum Base | 25.00% | 30.00% |
| Sugar | 57.11% | 58.46% |
| Corn Syrup | 15.00% | 9.00% |
| Glycerin | 2.00% | 1.50% |
| Spearmint Oil | 0.70% | — |
| Peppermint Oil | — | 0.90% |
| WS-14 | 0.08% | 0.06% |
| TCA | 0.11% | 0.08% |
| TOTAL | 100.00 | 100.00 |

Additional cooling agents from the other Groups B, C, D, and E may also be added as in some of the following examples:

TABLE 132

| | Exam- | Exam- | Exam- | Exam- | Exam- | Exam- |
|---|---|---|---|---|---|---|
| | ple | ple | ple | ple | ple | ple |
| | 518 | 519 | 520 | 521 | 522 | 523 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-5 | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 133

| | Exam- | Exam- | Exam- | Exam- | Exam- | Exam- |
|---|---|---|---|---|---|---|
| | ple | ple | ple | ple | ple | ple |
| | 524 | 525 | 526 | 527 | 528 | 529 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| BAMC | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 134

| | Exam- | Exam- | Exam- | Exam- | Exam- | Exam- |
|---|---|---|---|---|---|---|
| | ple | ple | ple | ple | ple | ple |
| | 530 | 531 | 532 | 533 | 534 | 535 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| PEMC | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 135

| | Exam- | Exam- | Exam- | Exam- | Exam- | Exam- |
|---|---|---|---|---|---|---|
| | ple | ple | ple | ple | ple | ple |
| | 536 | 537 | 538 | 539 | 540 | 541 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-4 | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 136

| | Exam- | Exam- | Exam- | Exam- | Exam- | Exam- |
|---|---|---|---|---|---|---|
| | ple | ple | ple | ple | ple | ple |
| | 542 | 543 | 544 | 545 | 546 | 547 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-14 | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 137

| | Exam- | Exam- | Exam- | Exam- | Exam- | Exam- |
|---|---|---|---|---|---|---|
| | ple | ple | ple | ple | ple | ple |
| | 548 | 549 | 550 | 551 | 552 | 553 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| WS-30 | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

Other coolants from Group E can also be used to produce synergistic effects in chewing gum. Some of these are:
1) Cubebol, (FEMA 4497);
2) 2-sec butyl cyclohexanone, BCH, (FEMA 3261);
3) Homomenthol or 3,3,5-trimethyl cyclohexanol, (FEMA 3962);

These can be combined to produce synergistic cooling effects with other coolants from Groups A, B, C, or D as in the following tables:

TABLE 138

| | Exam- | Exam- | Exam- | Exam- | Exam- | Exam- |
|---|---|---|---|---|---|---|
| | ple | ple | ple | ple | ple | ple |
| | 554 | 555 | 556 | 557 | 558 | 559 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| Cubebol | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 139

| | Exam- | Exam- | Exam- | Exam- | Exam- | Exam- |
|---|---|---|---|---|---|---|
| | ple | ple | ple | ple | ple | ple |
| | 560 | 561 | 562 | 563 | 564 | 565 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| Cubebol | 0.30 | 0.10 | 0.08 | 0.25 | 0.13 | 0.04 |
| Menthone | — | — | — | 0.05 | 0.05 | 0.04 |
| Glycerol | | | | | | |
| Ketal | | | | | | |
| Butanamides | — | 0.05 | 0.05 | 0.06 | — | — |
| Menthyl | 0.30 | — | 0.20 | 0.10 | — | 0.10 |
| Glutarate | | | | | | |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 140

| | Exam- | Exam- | Exam- | Exam- | Exam- | Exam- |
|---|---|---|---|---|---|---|
| | ple | ple | ple | ple | ple | ple |
| | 566 | 567 | 568 | 569 | 570 | 571 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| BCH | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 141

| | Exam- | Exam- | Exam- | Exam- | Exam- | Exam- |
|---|---|---|---|---|---|---|
| | ple | ple | ple | ple | ple | ple |
| | 572 | 573 | 574 | 575 | 576 | 577 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| BCH | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl | 0.30 | — | 0.20 | 0.10 | — | 0.10 |
| Glutarate | | | | | | |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 142

| | Exam- | Exam- | Exam- | Exam- | Exam- | Exam- |
|---|---|---|---|---|---|---|
| | ple | ple | ple | ple | ple | ple |
| | 578 | 579 | 580 | 581 | 582 | 583 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| Homomenthol | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl Lactate | 0.30 | — | 0.20 | 0.10 | — | 0.10 |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

TABLE 143

| | Exam- | Exam- | Exam- | Exam- | Exam- | Exam- |
|---|---|---|---|---|---|---|
| | ple | ple | ple | ple | ple | ple |
| | 584 | 585 | 586 | 587 | 588 | 589 |
| Gum Base | 48.00 | 35.00 | 30.00 | 25.00 | 22.00 | 30.00 |
| Sorbitol | 34.05 | 48.85 | 52.57 | 60.69 | 59.24 | 51.12 |
| Hydrogenated | — | — | — | 7.50 | 14.00 | 10.00 |
| Starch | | | | | | |
| Hydrolysate | | | | | | |
| Syrup | | | | | | |
| 70% Sorbitol | 10.00 | 8.00 | — | — | — | — |
| Solution | | | | | | |
| Glycerin | 5.00 | 6.00 | 15.00 | 5.00 | 3.00 | 7.00 |
| Encapsulated | 0.30 | 0.50 | 0.60 | 0.20 | 0.30 | 0.40 |
| Aspartame | | | | | | |
| Methyl | 0.50 | — | — | — | 0.70 | — |
| Salicylate | | | | | | |
| Peppermint Oil | 1.30 | 0.40 | — | 0.95 | 0.20 | 1.20 |
| Spearmint Oil | 0.20 | 0.80 | 0.80 | — | — | — |
| BCH | 0.30 | 0.10 | 0.08 | 0.25 | 0.13 | 0.04 |
| Menthone | — | — | — | 0.05 | 0.05 | 0.04 |
| Glycerol Ketal | | | | | | |
| Butanamides | — | 0.05 | 0.05 | 0.06 | — | — |
| Menthyl | 0.30 | — | 0.20 | 0.10 | — | 0.10 |
| Glutarate | | | | | | |
| TCA | 0.05 | 0.10 | 0.20 | 0.20 | 0.08 | 0.10 |
| Menthol | — | 0.20 | 0.50 | — | 0.30 | — |
| | 100.00 | 100.00 | 100.00 | 100.00 | 100.00 | 100.00 |

The above tables show formulations in a peppermint flavored, spearmint flavored or wintergreen flavored chewing gum. Other gum products can be made with other flavors as well. Menthol and/or physiological cooling agents may enhance these various types of flavors, such as menthol-eucalyptus, spearmint-menthol, cinnamon-menthol, and even fruity mint-menthol.

The formulations for various flavored gum formulas are found in the following tables. Again, the cooling agents may (Examples 554-593) or may not be encapsulated, depending on whether a modified release is desired. In these examples selected coolants from each group are used, but any other coolants from the group may be substituted for the coolant in the formula.

TABLE 144
VARIOUS-FLAVORED SUGARLESS GUM

| | Exam- | Exam- | Exam- | Exam- |
|---|---|---|---|---|
| | ple 590 | ple 591 | ple 592 | ple 593 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of WS-5/WS-23 | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 145
VARIOUS-FLAVORED SUGARLESS GUM

| | Exam- | Exam- | Exam- | Exam- |
|---|---|---|---|---|
| | ple 594 | ple 595 | ple 596 | ple 597 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of DMIB/MENETH | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 146
VARIOUS-FLAVORED SUGARLESS GUM

| | Exam- | Exam- | Exam- | Exam- |
|---|---|---|---|---|
| | ple 598 | ple 599 | ple 600 | ple 601 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of MENETH/MS | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 147
VARIOUS-FLAVORED SUGARLESS GUM

| | Exam- | Exam- | Exam- | Exam- |
|---|---|---|---|---|
| | ple 602 | ple 603 | ple 604 | ple 605 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of MS/Cubebol | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 148
VARIOUS-FLAVORED SUGARLESS GUM

| | Exam- | Exam- | Exam- | Exam- |
|---|---|---|---|---|
| | ple 606 | ple 607 | ple 608 | ple 609 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend BAMC/Isopulegol | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 149
VARIOUS-FLAVORED SUGARLESS GUM

| | Exam- | Exam- | Exam- | Exam- |
|---|---|---|---|---|
| | ple 610 | ple 611 | ple 612 | ple 613 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of PEMC/MG | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 150
VARIOUS-FLAVORED SUGARLESS GUM

| | Exam- | Exam- | Exam- | Exam- |
|---|---|---|---|---|
| | ple 614 | ple 615 | ple 616 | ple 617 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of WS-4/Cubebol | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 151
VARIOUS-FLAVORED SUGARLESS GUM

| | Exam- | Exam- | Exam- | Exam- |
|---|---|---|---|---|
| | ple 618 | ple 619 | ple 620 | ple 621 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of DHDB/MLAK | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 152
VARIOUS-FLAVORED SUGARLESS GUM

| | Exam- | Exam- | Exam- | Exam- |
|---|---|---|---|---|
| | ple 622 | ple 623 | ple 624 | ple 625 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of HDIB/BCH | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

TABLE 153
VARIOUS-FLAVORED SUGARLESS GUM

| | Exam- | Exam- | Exam- | Exam- |
|---|---|---|---|---|
| | ple 626 | ple 627 | ple 628 | ple 629 |
| Gum Base | 30.00 | 30.00 | 30.00 | 30.00 |
| Calcium Carbonate | 5.00 | 5.00 | 5.00 | 5.00 |
| Sorbitol | 54.60 | 53.68 | 53.80 | 55.05 |
| Glycerin | 8.00 | 8.00 | 8.00 | 7.00 |
| Encapsulated Sweetener | 0.50 | 0.50 | 0.50 | 0.50 |
| Flavor | 1.00^{A} | 1.50^{B} | 1.40^{B} | 1.60^{C} |
| Menthol | 0.20 | 0.12 | 0.30 | 0.20 |
| 50/50 blend of MG/Cubebol | 0.10 | 0.20 | 0.10 | 0.05 |
| Lecithin | 0.60 | 0.60 | 0.60 | 0.60 |
| Encapsulated Menthol | — | 0.40 | 0.30 | — |
| TOTAL | 100.00 | 100.00 | 100.00 | 100.00 |

^{A}Spearmint Flavor
^{B}Menthol-Eucalyptus Flavor
^{C}Cinnamon-Menthol Flavor

The combination of physiological cooling agents may be used in a wide variety of sugarless and sugar chewing gum formulations. The cooling agents may be encapsulated or entrapped in a wide variety of controlled release techniques as previously discussed. Gum formulations in which these materials may be used are given in tables 154-160. These formulas may also be made with non-encapsulated physiological cooling agents. Examples of the techniques and resulting controlled release physiological cooling agents that may be used in these formulations are discussed in the examples following the tables.

TABLE 154
Regular-Tack Sugarless Gum

| | Exam- | Exam- | Exam- | Exam- | Exam- |
|---|---|---|---|---|---|
| | ple 630 | ple 631 | ple 632 | ple 633 | ple 634 |
| Sorbitol | 50.00 | 50.00 | 50.00 | 50.00 | 50.00 |
| Gum Base | 24.70 | 24.70 | 24.70 | 24.70 | 24.70 |
| Lecithin | 0.20 | 0.20 | 0.18 | 0.18 | 0.18 |
| Glycerin | 2.00 | 2.00 | 2.00 | 5.00 | 8.00 |
| Lycasin | 14.40 | 12.00 | 12.00 | 9.00 | 6.00 |
| Mannitol | 7.10 | 9.50 | 9.48 | 9.53 | 9.53 |
| Peppermint Flavor | 1.40 | 1.40 | 1.44 | 1.44 | 1.44 |
| Active Level of | 0.20 | 0.20 | 0.20 | 0.15 | 0.15 |
| Cooling Agents | | | | | |
| TOTAL | 100.00 | 100.00 | 100.00 | 100.00 | 100.00 |

TABLE 155
Regular-Tack Sugarless Gum

| | Exam- | Exam- | Exam- | Exam- | Exam- |
|---|---|---|---|---|---|
| | ple 635 | ple 636 | ple 637 | ple 638 | ple 639 |
| Sorbitol | 49.35 | 49.35 | 49.35 | 49.35 | 49.35 |
| Gum Base | 25.50 | 25.50 | 25.50 | 25.50 | 25.50 |
| Lecithin | 0.20 | 0.20 | 0.20 | 0.20 | 0.20 |
| Glycerin | 8.50 | 8.50 | 8.50 | 8.60 | 8.50 |
| Liquid Sorbitol | 6.80 | 6.80 | 6.80 | 6.80 | 6.90 |
| Mannitol | 8.00 | 8.00 | 8.00 | 8.00 | 8.00 |
| Active Level of | 0.20 | 0.20 | 0.20 | 0.10 | 0.10 |
| Cooling Agents | | | | | |
| Peppermint Flavor | 1.45 | 1.45 | 1.45 | 1.45 | 1.45 |
| TOTAL | 100.00 | 100.00 | 100.00 | 100.00 | 100.00 |

TABLE 156
Sugarless Pellet Gums for Coating

| | Exam- | Exam- | Exam- | Exam- | Exam- |
|---|---|---|---|---|---|
| | ple 640 | ple 641 | ple 642 | ple 643 | ple 644 |
| Sorbitol | 51.16 | 43.87 | 45.92 | 43.81 | 46.33 |
| Gum Base | 31.01 | 33.00 | 32.71 | 33.03 | 30.97 |
| Glycerin | 6.14 | 8.00 | 7.50 | 7.98 | 7.82 |
| Aspartame | 0.06 | — | 0.10 | — | 0.08 |
| Active Level of | 0.42 | 0.23 | 0.35 | 0.25 | 0.34 |
| Cooling Agents | | | | | |
| Calcium | 10.01 | 13.00 | 12.16 | 12.93 | 13.04 |
| Carbonate | | | | | |
| Peppermint Flavor | — | 1.20 | 0.17 | — | 1.01 |
| Menthol | — | 0.50 | — | — | 0.21 |
| Fruit Flavor | — | — | — | 1.50 | — |
| Lemon Flavor | — | — | — | .50 | — |
| Encapsulated | — | 0.20 | — | — | 0.20 |
| Menthol | | | | | |
| Spearmint Flavor | 1.20 | — | 1.09 | — | — |
| TOTAL | 100.00 | 100.00 | 100.00 | 100.00 | 100.00 |

TABLE 157
Sugarless Bubble Gums

| | Example | Example | Example | Example |
|---|---|---|---|---|
| | 645 | 646 | 647 | 648 |
| Sorbitol | 56.65 | 56.09 | 50.42 | 48.63 |
| Gum Base | 24.00 | 24.59 | 28.00 | 30.10 |
| Lecithin | 1.00 | 0.91 | 0.89 | 0.86 |
| Fruit Flavor | 1.20 | 1.41 | — | — |
| Grape Flavor | — | — | 1.71 | — |
| Strawberry Flavor | — | — | — | 1.41 |
| Evaporated | — | 6.79 | 9.61 | 10.41 |
| Lycasin/Glycerin* | | | | |
| Glycerin | 17.00 | 10.00 | 9.00 | 8.21 |
| Free Aspartame | 0.04 | — | 0.06 | 0.17 |
| Active Level of | 0.11 | 0.21 | 0.31 | 0.21 |
| Cooling Agents | | | | |
| TOTAL | 100.00 | 100.00 | 100.00 | 100.00 |

*Contains 25% glycerin, 67.5% Lycasin brand hydrogenated starch hydrolysate solids and 7.5% water.

TABLE 158
Sugar Gums

| | Exam- | Exam- | Exam- | Exam- | Exam- |
|---|---|---|---|---|---|
| | ple 649 | ple 650 | ple 651 | ple 652 | ple 653 |
| Sugar | 58.29 | 59.26 | 62.49 | 59.97 | 56.61 |
| Gum Base | 22.38 | 20.60 | 20.08 | 23.17 | 26.80 |
| Corn Syrup | 17.20 | 18.50 | 15.40 | 14.70 | 13.88 |
| Glycerin | 1.09 | 0.83 | 1.00 | 1.00 | 1.30 |
| Active Level of | 0.10 | 0.20 | 0.15 | 0.25 | 0.20 |
| Cooling Agents | | | | | |
| Lecithin | 0.05 | 0.03 | 0.02 | — | — |
| Peppermint Flavor | 0.89 | 0.58 | 0.86 | 0.91 | 1.21 |
| TOTAL | 100.00 | 100.00 | 100.00 | 100.00 | 100.00 |

TABLE 159
Sugar Gums

| | Exam- | Exam- | Exam- | Exam- | Exam- |
|---|---|---|---|---|---|
| | ple 654 | ple 655 | ple 656 | ple 657 | ple 658 |
| Sugar | 54.30 | 45.30 | 49.30 | 40.30 | 45.30 |
| Gum Base | 19.20 | 19.20 | 19.20 | 19.20 | 19.20 |
| Glycerin | 1.40 | 1.40 | 1.40 | 1.40 | 1.40 |
| Corn Syrup | 19.00 | 23.00 | 19.00 | 19.00 | 23.00 |
| Dextrose | — | 5.00 | — | — | — |
| Lactose | 5.00 | — | — | — | — |
| Fructose | — | 5.00 | — | — | — |
| Invert Sugar | — | — | 10.00 | — | — |
| Maltose | — | — | — | 10.00 | — |
| Palatinose | — | — | — | — | 10.00 |
| Spearmint Flavor | 0.90 | 0.90 | 0.90 | 9.90 | 0.90 |
| Active Level of | 0.20 | 0.20 | 0.20 | 0.20 | 0.20 |
| Cooling Agents | | | | | |
| TOTAL | 100.00 | 100.00 | 100.00 | 100.00 | 100.00 |

TABLE 160
Sugarless Gums

| | Example | Example | Example | Example | Example | Example | Example | Example |
|---|---|---|---|---|---|---|---|---|
| | 659 | 660 | 661 | 662 | 663 | 664 | 665 | 666 |
| Gum Base | 25.50 | 25.50 | 25.50 | 25.50 | 25.50 | 25.50 | 25.50 | 25.50 |
| Sorbitol | 53.80 | 46.80 | 41.80 | 41.80 | 41.80 | 41.80 | 36.80 | 37.80 |
| Sorbitol Liquid/ | 17.00 | 14.00 | 6.00 | — | 5.00 | — | — | 11.00^{A} |
| Lycasin | | | | | | | | |
| Mannitol | — | 10.00 | 8.00 | 8.00 | 8.00 | 8.00 | 8.00 | 8.00 |
| Maltitol | — | — | — | 5.00 | — | — | 5.00 | — |
| Xylitol | — | — | 15.00 | 10.00 | — | — | 5.00 | 10.00 |
| Lactitol | — | — | — | — | 10.00 | — | — | — |
| Hydrogenated | — | — | — | — | — | 15.00 | 10.00 | — |
| Isomaltulose | | | | | | | | |
| Glycerin | 2.00 | 2.00 | 2.00 | 8.00 | 8.00 | 8.00 | 8.00 | 6.00 |
| Flavor | 1.50 | 1.50 | 1.50 | 1.50 | 1.50 | 1.50 | 1.50 | 1.50 |
| Active Level of | 0.20 | 0.20 | 0.20 | 0.20 | 0.20 | 0.20 | 0.20 | 0.20 |
| Cooling Agents | | | | | | | | |
| TOTAL | 100.00 | 100.00 | 100.00 | 100.00 | 100.00 | 100.00 | 100.00 | 100.00 |

^{A}Lycasin brand hydrogenated starch hydrolysate syrup; all others use 70% sorbitol liquid.

Encapsulated cooling agents may be made by the Examples 667-915 that follow and added to any of the formulas given in tables 154 through 160. Encapsulations with water soluble polymers such as HPMC or maltodextrins will give a fast release of cooling agent. Encapsulations with alcoholic shellac, alcoholic Zein or PVAC will give a slow release.

Any of the coolants listed in Group A can be mixed together to form an encapsulated blend, any of the coolants listed in Group B can be mixed together to form an encapsulated blend, any of the coolants listed in Group C can be mixed together to form an encapsulated blend, any of the coolants listed in Group D can be mixed together to form an encapsulated blend, and any of the coolants listed in Group E can be mixed together to form an encapsulated blend. Encapsulated blends can also be mixtures of multiple combinations of coolants with any 2 or more coolants from a specific group. In addition the encapsulated coolant blends from any of the Groups may be blended with any of the coolants from any of the other Groups. Coolants from any of the 3, 4 or even all 5 groups can also be mixed to form encapsulated blends. The following table discloses various combinations of encapsulated coolants in the 5 groups that can be combined in a variety of encapsulated blends to be used in chewing gum and confectionary products:

### Example 667

This example contains a cooling agent composition which has 25% menthyl succinate and 75% WS-5 entrapped with polyvinyl-acetate.

### Example 668

This example contains a cooling agent composition which has 25% menthyl succinate and 75% DMIB entrapped with polyvinyl-acetate.

### Example 669

This example contains a cooling agent composition which has 25% menthyl lactate and 75% DHDB entrapped with polyvinyl-acetate.

### Example 670

This example contains a cooling agent composition which has 50% menthyl lactate and 50% HDIB entrapped with polyvinyl-acetate.

### Example 671

This example contains a cooling agent composition which has 50% menthyl succinate and 50% WS-3 entrapped with polyvinyl-acetate.

### Example 672

This example contains a cooling agent composition which has 25% DMIB and 75% WS-5 entrapped with polyvinyl-acetate.

### Example 673

This example contains a cooling agent composition which has 25% DHDB and 75% WS-23 entrapped with polyvinyl-acetate.

### Example 674

This example contains a cooling agent composition which has 25% HDIB and 75% WS-3 entrapped with polyvinyl-acetate.

### Example 675

This example contains a cooling agent composition which has 50% DHDB and 50% WS-3 entrapped with polyvinyl-acetate.

### Example 676

This example contains a cooling agent composition which has 25% DMIB and 75% WS-23 entrapped with polyvinyl-acetate.

### Example 677

This example contains a cooling agent composition containing 50% menthyl glutarate and 50% DMIB agglomerated with hydroxypropylmethyl cellulose.

### Example 678

This example contains a cooling agent composition containing 50% menthyl glutarate and 50% WS-5 agglomerated with hydroxypropylmethyl cellulose.

### Example 679

This example contains a cooling agent composition containing 50% menthyl lactate and 50% DHDB agglomerated with hydroxypropylmethyl cellulose.

### Example 680

This example contains a cooling agent composition containing 50% menthyl lactate and 50% HDIB agglomerated with hydroxypropylmethyl cellulose.

### Example 681

This example contains a cooling agent composition containing 50% MENETH and 50% WS-5 agglomerated with hydroxypropylmethyl cellulose.

### Example 682

This example contains a cooling agent composition containing 50% TCA and 50% BCH agglomerated with hydroxypropylmethyl cellulose.

### Example 683

This example contains a cooling agent composition which has 75% menthyl glutarate and 25% WS-5 coated with Zein.

### Example 684

This example contains a cooling agent composition which has 75% menthyl glutarate and 25% DMIB coated with Zein.

### Example 685

This example contains a cooling agent composition which has 75% menthyl lactate and 25% DHDB coated with Zein.

### Example 686

This example contains a cooling agent composition which has 75% menthyl lactate and 25% HDIB coated with Zein.

### Example 687

This example contains a cooling agent composition which has 50% TCA and 50% MGK coated with Zein.

### Example 688

This example contains a cooling agent composition which has 50% menthyl glutarate and 50% BCH coated with Zein.

### Example 689

This example contains a cooling agent composition which has 25% menthyl lactate and 75% WS-5 melted and absorbed onto silica.

### Example 690

This example contains a cooling agent composition which has 50% menthyl glutarate and 50% WS-5 melted and absorbed onto silica.

### Example 691

This example contains a cooling agent composition which has 25% menthyl glutarate and 75% DMIB melted and absorbed onto silica.

### Example 692

This example contains a cooling agent composition which has 50% menthyl lactate and 50% DHDB melted and absorbed onto silica.

### Example 693

This example contains a cooling agent composition which has 25% menthyl glutarate and 75% menthyl lactate melted and absorbed onto silica.

### Example 694

This example contains a cooling agent composition which has 25% TCA and 75% HDIB melted and absorbed onto silica.

### Example 695

This example contains a cooling agent composition which has 50% menthyl succinate and 50% WS-5 coated with shellac.

### Example 696

This example contains a cooling agent composition which has 50% menthyl lactate and 50% DMIB coated with shellac.

### Example 697

This example contains a cooling agent composition which has 50% menthyl glutarate and 50% DHDB coated with shellac.

### Example 698

This example contains a cooling agent composition which has 50% DMIB and 50% HDIB coated with shellac.

### Example 699

This example contains a cooling agent composition which has 50% MAA and 50% DHDB coated with shellac.

### Example 700

This example contains a cooling agent composition which has 50% menthyl 3-hydroxybutyrate and 50% WS-5 coated with shellac.

### Example 701

This example contains a cooling agent composition which has 25% menthyl succinate and 75% WS-5 which was spray dried and extruded with polyvinyl acetate.

### Example 702

This example contains a cooling agent composition which has 25% menthyl succinate and 75% DMIB which was spray dried and extruded with polyvinyl acetate.

### Example 703

This example contains a cooling agent composition which has 25% menthyl succinate and 75% DHDB which was spray dried and extruded with polyvinyl acetate.

### Example 704

This example contains a cooling agent composition which has 50% menthyl succinate and 50% HDIB which was spray dried and extruded with polyvinyl acetate.

### Example 705

This example contains a cooling agent composition which has 25% menthyl succinate and 75% BCH which was spray dried and extruded with polyvinyl acetate.

### Example 706

This example contains a cooling agent composition which has 25% menthyl glutarate and 75% BAMC which was spray dried and extruded with polyvinyl acetate.

### Example 707

This example contains a cooling agent composition which has 25% menthyl glutarate, 25% DMIB and 75% BAMC which was spray dried and extruded with polyvinyl acetate.

### Example 708

This example contains a cooling agent composition which has 25% DMIB, 25% DHDB, and 50% WS-5 which was spray dried and extruded with polyvinyl acetate.

### Example 709

This example contains a cooling agent composition which has 25% menthyl lactate, 25% HDIB, and 50% WS-5 which was spray dried and extruded with polyvinyl acetate.

### Example 710

This example contains a cooling agent composition which has 75% menthyl succinate and 25% WS-5 agglomerated with hydroxypropylmethyl cellulose.

### Example 711

This example contains a cooling agent composition which has 50% menthyl glutarate and 50% DHDB agglomerated with hydroxypropylmethyl cellulose.

### Example 712

This example contains a cooling agent composition which has 25% menthyl lactate, 50% HDIB, and 25% MGK agglomerated with hydroxypropylmethyl cellulose.

### Example 713

This example contains a cooling agent composition which has 25% menthyl succinate, 50% DHDB, and 25% MGK agglomerated with hydroxypropylmethyl cellulose.

### Example 714

This example contains a cooling agent composition which has 25% menthyl lactate, 50% WS-5 and 25% DMIB agglomerated with hydroxypropylmethyl cellulose.

### Example 715

This example contains a cooling agent composition which has 25% menthyl succinate, 25% TCA, and 50% DMIB coated with Zein.

### Example 716

This example contains a cooling agent composition which has 25% menthyl glutarate, 25% TCA, and 50% DHDB coated with Zein.

### Example 717

This example contains a cooling agent composition which has 25% menthyl lactate, 25% TCA and 50% HDIB coated with Zein.

### Example 718

This example contains a cooling agent composition which has 25% menthyl lactate, 25% WS-5, and 50% BAMC coated with Zein.

### Example 719

This example contains a cooling agent composition which has 25% menthanediol, 25% WS-5, and 50% MPGC coated with Zein.

### Example 720

This example contains a cooling agent composition which has 50% menthyl succinate and 50% WS-23 coated with hydroxypropylmethyl cellulose.

### Example 721

This example contains a cooling agent composition which has 50% menthyl succinate and 50% DMIB coated with hydroxypropylmethyl cellulose.

### Example 722

This example contains a cooling agent composition which has 50% menthyl succinate and 50% DHDB coated with hydroxypropylmethyl cellulose.

### Example 723

This example contains a cooling agent composition which has 50% menthyl succinate and 50% HDIB coated with hydroxypropylmethyl cellulose.

### Example 724

This example contains a cooling agent composition which has 50% menthyl succinate and 50% EDIB coated with hydroxypropylmethyl cellulose.

### Example 725

This example contains a cooling agent composition which has 50% menthyl succinate and 50% WS-5 coated with hydroxypropylmethyl cellulose.

### Example 726

This example contains a cooling agent composition which has 75% menthyl succinate and 25% WS-5 melted and absorbed onto silica.

### Example 727

This example contains a cooling agent composition which has 75% menthyl succinate and 25% BAMC melted and absorbed onto silica.

### Example 728

This example contains a cooling agent composition which has 75% menthyl succinate and 25% PEMC melted and absorbed onto silica.

### Example 729

This example contains a cooling agent composition which has 75% menthyl succinate and 25% WS-30 melted and absorbed onto silica.

### Example 730

This example contains a cooling agent composition which has 75% menthyl succinate and 25% WS-4 melted and absorbed onto silica.

### Example 731

This example contains a cooling agent composition which has 75% menthyl succinate and 25% WS-12 melted and absorbed onto silica.

### Example 732

This example contains a cooling agent composition which has 25% Menthyl Lactate and 75% WS-23 agglomerated with gelatin.

### Example 733

This example contains a cooling agent composition which has 25% Menthyl Lactate and 75% WS-3 agglomerated with gelatin.

### Example 734

This example contains a cooling agent composition which has 25% Menthyl Lactate and 75% DMIB agglomerated with gelatin.

### Example 735

This example contains a cooling agent composition which has 25% Menthyl Lactate and 75% DHDB agglomerated with gelatin.

### Example 736

This example contains a cooling agent composition which has 25% Menthyl Lactate and 75% HDIB agglomerated with gelatin.

### Example 737

This example contains a cooling agent composition which has 25% Menthyl Lactate and 75% EDIB agglomerated with gelatin.

### Example 738

This example contains a cooling agent composition which has 50% Menthyl Lactate and 50% WS-3 melted and absorbed onto silica.

### Example 739

This example contains a cooling agent composition which has 50% Menthyl Lactate and 50% WS-5 melted and absorbed onto silica.

### Example 740

This example contains a cooling agent composition which has 50% Menthyl Lactate and 50% BAMC melted and absorbed onto silica.

### Example 741

This example contains a cooling agent composition which has 50% Menthyl Lactate and 50% PEMC melted and absorbed onto silica.

### Example 742

This example contains a cooling agent composition which has 50% Menthyl Lactate and 50% WS-4 melted and absorbed onto silica.

### Example 743

This example contains a cooling agent composition which has 50% Menthyl Lactate and 50% WS-14 melted and absorbed onto silica.

### Example 744

This example contains a cooling agent composition which has 25% Menthyl Lactate, 50% WS-5, and 25% TCA coated with shellac.

### Example 745

This example contains a cooling agent composition which has 25% Menthyl Glutarate, 25% BAMC, and 50% isopulegol coated with shellac.

### Example 746

This example contains a cooling agent composition which has 25% Menthyl Lactate, 50% Menthyl Glutarate, and 25% TCA coated with shellac.

### Example 747

This example contains a cooling agent composition which has 25% Menthyl Lactate, 50% menthanediol, and 25% TCA coated with shellac.

### Example 748

This example contains a cooling agent composition which has 25% Menthyl Lactate, 50% MENETH and 25% TCA coated with shellac.

### Example 749

This example contains a cooling agent composition which has 25% Menthyl Glutarate, 50% MME, and 25% TCA coated with shellac.

### Example 750

This example contains a cooling agent composition which has 50% Cubebol and 50% WS-23 which is agglomerated with Zein.

### Example 751

This example contains a cooling agent composition which has 50% Cubebol and 50% DMIB which is agglomerated with Zein.

### Example 752

This example contains a cooling agent composition which has 50% Cubebol and 50% DHDB which is agglomerated with Zein.

### Example 753

This example contains a cooling agent composition which has 50% BCH and 50% HDIB which is agglomerated with Zein.

### Example 754

This example contains a cooling agent composition which has 50%

BCH and 50% MGK which is agglomerated with Zein.

### Example 755

This example contains a cooling agent composition which has 50% BCH and 50% WS-5 which is agglomerated with Zein.

### Example 756

This example contains a cooling agent composition which has 25%

MGK and 75% isopulegol which is agglomerated with hydroxypropylmethyl cellulose.

### Example 757

This example contains a cooling agent composition which has 25% MAA and 75% WS-5 which is agglomerated with hydroxypropylmethyl cellulose.

### Example 758

This example contains a cooling agent composition which has 25% MPGC and 75% DMIB which is agglomerated with hydroxypropylmethyl cellulose.

### Example 759

This example contains a cooling agent composition which has 25% DMIB and 75% Cubebol which is agglomerated with hydroxypropylmethyl cellulose.

### Example 760

This example contains a cooling agent composition which has 25% DHDB, 50% WS-3, and 25% BCH which is agglomerated with hydroxypropylmethyl cellulose.

### Example 761

This example contains a cooling agent composition which has 25% Menthyl succinate, 25% isopulegol, and 50% BCH which is agglomerated with hydroxypropylmethyl cellulose.

### Example 762

This example contains a cooling agent composition which has 25% MGK, 50% MENETH, and 25% WS-23 coated with shellac.

### Example 763

This example contains a cooling agent composition which has 25% MAA, 50% DMIB, and 25% WS-3 coated with shellac.

### Example 764

This example contains a cooling agent composition which has 25% Menthyl Lactate, 25% DMIB, and 50% WS-5 coated with shellac.

### Example 765

This example contains a cooling agent composition which has 25%

Menthyl Lactate, 25% BAMC, 25% DHDB, and 25% isopulegol coated with shellac.

### Example 766

This example contains a cooling agent composition which has 25% Menthyl glutarate, 25% WS-5, 25% DHDB, and 25% TCA coated with shellac.

### Example 767

This example contains a cooling agent composition which has 25% Menthyl succinate, 25% PEMC. 25% HDIB, and 25% isopulegol coated with shellac.

### Example 768

This example contains a cooling agent composition which has 20% Menthyl succinate, 20% PEMC. 20% HDIB, 20% Cubebol, and 20% isopulegol coated with shellac.

### Example 769

This example contains a cooling agent composition which has 20% Menthyl glutarate, 20% WS-5.20% HDIB, 20% MGK, and 20% isopulegol coated with shellac.

### Example 770

This example contains a cooling agent composition which has 20%

Menthyl lactate, 20% WS-3.20% HDIB, 20% WS-23, and 20% isopulegol coated with shellac.

### Example 771

This example contains a cooling agent composition which has 20% Menthyl glutarate, 20% menthyl lactate, 20% WS-5, 20% HDIB, and 20% isopulegol coated with shellac.

### Example 772

This example contains a cooling agent composition which has 20% Menthyl succinate, 20% WS-5.20% WS-23, 20% menthyl glutarate, and 20% isopulegol coated with shellac.

### Example 773

This example contains a cooling agent composition which has 50% menthyl lactate and 50% WS-5 coated with maltodextrin.

### Example 774

This example contains a cooling agent composition which has 50% menthyl succinate and 50% BAMC coated with maltodextrin.

### Example 775

This example contains a cooling agent composition which has 50% menthyl glutarate and 50% PEMC coated with maltodextrin.

### Example 776

This example contains a cooling agent composition which has 50% menthyl lactate and 50% menthyl glutarate coated with maltodextrin.

### Example 777

This example contains a cooling agent composition which has 50% menthyl glutarate and 25% WS-5, and 25% WS-23 coated with maltodextrin.

### Example 778

This example contains a cooling agent composition which has 25% WS-5, 25% HDIB, and 50% isopulegol coated with maltodextrin.

### Example 779

This example contains a cooling agent composition which has 25% menthyl lactate, 25% DHDB, 25% BAMC, and 25% isopulegol coated with maltodextrin.

### Example 780

This example contains a cooling agent composition which has 50% menthyl lactate and 50% WS-5 coated with gum Arabic.

### Example 781

This example contains a cooling agent composition which has 50% menthyl glutarate and 50% DHDB coated with gum Arabic.

### Example 782

This example contains a cooling agent composition which has 50% menthyl lactate and 50% DMIB coated with gum Arabic.

### Example 783

This example contains a cooling agent composition which has 50% menthyl glutarate, 25% menthyl lactate, and 25% WS-5 coated with gum Arabic.

### Example 784

This example contains a cooling agent composition which has 50% menthyl glutarate, 25% DHDB, and 25% BAMC coated with gum Arabic.

### Example 785

This example contains a cooling agent composition which has 25% menthyl glutarate, 25% DMIB, 25% DHDB, and 25% BAMC coated with gum Arabic.

### Example 786

This example contains a cooling agent composition which has 25% menthyl glutarate, 25% WS-23, and 25% WS-5, and 25% isopulegol coated with gum Arabic.

### Example 787

This example contains a cooling agent composition which has 20% menthyl glutarate, 20% DMIB, 20% WS-5, 20% isopulegol, and 20% BCH coated with gum Arabic.

### Example 788

This example contains a cooling agent composition which has 25% TCA, 25% WS-3, and 50% DMIB which was spray dried and extruded with polyvinyl acetate.

### Example 789

This example contains a cooling agent composition which has 25% TCA, 25% DHDB, and 50% WS-5 which was spray dried and extruded with polyvinyl acetate.

### Example 790

This example contains a cooling agent composition which has 25% TCA, 25% HDIB, 25% menthyl lactate, and 25% isopulegol which was spray dried and extruded with polyvinyl acetate.

### Example 791

This example contains a cooling agent composition which has 25% TCA, 25% menthyl glutarate, 25% WS-5, and 25% Homomenthol which was spray dried and extruded with polyvinyl acetate.

### Example 792

This example contains a cooling agent composition which has 20% TCA, 20% DMIB, 20% WS-5, 20% isopulegol, and 20% Cubebol which was spray dried and extruded with polyvinyl acetate.

### Example 793

This example contains a cooling agent composition which has 50% TCA and 50% WS-5 agglomerated with Zein.

### Example 794

This example contains a cooling agent composition which has 50% menthyl glutarate and 50% menthyl lactate agglomerated with Zein.

### Example 795

This example contains a cooling agent composition which has 50% menthyl glutarate, 25% DMIB, and 25% BAMC agglomerated with Zein.

### Example 796

This example contains a cooling agent composition which has 25% menthyl succinate, 25% DHDB, and 50% isopulegol agglomerated with Zein.

### Example 797

This example contains a cooling agent composition which has 25% WS-23, 25% DMIB, 25% MGK, and 25% isopulegol agglomerated with Zein.

### Example 798

This example contains a cooling agent composition which has 20% TCA, 20% HDIB, 20% WS-5, 20% menthyl lactate, and 20% Cubebol agglomerated with Zein.

### Example 799

An 80% shellac, 20% active cooling agent powder mixture is obtained by spray drying an alcohol/shellac/menthyl glutarate and menthyl lactate solution.

### Example 800

An 80% shellac, 20% active cooling agent powder mixture is obtained by spray drying an alcohol/shellac/menthyl glutarate, WS-5, and menthyl lactate solution.

### Example 801

An 80% shellac, 20% active cooling agent powder mixture is obtained by spray drying an alcohol/shellac/menthyl glutarate, menthyl succinate, and isopulegol solution.

### Example 802

An 80% shellac, 20% active cooling agent powder mixture is obtained by spray drying an alcohol/shellac/WS-5, DMIB, isopulegol, and menthyl lactate solution.

### Example 803

An 80% shellac, 20% active cooling agent powder mixture is obtained by spray drying an alcohol/shellac/DHDB, menthyl glutarate, BAMC, isopulegol, and Cubebol solution.

### Example 804

A 50% shellac, 50% active cooling agent powder mixture is obtained by spray drying an appropriate ratio of alcohol/shellac/menthyl lactate and menthyl glutarate solution.

### Example 805

A 50% shellac, 50% active cooling agent powder mixture is obtained by spray drying an appropriate ratio of alcohol/shellac/menthyl succinate, WS-5, and menthyl glutarate solution.

### Example 806

A 50% shellac, 50% active cooling agent powder mixture is obtained by spray drying an appropriate ratio of alcohol/shellac/menthyl glutarate, TCA, DMIB solution.

### Example 807

A 50% shellac, 50% active cooling agent powder mixture is obtained by spray drying an appropriate ratio of alcohol/shellac/menthyl glutarate, WS-5, DHDB, and isopulegol solution.

### Example 808

A 50% shellac, 50% active cooling agent powder mixture is obtained by spray drying an appropriate ratio of alcohol/shellac/menthyl lactate, HDIB, BAMC, isopulegol, and Cubebol solution.

### Example 809

A 70% Zein, 30% active cooling agent powder mixture is obtained by spray drying an alcohol/zein/menthyl glutarate and menthyl lactate solution.

### Example 810

A 70% Zein, 30% active cooling agent powder mixture is obtained by spray drying an alcohol/zein/menthyl glutarate, DMIB, and WS-5 solution.

### Example 811

A 70% Zein, 30% active cooling agent powder mixture is obtained by spray drying an alcohol/zein/menthyl lactate, DHDB, isopulegol solution.

### Example 812

A 70% Zein, 30% active cooling agent powder mixture is obtained by spray drying an alcohol/zein/menthyl succinate, BAMC, HDIB, and TCA solution.

### Example 813

A 70% Zein, 30% active cooling agent powder mixture is obtained by spray drying an alcohol/zein/menthyl glutarate, WS-3, DMIB, isopulegol, and Cubebol solution.

### Example 814

A shellac/silica/active cooling agent powder mixture is obtained by fluid-bed coating menthyl lactate and menthyl glutarate with an alcohol/shellac solution at 20% solids after being absorbed on silica.

### Example 815

A shellac/silica/active cooling agent powder mixture is obtained by fluid-bed coating menthyl lactate, WS-5, and menthyl succinate with an alcohol/shellac solution at 20% solids after being absorbed on silica.

### Example 816

A shellac/silica/active cooling agent powder mixture is obtained by fluid-bed coating menthyl lactate and DMIB with an alcohol/shellac solution at 20% solids after being absorbed on silica.

### Example 817

A shellac/silica/active cooling agent powder mixture is obtained by fluid-bed coating menthyl glutarate, BAMC, and DHDB with an alcohol/shellac solution at 20% solids after being absorbed on silica.

### Example 818

A shellac/silica/active cooling agent powder mixture is obtained by fluid-bed coating menthyl glutarate, isopulegol, HDIB, and TCA with an alcohol/shellac solution at 20% solids after being absorbed on silica.

### Example 819

A shellac/silica/active cooling agent powder mixture is obtained by fluid-bed coating menthyl succinate, WS-23, WS-5, isopulegol, and Cubebol with an alcohol/shellac solution at 20% solids after being absorbed on silica.

### Example 820

A shellac/silica/active cooling agent powder mixture is obtained by fluid-bed coating menthyl succinate, menthyl glutarate, and isopulegol with an alcohol/shellac solution at 20% solids after being absorbed on silica.

### Example 821

A Zein/silica/active cooling agent mixture is obtained by fluid-bed coating menthyl glutarate and menthyl lactate with an alcohol/Zein solution at 25% solids after being absorbed on silica.

### Example 822

A Zein/silica/active cooling agent mixture is obtained by fluid-bed coating menthyl glutarate, WS-5, and menthyl lactate with an alcohol/Zein solution at 25% solids after being absorbed on silica.

### Example 823

A Zein/silica/active cooling agent mixture is obtained by fluid-bed coating menthyl glutarate, DMIB, BAMC, and menthyl lactate with an alcohol/Zein solution at 25% solids after being absorbed on silica.

### Example 824

A Zein/silica/active cooling agent mixture is obtained by fluid-bed coating menthyl glutarate, TCA, DHDB, and menthyl succinate with an alcohol/Zein solution at 25% solids after being absorbed on silica.

### Example 825

A Zein/silica/active cooling agent mixture is obtained by fluid-bed coating menthyl glutarate, HDIB, DMIB, Homomenthol, and isopulegol with an alcohol/Zein solution at 25% solids after being absorbed on silica.

### Example 826

A Zein/silica/active cooling agent mixture is obtained by fluid-bed coating menthyl glutarate, WS-5, Cubebol, and WS-23 with an alcohol/Zein solution at 25% solids after being absorbed on silica.

### Example 827

An 85% wax, 15% active menthyl succinate and menthyl lactate powder mixture is obtained by spray chilling a mixture of molten wax and cooling agent.

### Example 828

An 85% wax, 15% active menthyl lactate, DHDB, and DMIB powder mixture is obtained by spray chilling a mixture of molten wax and cooling agent.

### Example 829

An 85% wax, 15% active menthyl succinate, WS-23, BAMC, and isopulegol powder mixture is obtained by spray chilling a mixture of molten wax and cooling agent.

### Example 830

An 85% wax, 15% active TCA, WS-5, menthyl lactate, and DMIB powder mixture is obtained by spray chilling a mixture of molten wax and cooling agent.

### Example 831

An 85% wax, 15% active menthyl succinate, BAMC, MENETH, and DMIB powder mixture is obtained by spray chilling a mixture of molten wax and cooling agent.

### Example 832

An 85% wax, 15% active menthyl glutarate, WS-23, WS-3, isopulegol, and DHDB powder mixture is obtained by spray chilling a mixture of molten wax and cooling agent.

### Example 833

A 70% wax, 30% active WS-5 and WS-23 powder mixture is obtained by spray chilling a mixture of molten wax and cooling agent.

### Example 834

A 70% wax, 30% active BAMC and DMIB powder mixture is obtained by spray chilling a mixture of molten wax and cooling agent.

### Example 835

A 70% wax, 30% active DHDB, WS-5, and menthyl lactate powder mixture is obtained by spray chilling a mixture of molten wax and cooling agent.

### Example 836

A 70% wax, 30% active PEMC, HDIB, and menthyl succinate powder mixture is obtained by spray chilling a mixture of molten wax and cooling agent.

### Example 837

A 70% wax, 30% active menthyl glutarate, WS-23, WS-5, and BCH powder mixture is obtained by spray chilling a mixture of molten wax and cooling agent.

### Example 838

A 70% Zein, 30% active menthyl succinate and WS-5 powder mixture is obtained by spray drying an emulsified mixture of cooling agent and Zein dispersed in an aqueous, high-pH (pH=11.6-12.0) media at 15% solids.

### Example 839

A 70% Zein, 30% active menthyl lactate and BAMC powder mixture is obtained by spray drying an emulsified mixture of cooling agent and Zein dispersed in an aqueous, high-pH (pH=11.6-12.0) media at 15% solids.

### Example 840

A 70% Zein, 30% active menthyl glutarate, menthyl succinate, and isopulegol powder mixture is obtained by spray drying an emulsified mixture of cooling agent and Zein dispersed in an aqueous, high-pH (pH=11.6-12.0) media at 15% solids.

### Example 841

A 70% Zein, 30% active menthanediol, DMIB, and WS-5 powder mixture is obtained by spray drying an emulsified mixture of cooling agent and Zein dispersed in an aqueous, high-pH (pH=11.6-12.0) media at 15% solids.

### Example 842

A 70% Zein, 30% active isopulegol, BAMC, and DHDB powder mixture is obtained by spray drying an emulsified mixture of cooling agent and Zein dispersed in an aqueous, high-pH (pH=11.6-12.0) media at 15% solids.

### Example 843

A 70% Zein, 30% active TCA, HDIB, WS-3, and Cubebol powder mixture is obtained by spray drying an emulsified mixture of cooling agent and Zein dispersed in an aqueous, high-pH (pH=11.6-12.0) media at 15% solids.

### Example 844

A Zein/active menthyl succinate and WS-5 powder mixture is obtained by fluid-bed coating the cooling agent blend with an aqueous, high-pH (pH=11.6-12.0) Zein dispersion of 15% solids.

### Example 845

A Zein/active menthyl lactate, DMIB, and BAMC powder mixture is obtained by fluid-bed coating the cooling agent blend with an aqueous, high-pH (pH=11.6-12.0) Zein dispersion of 15% solids.

### Example 846

A Zein/active menthyl lactate, DHDB, and WS-3 powder mixture is obtained by fluid-bed coating the cooling agent blend with an aqueous, high-pH (pH=11.6-12.0) Zein dispersion of 15% solids.

### Example 847

A Zein/active menthyl succinate, WS-5, HDIB, and BCH powder mixture is obtained by fluid-bed coating the cooling agent blend with an aqueous, high-pH (pH=11.6-12.0) Zein dispersion of 15% solids.

### Example 848

A Zein/active menthyl succinate, TCA, DMIB, and isopulegol powder mixture is obtained by fluid-bed coating the cooling agent blend with an aqueous, high-pH (pH=11.6-12.0) Zein dispersion of 15% solids.

### Example 849

A 20% Zein, 20% shellac, 60% active menthyl lactate, WS-23, and WS-5 powder mixture is obtained by spray drying an alcohol/shellac/cooling agent mixture and then fluid-bed coating the spray dried product for a second coating of alcohol and Zein.

### Example 850

A 20% Zein, 20% shellac, 60% active menthyl glutarate, menthyl succinate, and isopulegol powder mixture is obtained by spray drying an alcohol/shellac/cooling agent mixture and then fluid-bed coating the spray dried product for a second coating of alcohol and Zein.

### Example 851

A 20% Zein, 20% shellac, 60% active WS-3, DHDB, TCA, and menthanediol powder mixture is obtained by spray drying an alcohol/shellac/cooling agent mixture and then fluid-bed coating the spray dried product for a second coating of alcohol and Zein.

### Example 852

A 20% Zein, 20% shellac, 60% active menthyl succinate, WS-5, HDIB, and menthyl glutarate powder mixture is obtained by spray drying an alcohol/shellac/cooling agent mixture and then fluid-bed coating the spray dried product for a second coating of alcohol and Zein.

### Example 853

A 20% Zein, 20% shellac, 60% active menthyl lactate, Homomenthol, WS-23, WS-5, and isopulegol powder mixture is obtained by spray drying an alcohol/shellac/cooling agent mixture and then fluid-bed coating the spray dried product for a second coating of alcohol and Zein.

Examples 799-853 would all give nearly complete encapsulation and would delay the release of the cooling agents when used in gum formulations. The higher levels of coating would give a longer delayed release of the cooling agents than the lower levels of coating.

Other polymers that are more water soluble and used in coating would have less of an effect of delaying the release of the cooling agents.

### Example 854

An 80% gelatin, 20% active WS-5 and TCA compounds powder mixture is obtained by spray drying a gelatin/TCA and WS-5 compounds emulsion.

### Example 855

An 80% gelatin, 20% active WS-23, isopulegol, and TCA compounds powder mixture is obtained by spray drying a gelatin/TCA, WS-23 and isopulegol compounds emulsion.

### Example 856

An 80% gelatin, 20% active WS-5, DMIB, and isopulegol compounds powder mixture is obtained by spray drying a gelatin/WS-5, DMIB, and isopulegol compounds emulsion.

### Example 857

An 80% gelatin, 20% active BAMC, DHDB, and menthanediol compounds powder mixture is obtained by spray drying a gelatin/BAMC, DHDB, and menthanediol compounds emulsion.

### Example 858

An 80% gelatin, 20% active menthyl glutarate, WS-5, Cubebol, and HDIB compounds powder mixture is obtained by spray drying a gelatin/menthyl glutarate, WS-5, Cubebol, and HDIB compounds emulsion.

### Example 859

An 80% gelatin, 20% active menthyl glutarate, WS-5, WS-23, isopulegol, and BCH compounds powder mixture is obtained by spray drying a gelatin/menthyl glutarate, WS-5, WS-23, isopulegol, and BCH compounds emulsion.

### Example 860

A 50% hydroxypropylmethyl cellulose (HPMC), 50% active menthyl succinate and WS-5 compounds powder mixture is obtained by fluid-bed coating menthyl succinate and WS-5 compounds with an aqueous solution of HPMC at 10% solids.

### Example 861

A 50% hydroxypropylmethyl cellulose (HPMC), 50% active menthyl succinate, DMIB, and WS-3 compounds powder mixture is obtained by fluid-bed coating menthyl succinate, DMIB, and WS-3 compounds with an aqueous solution of HPMC at 10% solids.

### Example 862

A 50% hydroxypropylmethyl cellulose (HPMC), 50% active menthyl lactate, DHDB, and HDIB compounds powder mixture is obtained by fluid-bed coating menthyl lactate, DHDB, and HDIB compounds with an aqueous solution of HPMC at 10% solids.

### Example 863

A 50% hydroxypropylmethyl cellulose (HPMC), 50% active menthyl lactate, BAMC, DMIB, HDIB, and WS-5 compounds powder mixture is obtained by fluid-bed coating menthyl lactate, BAMC, DMIB, HDIB, and WS-5 compounds with an aqueous solution of HPMC at 10% solids.

### Example 864

A 50% maltodextrin, 50% active TCA, WS-5, and WS-23 compounds powder mixture is obtained by spray drying an aqueous emulsion of TCA, WS-5, and WS-23 compounds and maltodextrin at 40% solids.

### Example 865

A 50% maltodextrin, 50% active menthyl glutarate, DMIB, and isopulegol compounds powder mixture is obtained by spray drying an aqueous emulsion of menthyl glutarate, DMIB, and isopulegol compounds and maltodextrin at 40% solids.

### Example 866

A 50% maltodextrin, 50% active menthanediol, DHDB, and WS-5 compounds powder mixture is obtained by spray drying an aqueous emulsion of menthanediol, DHDB, and WS-5 compounds and maltodextrin at 40% solids.

### Example 867

A 50% maltodextrin, 50% active menthyl glutarate, WS-5, HDIB, and isopulegol compounds powder mixture is obtained by spray drying an aqueous emulsion of menthyl glutarate, WS-5, HDIB, and isopulegol compounds and maltodextrin at 40% solids.

### Example 868

A 50% maltodextrin, 50% active TCA, menthyl lactate, BAMC, DMIB, isopulegol and BCH compounds powder mixture is obtained by spray drying an aqueous emulsion of menthyl lactate, BAMC, DMIB, isopulegol, and BCH compounds and maltodextrin at 40% solids.

### Example 869

A 50% gum Arabic, 50% active TCA and menthyl glutarate compounds powder mixture is obtained by fluid-bed coating TCA and menthyl glutarate compounds absorbed on silica, then with an aqueous solution of gum Arabic at 40% solids.

### Example 870

A 50% gum Arabic, 50% active TCA, WS-5, and DMIB compounds powder mixture is obtained by fluid-bed coating TCA, WS-5, and DMIB compounds absorbed on silica, then with an aqueous solution of gum Arabic at 40% solids.

### Example 871

A 50% gum Arabic, 50% active menthyl glutarate, TCA, DHDB, and Cubebol compounds powder mixture is obtained by fluid-bed coating menthyl glutarate, TCA, DHDB, and Cubebol compounds absorbed on silica, then with an aqueous solution of gum Arabic at 40% solids.

### Example 872

A 50% gum Arabic, 50% active menthanediol, WS-3, DMIB, and HDIB compounds powder mixture is obtained by fluid-bed coating menthanediol, WS-3, DMIB, and HDIB compounds absorbed on silica, then with an aqueous solution of gum Arabic at 40% solids.

### Example 873

A 50% gum Arabic, 50% active menthyl succinate, WS-5, WS-23, DMIB, and BCH compounds powder mixture is obtained by fluid-bed coating menthyl succinate, WS-5, WS-23, DMIB, and BCH compounds absorbed on silica, then with an aqueous solution of gum Arabic at 40% solids.

The coated cooling compounds from Example 854-863, when used in the chewing gum formula, would give a moderately fast release of cooling agents. The products coated with maltodextrin and gum Arabic in Examples 864-873, when used in the gum formula would give a fast release of the cooling agents.

Cooling agents could also be used in gum after being agglomerated to give modified release of these cooling agents.

### Example 874

A 15% hydroxypropylmethyl cellulose (HPMC), 85% active WS-5 and DMIB compounds powder mixture can be prepared by agglomerating WS-5 and DMIB compounds and HPMC blended together, with water being added, and the resulting product being dried and ground.

### Example 875

A 15% hydroxypropylmethyl cellulose (HPMC), 85% active menthyl lactate, WS-3, and DMIB compounds powder mixture can be prepared by agglomerating menthyl lactate, WS-3, and DMIB compounds and HPMC blended together, with water being added, and the resulting product being dried and ground.

### Example 876

A 15% hydroxypropylmethyl cellulose (HPMC), 85% active WS-5, menthyl glutarate, isopulegol, and DMIB compounds powder mixture can be prepared by agglomerating WS-5, menthyl glutarate, WS-3, and DMIB compounds and HPMC blended together, with water being added, and the resulting product being dried and ground.

### Example 877

A 15% hydroxypropylmethyl cellulose (HPMC), 85% active menthyl succinate, menthyl glutarate, and isopulegol compounds powder mixture can be prepared by agglomerating menthyl succinate, menthyl glutarate, and isopulegol compounds and HPMC blended together, with water being added, and the resulting product being dried and ground.

### Example 878

A 15% gelatin, 85% active TCA, WS-3, and WS-23 compounds powder mixture can be made by agglomerating TCA, WS-3, and WS-23 compounds and gelatin blended together, with water being added, and the resulting product being dried and ground.

### Example 879

A 15% gelatin, 85% active TCA, WS-5, and DMIB compounds powder mixture can be made by agglomerating TCA, WS-5, and DMIB compounds and gelatin blended together, with water being added, and the resulting product being dried and ground.

### Example 880

A 15% gelatin, 85% active isopulegol, DHDB, and menthyl glutarate compounds powder mixture can be made by agglomerating isopulegol, DHDB, and menthyl glutarate compounds and gelatin blended together, with water being added, and the resulting product being dried and ground.

### Example 881

A 15% gelatin, 85% active menthanediol, WS-5, HDIB, and Cubebol compounds powder mixture can be made by agglomerating menthanediol, WS-5, HDIB, and Cubebol compounds and gelatin blended together, with water being added, and the resulting product being dried and ground.

### Example 882

A 10% Zein, 90% active TCA, WS-5, and WS-23 compounds powder mixture can be made by agglomerating TCA, WS-5 and WS-23 compounds with an aqueous solution containing Zein, and drying and grinding the resulting product.

### Example 883

A 10% Zein, 90% active TCA, DMIB, and HDIB compounds powder mixture can be made by agglomerating TCA, DMIB, and HDIB compounds with an aqueous solution containing Zein, and drying and grinding the resulting product.

### Example 884

A 10% Zein, 90% active menthyl glutarate, isopulegol, DMIB, and BAMC compounds powder mixture can be made by agglomerating menthyl glutarate, isopulegol, DMIB, and BAMC compounds with an aqueous solution containing Zein, and drying and grinding the resulting product.

### Example 885

A 10% Zein, 90% active TCA, WS-5, DHDB, HDIB, and Cubebol compounds powder mixture can be made by agglomerating TCA, WS-5, DHDB, HDIB, and Cubebol compounds with an aqueous solution containing Zein, and drying and grinding the resulting product.

### Example 886

A 15% shellac, 85% active TCA, BAMC, and WS-23 compounds powder mixture can be made by agglomerating TCA, BAMC, and WS-23 compounds with an alcohol solution containing 25% shellac, and drying and grinding the resulting product.

### Example 887

A 15% shellac, 85% active menthyl glutarate, DMIB, isopulegol, and MGK compounds powder mixture can be made by agglomerating menthyl glutarate, DMIB, isopulegol, and MGK compounds with an alcohol solution containing 25% shellac, and drying and grinding the resulting product.

### Example 888

A 15% shellac, 85% active WS-3, DHDB, HDIB, and menthyl lactate compounds powder mixture can be made by agglomerating WS-3, DHDB, HDIB, and menthyl lactate compounds with an alcohol solution containing 25% shellac, and drying and grinding the resulting product.

### Example 889

A 15% shellac, 85% active TCA, WS-5, DMIB, menthyl succinate, and Cubebol compounds powder mixture can be made by agglomerating TCA, WS-5, DMIB, menthyl succinate, and Cubebol compounds with an alcohol solution containing 25% shellac, and drying and grinding the resulting product.

Multiple encapsulation treatments are given in Examples 814-826 and Examples 849-853. Additional examples of multiple step treatments are here described:

### Example 890

Menthyl succinate and WS-5 are spray dried with maltodextrin at 30% solids to prepare a powder. This powder is then agglomerated with hydroxy-propylmethyl cellulose (HPMC) in a ratio of 85/15 powder/HPMC, wetted with water and dried. After grinding the resulting powder will contain about 68% active cooling agent, 17% maltodextrin and 15% HPMC.

### Example 891

Menthyl glutarate, DMIB, DHDB, and WS-5 are spray dried with maltodextrin at 30% solids to prepare a powder. This powder is then agglomerated with HPMC in a ratio of 85/15 powder/HPMC, wetted with water and dried. After grinding the resulting powder will contain about 68% active cooling agent, 17% maltodextrin and 15% HPMC.

### Example 892

Menthyl lactate, MGK, HDIB, isopulegol, and WS-5 are spray dried with maltodextrin at 30% solids to prepare a powder. This powder is then agglomerated with HPMC in a ratio of 85/15 powder/HPMC, wetted with water and dried. After grinding the resulting powder will contain about 68% active cooling agent, 17% maltodextrin and 15% HPMC.

### Example 893

Menthyl glutarate, WS-5, and DMIB are agglomerated with HPMC in a ratio of 85/15 cooling agent/HPMC. After drying and grinding, the resulting powder is fluid-bed coated with an alcohol shellac solution at about 25% solids to give a final product containing about 60% active cooling agent, 10% HPMC, and about 30% shellac.

### Example 894

Menthyl lactate, DHDB, HDIB, and isopulegol are agglomerated with HPMC in a ratio of 85/15 cooling agent/HPMC. After drying and grinding, the resulting powder is fluid-bed coated with an alcohol shellac solution at about 25% solids to give a final product containing about 60% active cooling agent, 10% HPMC, and about 30% shellac.

### Example 895

Menthyl succinate, WS-5, TCA, WS-23, and Cubebol are agglomerated with HPMC in a ratio of 85/15 cooling agent/HPMC. After drying and grinding, the resulting powder is fluid-bed coated with an alcohol shellac solution at about 25% solids to give a final product containing about 60% active cooling agent, 10% HPMC, and about 30% shellac.

### Example 896

Menthyl glutarate, WS-5, and DMIB, are agglomerated with HPMC in a ratio of 85/15 cooling agent/HPMC. After drying and grinding, the resulting powder is agglomerated with a 15% solids, high-pH, aqueous solution of Zein to give a final product containing about 60% active cooling agent, 10% HPMC, and 30% Zein.

### Example 897

Menthyl succinate, DHDB, HDIB, and isopulegol are agglomerated with HPMC in a ratio of 85/15 cooling agent/HPMC. After drying and grinding, the resulting powder is agglomerated with a 15% solids, high-pH, aqueous solution of Zein to give a final product containing about 60% active cooling agent, 10% HPMC, and 30% Zein.

### Example 898

Menthyl lactate, MGK, TCA, WS-5, and Cubebol are agglomerated with HPMC in a ratio of 85/15 cooling agent/HPMC. After drying and grinding, the resulting powder is agglomerated with a 15% solids, high-pH, aqueous solution of Zein to give a final product containing about 60% active cooling agent, 10% HPMC, and 30% Zein.

### Example 899

Menthyl lactate, WS-5, and DMIB are spray dried with a 25% emulsion of gelatin. The spray dried product is then agglomerated with a 15% solids, high pH, aqueous solution of Zein. The final product will contain about 50% active cooling agent, 20% gelatin, and 30% Zein.

### Example 900

Menthyl succinate, DHDB, and HDIB are spray dried with a 25% emulsion of gelatin. The spray dried product is then agglomerated with a 15% solids, high pH, aqueous solution of Zein. The final product will contain about 50% active cooling agent, 20% gelatin, and 30% Zein.

### Example 901

Menthyl glutarate, WS-5, WS-23, and BAMC are spray dried with a 25% emulsion of gelatin. The spray dried product is then agglomerated with a 15% solids, high pH, aqueous solution of Zein. The final product will contain about 50% active cooling agent, 20% gelatin, and 30% Zein.

### Example 902

Menthyl lactate, WS-3, MGK, isopulegol, and DMIB are spray dried with a 25% emulsion of gelatin. The spray dried product is agglomerated with a 15% solids, high pH, aqueous solution of Zein. The final product will contain about 50% active cooling agent, 20% gelatin, and 30% Zein.

### Example 903

Menthyl succinate, WS-5, and menthyl glutarate are agglomerated with molten wax in a ratio of 85/15 cooling agent/wax. When the mixture cools and is ground, it is fluid-bed coated with a 10% Zein solution, giving a final product containing 60% active cooling agent, 10% wax, and 30% Zein.

### Example 904

Menthyl lactate, WS-5, DMIB, and isopulegol are agglomerated with molten wax in a ratio of 85/15 cooling agent/wax. When the mixture cools and is ground, it is fluid-bed coated with a 10% Zein solution, giving a final product containing 60% active cooling agent, 10% wax, and 30% Zein.

### Example 905

Menthyl glutarate, MGK, DHDB, HDIB, and BCH are agglomerated with molten wax in a ratio of 85/15 cooling agent/wax. When the mixture cools and is ground, it is fluid-bed coated with a 10% Zein solution, giving a final product containing 60% active cooling agent, 10% wax, and 30% Zein.

The following examples show cooling agents absorbed onto various substrates for controlled release in chewing gum:

### Example 906

A mixture of menthyl glutarate, menthyl succinate, and isopulegol are sprayed onto precipitated silica. The mixture is dried and ground. The final product is about 50% active cooling agent.

### Example 907

A mixture of menthyl glutarate, TCA, and WS-5 are sprayed onto precipitated silica. The mixture is dried and ground. The final product is about 50% active cooling agent.

### Example 908

A mixture of MGK, TCA, DMIB, and DHDB are sprayed onto precipitated silica. The mixture is dried and ground. The final product is about 50% active cooling agent.

### Example 909

A mixture of menthyl lactate, isopulegol, WS-5, DMIB, and TCA are sprayed onto precipitated silica. The mixture is dried and ground. The final product is about 50% active cooling agent.

### Example 910

A mixture of TCA, isopulegol, HDIB, and DHDB, are sprayed onto pharmasorb clay. The mixture is dried and ground and gives a final product of about 80% clay and 20% active cooling agent.

### Example 911

A mixture of menthyl glutarate, WS-5, MGK and WS-23 are sprayed onto pharmasorb clay. The mixture is dried and ground and gives a final product of about 80% clay and 20% active cooling agent.

### Example 912

A mixture of menthyl glutarate, TCA, DMIB, DHDB, and Cubebol are sprayed onto pharmasorb clay. The mixture is dried and ground and gives a final product of about 80% clay and 20% active cooling agent.

### Example 913

A mixture of WS-5, WS-23, and TCA is sprayed onto a microcrystalline cellulose powder. The mixture is dried and ground and gives a product that is about 70% microcrystalline cellulose and 30% active cooling agent.

### Example 914

A mixture of isopulegol, DMIB, DHDB, and menthyl glutarate is sprayed onto a microcrystalline cellulose powder. The mixture is dried and ground and gives a product that is about 70% microcrystalline cellulose and 30% active cooling agent.

### Example 915

A mixture of WS-5, menthyl lactate, HDIB, menthanediol, and BCH is sprayed onto a microcrystalline cellulose powder. The mixture is dried and ground and gives a product that is about 70% microcrystalline cellulose and 30% active cooling agent.

Many of the examples listed are single step processes. However, more delayed release of the cooling agents may be obtained by combining the various processes of encapsulation, agglomeration, absorption, and entrapment. Any of the above preparations can be further treated in fluid-bed coating, spray chilling or coacervation processes to encapsulate the product, and can be agglomerated with various materials and procedures in a variety of multiple step processes.

As disclosed in many of the patents, physiological cooling agents may be added to chewing gum formulations. These chewing gums may be used as centers or cores for the chewing gum that are coated. TABLE 161 illustrates sugared chewing gum formulations that are used as centers for sugar-coated chewing gums having a coating comprising a physiological cooling agent.

TABLE 161
SUGARED CHEWING GUM CENTERS

| | Example | Example | Example |
|---|---|---|---|
| | 916 | 917 | 918 |
| Gum Base | 28.0% | 30.0% | 30.0% |
| Sugar | 52.9% | 50.7% | 46.6% |
| Corn Syrup | 18.0% | 18.0% | 12.0% |
| Glycerin | 0.5% | 0.5% | 0.5% |
| Spearmint Flavor | 0.6% | — | — |
| Peppermint Flavor | — | 0.8% | 0.9% |
| Dextrose Monohydrate | — | — | 10.0% |

The chewing gum formed in TABLE 161 is sheeted in pellets that are square or rectangular pillow shaped and coated with the sugar-based coating formulations in which the cooling agent and menthol are dissolved in the flavor when mixed into the coating syrup in TABLE 162.

TABLE 162
COATING FOR SUGARED CHEWING GUM CENTERS

| | Example | Example | Example |
|---|---|---|---|
| | 919 | 920 | 921 |
| Sugar | 96.56 | 96.06 | 95.71 |
| Modified Starch | 3.0 | 3.0 | 3.0 |
| Spearmint Flavor | 0.3 | — | — |
| Peppermint Flavor | | 0.6 | 0.8 |
| Menthol | — | 0.2 | 0.3 |
| Carnauba Wax | 0.04 | 0.04 | 0.04 |
| Cooling Agent* | 0.1 | 0.1 | 0.15 |

*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

In Example 919, the physiological cooling agent gives a clean, cool Spearmint flavor that could not be obtained with menthol. Examples 920 and 921 would normally require higher levels of menthol, and consequently would contain harsh notes. Adding the physiological cooling agents to Examples 920 and 921 results in strong, clean, cool minty tasting products. As stated previously, non-sugar or sugarless coatings generally will have less sweetness, thus causing more harsh notes when mint flavor and/or menthol are added to the coating. Use of the physiological cooling agents is especially useful in sugarless coating. Polyols such as sorbitol, xylitol, maltitol, lactitol and hydrogenated isomaltulose can be used to coat pellet sugarless gum. Examples of sugarless gum center or core formulations are found in tables 163 and 164.

TABLE 163
SUGARLESS GUM CENTERS

| | Example | Example | Example | Example |
|---|---|---|---|---|
| | 922 | 923 | 924 | 925 |
| Base | 33.1 | 30.0 | 30.0 | 33.0 |
| Calcium Carbonate | 15.0 | 11.0 | 11.0 | 13.0 |
| Sorbitol | 40.94 | 46.36 | 46.08 | 49.52 |
| Glycerin | 8.0 | 0.4 | 0.4 | 0.4 |
| Liquid Sorbitol | — | 6.2 | 6.2 | — |
| Encap. Sweetener | 0.7 | 0.24 | 0.24 | 0.82 |
| Wintergreen Flavor | 1.1 | — | — | — |
| Menthol | 1.1 | — | 0.26 | 0.3 |
| Cooling Agent* | 0.06 | — | 0.12 | 0.06 |
| Mannitol | — | 3.0 | 3.0 | — |
| Peppermint Flavor | — | 2.0 | 1.9 | 1.9 |
| Lecithin | — | 0.8 | 0.8 | 1.0 |
| Encap Menthol | — | — | — | — |

*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

TABLE 164
SUGARLESS GUM CENTERS

| | Example | Example | Example |
|---|---|---|---|
| | 926 | 927 | 928 |
| Base | 32.0 | 31.6 | 33.6 |
| Calcium Carbonate | 15.0 | 11.0 | 13.0 |
| Sorbitol | 41.26 | 45.98 | 49.23 |
| Glycerin | 7.0 | 0.8 | 0.75 |
| Liquid Sorbitol | — | 7.2 | — |
| Encap. Sweetener | 0.40 | 0.66 | 0.66 |
| Wintergreen Flavor | — | — | — |
| Menthol | 0.9 | 0.3 | 0.3 |
| Cooling Agents* | 0.14 | 0.06 | 0.06 |
| Mannitol | — | — | — |
| Peppermint Flavor | 1.3 | 1.9 | 1.9 |
| Lecithin | — | 0.5 | 0.5 |
| Encap Menthol | 2.0 | — | — |

*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

The centers in tables 163 and 164 are coated with coating formulations that comprise xylitol, maltitol, lactitol, hydrogenated isomaltulose or sorbitol; various flavors; optionally menthol; and the physiological cooling agents. Examples of sugarless coated chewing gums are found in tables 165 and 166.

TABLE 165
SUGARLESS COATED CHEWING GUMS

| | Ex. 929 | Ex. 930 | Ex. 931 | Ex. 932 | Ex. 933 |
|---|---|---|---|---|---|
| Center | Ex. 922 | Ex. 923 | Ex. 923 | Ex. 924 | Ex. 925 |
| Xylitol | 88.83 | 88.83 | — | — | — |
| Gum Arabic | 8.8 | 8.8 | 2.8 | 2.8 | 3.1 |
| Titanium Dioxide | 0.9 | 0.9 | 0.9 | 0.9 | 1.3 |
| Hydrogenated | — | — | 95.0 | 94.84 | 93.66 |
| isomaltulose | | | | | |
| Maltitol | — | — | — | — | — |
| Wintergreen Flavor | 0.9 | — | — | — | — |
| Peppermint Flavor | — | 0.9 | 0.7 | 0.7 | 0.75 |
| Menthol | 0.4 | 0.4 | 0.3 | 0.5 | 0.75 |
| Carnauba Wax | 0.1 | 0.1 | 0.1 | 0.1 | 0.1 |
| Cooling Agent* | 0.07 | 0.07 | 0.1 | 0.06 | 0.14 |
| Sweetener | — | — | 0.1 | 0.1 | 0.2 |

*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

TABLE 166
SUGARLESS COATED CHEWING GUMS

| | Ex. 934 | Ex. 935 | Ex. 936 | Ex. 937 |
|---|---|---|---|---|
| Center | Ex. 925 | Ex. 926 | Ex. 927 | Ex. 928 |
| Xylitol | — | — | — | — |
| Gum Arabic | 3.1 | 3.1 | 3.1 | 3.1 |
| Titanium Dioxide | 1.3 | 1.3 | 1.3 | 1.3 |
| Hydrogenated | — | — | 93.59 | 93.56 |
| Isomaltulose | | | | |
| Maltitol | 93.66 | 93.33 | — | — |
| Wintergreen Flavor | — | — | — | — |
| Peppermint Flavor | 0.75 | 1.0 | 0.9 | 0.9 |
| Menthol | 0.75 | 1.0 | 0.3 | 0.3 |
| Carnauba Wax | 0.1 | 0.1 | 0.1 | 0.1 |
| Cooling Agent* | 0.14 | 0.02 | 0.11 | 0.14 |
| Sweetener | 0.2 | 0.15 | 0.6 | 0.6 |

*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

In the examples of tables 165 and 166, menthol is dissolved into the flavor along with the physiological cooling agent. Half of this mixture is applied at each of coats 8 and 14. After the coating is completed and allowed to stand overnight, the pellets are polished with carnauba wax. In the case of hydrogenated isomaltulose and maltitol, gum Arabic may be used as a precoat with hydrogenated isomaltulose or maltitol, or dusted with powdered hydrogenated isomaltulose or maltitol then coated with a hydrogenated isomaltulose or maltitol solution.

Other coated gum products can be made with other flavors as well. Menthol and/or physiological cooling agents may enhance these various types of flavors such as menthol-eucalyptus, spearmint-menthol, cinnamon-menthol, and even fruity mint-menthol. The formulations for various flavored centers are found in tables 167 and 168.

TABLE 167
VARIOUS-FLAVORED CENTERS

| | Ex. 928 | Ex. 929 | Ex. 930 | Ex. 931 |
|---|---|---|---|---|
| Base | 30.0 | 30.0 | 30.0 | 30.0 |
| Calcium Carbonate | 11.0 | 11.0 | 11.0 | 11.0 |
| Sorbitol | 51.6 | 50.6 | 50.8 | 52.05 |
| Glycerin | 5.0 | 5.0 | 5.0 | 4.0 |
| Encap. Sweetener | 0.5 | 0.5 | 0.5 | 0.5 |
| Flavor | 1.0^{A} | 1.5^{B} | 1.4^{B} | 1.6^{C} |
| Menthol | 0.2 | 0.4 | 0.3 | 0.2 |
| Cooling agent* | 0.1 | — | 0.1 | 0.05 |
| Lecithin | 0.6 | 0.6 | 0.6 | 0.6 |
| Encap. Menthol | — | 0.4 | 0.3 | — |

^{A}Spearmint Flavor
^{B}Menthol/Eucalyptus Flavor
^{C}Cinnamon/Menthol Flavor
*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

TABLE 168
VARIOUS-FLAVORED CENTERS

| | Ex. 932 | Ex. 933 | Ex. 934 |
|---|---|---|---|
| Base | 30.0 | 30.0 | 30.0 |
| Calcium Carbonate | 11.0 | 11.0 | 11.0 |
| Sorbitol | 51.9 | 49.3 | 49.3 |
| Glycerin | 4.0 | 7.0 | 7.0 |
| Encap. Sweetener | 0.5 | 0.6 | 0.6 |
| Flavor | 1.6^{C} | 1.2^{D} | 1.2^{D} |
| Menthol | 0.2 | 0.2 | 0.1 |
| Cooling Agent* | 0.2 | 0.1 | 0.2 |
| Lecithin | 0.6 | 0.6 | 0.6 |
| Encap. Menthol | — | — | — |

^{C}Cinnamon-Menthol Flavor
^{D}Fruity-mint Menthol Flavor
*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

The various-flavored center formulas may be coated with polyols such as xylitol, maltitol, lactitol, hydrogenated isomaltulose or sorbitol and have a physiological cooling agent added to the coating. Examples of coated chewing gum having various flavors are found in tables 169 and 170.

TABLE 169
VARIOUS-FLAVORED COATED CHEWING GUMS

| | Ex. 935 | Ex. 936 | Ex. 937 | Ex. 938 |
|---|---|---|---|---|
| Center | Ex. 928 | Ex. 929 | Ex. 930 | Ex. 931 |
| Xylitol | 89.7 | 89.1 | — | 89.2 |
| Gum Arabic | 8.8 | 8.8 | 2.8 | 8.8 |
| Titanium Dioxide | 0.8 | 0.8 | 0.8 | 0.8 |
| Hydrogenated | — | — | 95.0 | — |
| isomaltulose | | | | |
| Maltitol | — | — | — | — |
| Flavor | 0.4^{A} | 0.6^{B} | 0.6^{B} | 0.8^{C} |
| Menthol | 0.1 | 0.4 | 0.3 | 0.2 |
| Carnauba Wax | 0.1 | 0.1 | 0.1 | 0.1 |
| Cooling Agent* | 0.1 | 0.2 | 0.2 | 0.1 |
| Sweeteners | — | — | 0.2 | — |

^{A}Spearmint Flavor
^{B}Menthol-Eucalyptus Flavor
^{C}Cinnamon-Menthol Flavor
*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

TABLE 170
VARIOUS-FLAVORED COATED CHEWING GUMS

| | Ex. 939 | Ex. 940 | Ex. 941 |
|---|---|---|---|
| Center | Ex. 932 | Ex. 933 | Ex. 934 |
| Xylitol | — | 89.7 | — |
| Gum Arabic | 2.8 | 8.8 | 2.8 |
| Titanium Dioxide | 0.8 | 0.8 | 0.8 |
| Hydrogenated | 94.9 | — | — |
| isomaltulose | | | |
| Maltitol | — | — | 95.6 |
| Flavor | 0.8^{C} | 0.3^{D} | 0.3^{D} |
| Menthol | 0.2 | 0.1 | 0.1 |
| Carnauba Wax | 0.1 | 0.1 | 0.1 |
| Cooling Agent* | 0.2 | 0.2 | 0.1 |
| Sweeteners | 0.2 | — | 0.2 |

^{C}Cinnamon-Menthol Flavor
^{D}Fruity-mint Menthol Flavor
*Any of the cooling agents listed in Groups A, B, C, D, or E or combinations of any of the cooling agents found in these groups. Specific examples of cooling agents include: WS-5, BAMC, DMIB, DHDB, HDIB, menthyl lactate, menthyl succinate, menthyl glutarate, isopulegol, menthanediol, TCA, Cubebol, and cyclohexanone.

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

1. A method of producing chewing gum with combinations of physiological cooling agents comprising the steps of:
a) mixing at least two physiological cooling agents together with a release modification material;
b) treating the cooling agents to provide a modified release; and
c) adding a quantity of the modified release cooling agents to a chewing gum composition to provide a cooling agent level in the gum of from about 0.001% to about 2%.

2. The method of claim 1 wherein the physiological cooling agents are selected from the group consisting of N-substituted p-menthane carboxamides, p-menthane carboxylic acids, and other p-menthane carboxamides, acyclic carboxamides, menthol esters, acids, and menthol salts, menthol derivatives, other physiological cooling agents and combinations thereof.

3. The method of claim 1 wherein the cooling agents are treated by an encapsulation process.

4. The method of claim 3 wherein the cooling agents are encapsulated by a spray drying process.

5. The method of claim 3 wherein the cooling agents are encapsulated by a fluid bed coating process.

6. The method of claim 1 wherein the cooling agents are treated by being entrapped in an extrusion process.

7. A chewing gum made according to the method of claim 1.

8. A chewing gum comprising a gum base, a sweet bulking agent, a flavor and from about 0.001% to about 2% of a modified release physiological cooling composition, said modified release physiological cooling composition comprising a mixture of at least two physiological cooling agents a release modification material, wherein said mixture has been treated to provide a modified release profile of the physiological cooling agents.

9. The chewing gum of claim 8 wherein the physiological cooling agents are selected from the group consisting of N-substituted p-menthane carboxamides, p-menthane carboxylic acids, and other p-menthane carboxamides, acyclic carboxamides, menthol esters, acids, and menthol salts, menthol derivatives, other physiological cooling agents and combinations thereof.

10. The chewing gum of claim 9, wherein one of the physiological cooling agents is N-[[5-methyl-2-(1-methylethyl)-cyclohexyl]carbonyl]glycine.

11. The chewing gum of claim 9, wherein one of the physiological cooling agents is N-(4-methoxyphenyl)-p-menthane-3-carboxamide.

12. The chewing gum of claim 9, wherein one of the physiological cooling agents is N-(t-butyl)-p-menthane-3-carboxamide.

13. The chewing gum of claim 9, wherein one of the physiological cooling agents is ethylene glycol ester of p-menthane-3-carboxylic acid.

14. The chewing gum of claim 9, wherein one of the physiological cooling agents is N-(p-benzene acetonitrile)-p-menthane-carboxamide.

15. The chewing gum of claim 9, wherein one of the physiological cooling agents is N-(2-(Pyridin-2-yl)ethyl)-3-p-menthane-carboxamide.

16. The chewing gum of claim 9 wherein the cooling agents are treated by an encapsulation process.

17. The chewing gum of claim 16 wherein the encapsulation process is a fluid bed coating process.

18. The chewing gum of claim 9, wherein the cooling agents are treated by a spray drying process.

19. The chewing gum of claim 9, wherein the cooling agents are treated by a spray chilling process.

20. The chewing gum of claim 9, wherein the cooling agents are treated by being entrapped in an extrusion process.
